(19) United States
(12) Patent Application Publication
(10) Pub. No.: US 2022/0188709 A1
(43) Pub. Date: Jun. 16, 2022

(54) COMPUTER-ENABLED METHOD, SYSTEM AND COMPUTER PROGRAM FOR DYNAMICALLY ALTERING CONSTRAINTS UTILISED IN THE MANAGEMENT OF A SPACE, FURNITURE, EQUIPMENT OR SERVICE

(71) Applicant: GRAND PERFORMANCE ONLINE PTY LTD, Sydney (AU)

(72) Inventor: Peter PETROULAS, Sydney (AU)

(21) Appl. No.: 17/452,770

(22) Filed: Oct. 28, 2021

Related U.S. Application Data
(63) Continuation of application No. PCT/AU2020/050412, filed on Apr. 28, 2020.
Application No. PCT/AU2020/050412 is a continuation-in-part of application No. PCT/AU2020/050407, filed on Apr. 28, 2020.
Application No. PCT/AU2020/050407 is a continuation-in-part of application No. PCT/AU2020/050408, filed on Apr. 28, 2020.
Application No. PCT/AU2020/050408 is a continuation-in-part of application No. PCT/AU2020/050409, filed on Apr. 28, 2020.
Application No. PCT/AU2020/050409 is a continuation-in-part of application No. PCT/AU2020/050410, filed on Apr. 28, 2020.
Application No. PCT/AU2020/050410 is a continuation-in-part of application No. PCT/AU2020/050411, filed on Apr. 28, 2020.
Application No. PCT/AU2020/050411 is a continuation-in-part of application No. PCT/AU2020/050413, filed on Apr. 28, 2020.
Application No. PCT/AU2020/050413 is a continuation-in-part of application No. PCT/AU2020/050414, filed on Apr. 28, 2020.
Application No. PCT/AU2020/050414 is a continuation-in-part of application No. PCT/AU2020/050415, filed on Apr. 28, 2020.
Application No. PCT/AU2020/050415 is a continuation-in-part of application No. PCT/AU2020/050416, filed on Apr. 28, 2020.
Application No. PCT/AU2020/050416 is a continuation-in-part of application No. PCT/AU2020/050417, filed on Apr. 28, 2020.
Application No. PCT/AU2020/050417 is a continuation-in-part of application No. PCT/AU2020/050418, filed on Apr. 28, 2020.
Application No. PCT/AU2020/050418 is a continuation-in-part of application No. 16/754,139, filed on Apr. 7, 2020.
Application No. 16/754,139 is a continuation-in-part of application No. 16/754,136, filed on Apr. 7, 2020.
Application No. 16/754,136 is a continuation-in-part of application No. 16/754,133, filed on Apr. 6, 2020.
Application No. 16/754,133 is a continuation-in-part of application No. 16/754,131, filed on Apr. 6, 2020.

(30) Foreign Application Priority Data
Oct. 31, 2017 (AU) 2017904431
Dec. 22, 2017 (AU) 2017905188
Dec. 22, 2017 (AU) 2017905189
Dec. 22, 2017 (AU) 2017905190
Apr. 19, 2018 (AU) 2018202759
May 21, 2018 (AU) 2018203575
Apr. 29, 2019 (AU) 2019901431
Apr. 29, 2019 (AU) 2019901432
Apr. 29, 2019 (AU) 2019901433
Apr. 29, 2019 (AU) 2019901434
Apr. 29, 2019 (AU) 2019901435
Apr. 29, 2019 (AU) 2019901437
Apr. 29, 2019 (AU) 2019901438
Apr. 29, 2019 (AU) 2019901439
Apr. 29, 2019 (AU) 2019901443
Apr. 29, 2019 (AU) 2019901444
Apr. 29, 2019 (AU) 2019901448
Apr. 29, 2019 (AU) 2019901451
Jul. 27, 2019 (AU) 2019902681
Jul. 27, 2019 (AU) 2019902682
Aug. 19, 2019 (AU) 2019903010
Aug. 19, 2019 (AU) 2019903011
Aug. 19, 2019 (AU) 2019903012
Aug. 19, 2019 (AU) 2019903013
Aug. 19, 2019 (AU) 2019903014
Aug. 19, 2019 (AU) 2019903015
Aug. 19, 2019 (AU) 2019903016
Aug. 19, 2019 (AU) 2019903017
Aug. 19, 2019 (AU) 2019903018
Aug. 19, 2019 (AU) 2019903019
Sep. 20, 2019 (AU) 2019903510
Sep. 20, 2019 (AU) 2019903511
Sep. 20, 2019 (AU) 2019903512

(51) Int. Cl. G06Q 10/02; G06Q 50/12

(52) U.S. Cl. CPC G06Q 10/02; G06Q 50/12

(57) ABSTRACT

In one embodiment, there is provided a computer-enabled method for providing differentiable product and/or services offerings to a booking requestor via a booking allocation algorithm utilising a volumetric space/time framework to allocate bookings using a booking allocation algorithm, comprising the steps of, associating one or more spatial, product and service attributes with each one of one or more spaces within the volumetric space/time framework, whereby the one or more attributes associated with the each one of the one or more spaces define at least one of a physical and qualitative attribute of the each one or more spaces, associating one or more products with the each one of the one or more attributes to create the differentiable set of products.

### TECHNICAL FIELD

The present invention relates to a system, method and computer program for dynamically altering the constraints utilised for optimising the management of a space over a period of time.

In one embodiment, the invention is directed to an online restaurant booking system and the interaction and relationship between the optimisation of the capacity of a space within the restaurant. The aspect includes determining the availability and use of seats and tables, and the revenue that can be generated from the available seats and tables in the space.

In one embodiment, the invention is directed to an online restaurant booking and management system that optimises the use of space and the operation of a restaurant through the use of one or more allocation methodologies and algorithms.

Embodiments of the system are directed the fields of online (e.g. web based) interactive systems, applications for mobile devices (‘apps”), and/or software applications that determine the optimal arrangement and deployment of bookings for a space, floor plan, table, chair, stool or area using yield management techniques and revenue management techniques while offering a personalised experience.

### BACKGROUND—YIELD MANAGEMENT

To better understand the inventive concepts and embodiments of the invention described herein, an abridged history and of the restaurant industry and known booking systems may be found in an earlier filed PCT application PCT/AU2018/051168 (and co-pending PCT application PCT/AU2018/051169, PCT/AU2018/051170 and PCT/AU2018/051171), as well as in Australian provisional application AU2019/900128.

It is widely recognised that a restaurant offers a fixed, time limited resource. Specifically, a dine-in restaurant has a fixed number of tables chairs, stools, eating area etc., which is time limited, as a meal period once finished, that meal period cannot be recovered. This is similar to the airline industry, hotel industry, car rentals and other similar products.

As restaurants also have fixed, time limited resources, like airline and other industries many people, software providers and others are of the opinion that they have created products and restaurants are using products and software that offer a yield management solution to the restaurant industry. This was noted ion the patent application of Bossert titled the “yield management of configurable restaurants” US 2009/0292566 A1, 26 November, 2009. Bossert noted that yield management had been successfully extended beyond airlines to cover various other industries as well as restaurants from at least the date of his application at [0006] where it was stated:

“Researchers and practitioners have extended yield management from air travel to other industries including hotels and lodging, cruise ships, car rentals, and cargo shipping, as well as restaurants”

However, the extension of what had been applied to the restaurant industry was not the application of yield management but the application of simple discount policies. At its most simple definition, yield management requires the ability to charge a premium price as well as a discount. As such, the systems that have been introduced within restaurants are best described as discounting policies and not yield management or revenue management (the differences between yield management and revenue management will be discussed further below).

For a proper yield management solution to be created one requires not only the existence of fixed, time limited resource but also the ability to strategically control inventory so that one can sell the right product to the right customer at the right time.

The control of inventory within a restaurant is very different to that of an airline. With an airline, as after an aircraft is configured the capacity or number of seats is fixed and unchanging. A similar situation applies to hotel rooms as they are known and finite, similarly with car rental companies and the list goes on. The capacity of a restaurant is very different as within a restaurant it can add or remove a table or add or remove a chair from a table which changes its capacity. No prior art has been able to address this concept and it remains without an answer in the control of capacity within a restaurant.

A further aspect of yield management is the ability to sell the right product to the right customer at the right time for the right price. This aspect of yield management refers to the further ability to sell:

a) The right product
b) The right customer
c) The right time
d) For the right price

Within yield management, the right product refers to an ability to differentiate and discriminate the product or service, in airlines this was done by introducing physical classes (first class, business class, economy class) or creating different classes of tickets with different rules or terms and conditions, including the ability to recognise different demand periods (for example peak and off peak times), the level of demand (business travellers versus family and holiday travellers which may be more price sensitive), as well as the time the purchase is made and the date the service is for. There is no current restaurant yield management system that can account for these product aspects of yield management.

Within yield management, the right customer refers to the ability to match the right customer to the right product, for this to occur a restaurant would need to know who its customers were, what products they wanted and how to enhance or personalise that experience. As one example, within the airline industry the creation of different classes within an aeroplane allows the flexibility of better matching the different needs of specific customers or the needs of one customer group if the airline has a value-based proposition or model. There is no current restaurant yield management system that can account for these customer aspects of yield management.

Within yield management, the right time refers to the fact that the right product should be available when people want it. To give another airline example, a person travelling for business between two cities for a meeting that has a flight time of one hour does not want to arrive there at 6 pm at night. Ideally, they would prefer to arrive early, be able to conduct their meeting and return later that day. While a holiday traveller that will be staying in a city visiting family for 4 weeks may not be as time sensitive as to what time they fly and be more willing to take an alternate flight time. Time in an airline environment refers both to the time of sale as well as to the time of travel. There is no current restaurant yield management system that can account for these time aspects of yield management.

Within yield management, the right price refers to the fact that the right price should be charged for the product and this is only possible, if it is for the right product, to the right customer at the right time. In summary, for proper yield management to be applied one must firstly be able to differentiate a product or service so that it can comply with the features necessary for the application of yield management techniques and dynamic pricing. Further, it is mandatory to then be able to utilise this differentiation and discrimination to control capacity and be able to strategically release that capacity being the release of the right product to the right customer at the right time and for the right price. It will be shown that not only is there no such system that is capable of doing this within a restaurant environment but that no system can offer the framework to permit yield management. The proliferation and application of systems within the restaurant industry that claim to be yield management systems or offer yield management solutions shows the want for a proper yield management solution within the restaurant industry. A paper that recognised the reasons why airline yield management could not apply to restaurants and correctly characterised the systems adopted within restaurants as not being yield management systems was Heo, Cindy Y., PhD, Associate professor, Head of Hotel School and Tourism Management, Hong Kong Polytechnic included in the publication “Revenue Management for Hospitality and Tourism”, by Patrick Legoherel, Elisabeth Poultier and Alan Fayall, published May 2013, Chapter 8, “Restaurant Revenue Management”.

The prior art systems do not measure the changes in the number of tables used during a service as the prior art systems cannot add or remove tables and chairs during the booking allocation process. As such, the prior art systems cannot determine dynamic seat utilisation factors or dynamic table utilisation factors which can calculate the total time each seat or table was utilised versus the time each seat or table was available during a service to calculate a “dynamic seat utilisation factor” or a “dynamic table utilisation factor”.

The prior art systems to not measure or track the recommended price for each product or service to determine what the potential “full recommended retail revenue” would been if all items sold or offered as complimentary would have been sold at the “full recommended retail price”. The prior art systems do not compare the actual revenue received against the potential “full recommended retail revenue” to calculate the “revenue yield” received to use this within any manual or artificial intelligence systems and processes.

The prior art systems do not use any processes where the “dynamic seat utilisation factor” is multiplied by the “revenue yield” to determine efficiency factors by class, area, subarea, table, etc., and then use that information within any manual or artificial intelligence system.

Previous attempts to attempts to manage a restaurant booking and allocation process and capacity have focused on a single floor plan with a predetermined list of tables and table combinations as such it has no ability to apply revenue metrics in the control and measurement or performance other than within the concept of its predetermined singe unchanging floor plan of fixed tables and table combinations. As such, the concepts of performance management and metrics to manage capacity, dynamic pricing and autonomous systems are beyond the scope of the prior art.

The prior art only provides very simplistic information such as revenue per person and table turnover times. Further it does not capture any information that would permit any other type of measurement concerning the efficiency of a space.

The prior art suffers from the disadvantage that it cannot properly calculate, control or optimise seating and table capacities which are mandatory and form the base for revenue management and deviated its search for maximising revenue to simplistic tactical embodiments which they claim as yield management. Further the outcomes of these tactical embodiments that are not capable of proper measurement as the true costs associated with such tactical embodiments are not seen as relevant and the prior art has never tried to understand their impact and cost as they have always been assumed to be positive.

### SUMMARY

In a first aspect, the invention provides a computer-enabled method for providing differentiable product offerings to a booking requestor via a booking allocation algorithm utilising a volumetric space/time framework to allocate bookings using a booking allocation algorithm, comprising the steps of, associating one or more spatial, product and service attributes with each one of the one or more spaces within the volumetric space/time framework, whereby the one or more attributes associated with the each one of the one or more spaces define at least one of a physical and qualitative attribute of the each one or more spaces, associating one or more products with the each one of the one or more attributes to create the differentiable set of products, whereby the differentiable set of products is further associated with the each of the one or more spaces, whereby the differentiable set of products is utilised in allocating the booking by the booking allocation algorithm.

In one embodiment, the method includes the further step of determining of the capacity to be released for the each one or more products or services to determine the total capacity of the each one or more products or services available for sale within a venue.

In one embodiment, the method includes the further step of allocating a booking request within the product differentiation volumetric framework whereby, for a booking allocation request including booking information arranged to allow the booking request algorithm to select one or more potentially suitable tables, at least one of the purchase amount of the one or more products and the availability of the one or more products is determined as a function of whether the product is associated with the one or more potentially suitable tables within the volumetric space/time framework.

In one embodiment, the framework is arranged to interact with a booking application, the booking application including a user interface arranged to interact with the booking requestor.

A computer-enabled method in accordance with claim 4, whereby the booking application prompts the booking requestor to input booking request information, the booking request information including requestor constraint information.

In one embodiment, the method includes the further step of the booking application providing a channel identifier to the algorithm, whereby the channel identifier is associated with further constraints, whereby, for each of the products in the set of products, the further constraints are utilised to further differentiate the purchase amount of the product or the availability of the product as displayed to the booking requestor on the user interface.

In one embodiment, the method includes the further step of identifying the booking requestor, whereby the identity of the booking requestor or any associated party is utilised by the algorithm to determine at least one of the purchase amount for the product and the availability of the product.

In one embodiment, the method includes the further step of, upon receiving a booking request from a booking requestor, via the booking application, the framework utilises the constraint information provided by the booking requestor to provide a list of available products and associated purchase amounts.

In one embodiment, the constraint information includes at least one of selected menu items, group size, occasion, group composition and odd group number sizes.

In one embodiment, the constraint information includes at least one of the terms and conditions associated with a booking, the provision of a pre-payment or part payment and the payment of supplementary items and the framework provides one of differential pricing and availability dependent on the constraint information.

In one embodiment, the constraint information includes a duration time for a booking and the framework provides one of differential pricing and availability dependent on the constraint information.

In one embodiment, the method includes the further steps of utilising an allocation module arranged to retrieve one or more booking requests from a database containing a plurality of booking requests, the plurality of booking requests wherein the allocation module executes an allocation algorithm that utilises the booking information and the constraint information to assess the capacity of the one or more spaces and allocate a portion of space for each booking request, to derive an optimised allocation instruction set of allocated portions, wherein the instruction set is saved in the database and provided to a space allocation user interface for display to one or more users.

In one embodiment, the constrain information further includes space constraint information defining a plurality of sub-spaces within each one or more spaces, wherein the attributes include constraints that define spatial and utility aspects of the plurality of sub-spaces, wherein the allocation algorithm utilises the sub-space constraint information to allocate each allocation portion to one or more of the plurality of sub-spaces.

In one embodiment, the method includes the constraint information further including section constraint information defining a plurality of sections within at least one sub-space of the plurality of sub-spaces, whereby the section constraint information and the booking constraint information include constraints that define spatial and utility aspects of the plurality of sections, wherein the allocation algorithm utilises the section constraint information to allocate each allocation portion to one or more of the plurality of sections.

In one embodiment, the section constraint information includes specific section constraint information, each specific section constraint information being associated with one or more of the plurality of sections, wherein each of the one or more sections is associated with section constraint information to utilised by the framework to provide one of differential pricing and availability.

In one embodiment, the venue spatial information including the dimensions of the one or more sub-spaces, wherein the dimensions are utilised by the framework to provide one of differential pricing and availability.

In one embodiment, the constraint information further including a class identifier associated with at least one of a space, sub-space or section, wherein the class identifier is utilised by the framework to provide one of differential pricing and availability.

In one embodiment, the requestor constraint information for at least one of the one or more booking requests including information identifying at least one customer associated with each one of the at least one of the one or more booking requests, wherein the allocation algorithm accesses a customer database including additional customer constraint information regarding the at least one customer and utilises the additional customer information as an input to generate and allocate the allocation portion for the at least one of the one or more booking requests.

In one embodiment, the customer constraint information including grouping information utilisable to group each one of the booking requests from the plurality of bookings into at least one of a plurality of groupings, the groupings including a grouping of booking requests where a predefined allocation portion is provided in the requestor constraint information and a grouping where no booking request is provided in the requestor constraint information.

In one embodiment, the selection information further including information regarding at least one of food and beverage to be consumed, wherein the selection information is utilised as an input to determine the optimal allocation portion for the requested booking.

In one embodiment, the interface further includes a menu selection mechanism arranged to allow the booking requestor to select the at least one of the food and beverage to be consumed.

In one embodiment, the information displayed by the interface is dependent, in part, by the service period selected by the booking requestor.

In one embodiment, upon the allocation algorithm not being capable of satisfying a predetermined proportion of optimisation criteria when attempting to allocate the portion in accordance with the requestor constraint information and the venue constraint information, the algorithm causes the interface to display at least one altered set of constraints capable of being satisfied, wherein the requestor may select one of the at least one altered sets of constraints to progress the booking request.

In one embodiment, the at least one altered set of constraints includes one or more of the service period, the selection information and the predefined allocated portion.

In one embodiment, the threshold condition is determined utilising at least one of the number of bookings received, the capacity of the venue, the aggregate of the customers associated with all booking requests that fall within the service period, the time and date at which the threshold is calculated relative to the time and date of service of the service period, or a combination thereof.

In one embodiment, the method includes the provision of a third party interface module, arranged to receive requestor constraint information regarding the provision of one or more third party products and services, wherein the third party module communicates with a third party computing system via a communications network to provide instructions to effect the provision of the third party product and service to the venue in accordance with the constraint information.

In one embodiment, the requestor interface includes information regarding the third party products and services, wherein the requestor can select one or more third party products and services via the requestor interface.

In one embodiment, third party selection information is utilised as part of the constraint information and utilised by the framework to provide one of differential pricing and availability.

In one embodiment, the venue constraint information further including at least one of forecasted and predicted information, wherein the at least one of forecasted and predicted information is retrieved from one of a local database of forecasted and predicted information, and a remote database of forecasted and predicted information.

In one embodiment, the method further includes providing a forecasting module arranged to utilise at least one of historical information, forecasted information and third party information to modify the constraint information, wherein the modified constraint information is utilised to by the framework to provide one of differential pricing and availability.

In one embodiment, the determination of the optimised condition includes the determination of whether one or more conditions are satisfied, including one or more of the total number of allocated spaces equals a predetermined maximum, the maximisation of a calculated hypothetical yield, the maximisation of one or more predefined qualitative criteria, or a combination thereof.

In one embodiment, the predefined qualitative criteria includes the optimisation of an ambiance metric calculated by determining at least one or more criteria that increases the subjective experience or desired outcome of at least one or more booking requestors.

In one embodiment, the ambiance metric includes one or more of allocating at least one booking request to the highest ranked available table, providing an upgrade in class, allocating booking requests in a manner that maximises privacy, allocating bookings in a manner that clusters booking requests with children, and allocating booking requests in a manner where a predefined distance is maintained between the location of each allocated portion relative to each other allocated portion.

In one embodiment, the constraint information further includes an allocation portion identifier.

In one embodiment, the allocation portion identifier is associated with a ranking value, the ranking value being derived from constraint information.

In one embodiment, the allocation portion identifier further includes a preferred table identifier associated with at least one booking requestor.

In one embodiment, the constraint information includes allocating an allocation status identifier to at least one of a space, sub-space, section and allocation portion, whereby the status identifier is utilised by the algorithm utilised to determine the allocation portion for at least one of the booking requests.

In one embodiment, the customer constraint information includes a customer status identifier, whereby the customer status identifier is utilised to determine the allocation portion for each booking request associated with the customer.

In one embodiment, the method further includes providing one or more associated modules, each associated module being arranged to optimise booking allocations utilising an associated allocation algorithm, each associated algorithm being arranged to effect a specific set or sub-set of optimisation parameters that comprise the optimisation condition.

In one embodiment, each associated module utilises a predetermined sub-set of at least one of the requestor constraint information and venue constraint information to allocate each portion.

In one embodiment, the allocation module allocates each booking request, in part, by determining a size metric representative of the relative size of each booking and allocating each booking in order of descending size.

In one embodiment, the size metric of each booking is determined by calculating the product of the number of people in the booking and the length of time sought for the booking.

In one embodiment, each one of the one or booking requests are ordered from largest size metric to smallest size metric, and the largest size booking is allocated first, with all remaining booking sizes being allocated in descending order of size metric.

In one embodiment, the venue constraint information is utilised to determine fixed allocation portions and booking requests capable of being allocated to one of fixed allocation portions are allocated to the fixed allocation portion in descending size metric order.

In one embodiment, a booking requestor is capable of interacting with a device physically located at the venue, the device including an interface for displaying and directing the requestor to an allocated table on a dynamic floor plan.

In one embodiment, a booking requestor is capable of interacting with one of a device physically located at the venue or a device under the control of the booking requestor, the device including an interface for allowing the booking requestor to interact with the booking software to request a booking and displaying and directing the requestor to the allocated table.

In one embodiment, the device physically located at the venue is a kiosk incorporating an electronic interface in communication with the booking software.

In one embodiment, the module determines table availability using an iterative allocation process.

In one embodiment, the module utilises qualified product information to determine table availability using the classification of tables into categories.

In one embodiment, the module utilises the qualified product information to determine table availability within a space comprising one or more spaces.

In one embodiment, the module utilises the qualified product information to determine the table availability to effect an optimised condition.

In one embodiment, if the product request is not confirmed then the booking requestor is provided with at least one alternative determined utilising the constraint information.

In one embodiment, product attributes include a:

1. specific service;

2. specific booking time;

3. specific duration time;

4. specific day of the week;

5. specific date;

6. specific group size;

7. specific occasion; and

8. specific booking duration.

In one embodiment, the product information includes constraint information regarding supplementary items including:

1. extended duration times;

2. locations within a venue;

3. classes of tables within a venue;

4. specific types of table;

5. specific tables within a venue; and

6. specific levels of service.

In one embodiment, the product information includes constraint information regarding third party items including:

1. flowers;

2. entertainment;

3. changes to order of service; and

4. additional complementary products.

In one embodiment, the price is dynamically set according to:

1. Price by product;

2. Price by product by time;

3. Price by product group size;

4. Price by occasion;

5. Price by period of extended duration time;

6. Price by peak and off-peak times;

7. Price by table based on table utility and table location characteristics;

8. Booking fees;

9. Price by additional services; and

10. Discounts, promotions during less popular times.

In one embodiment, the space is one of a seat at a table, a table associated with a plurality of seats, or a seat associated with a table.

In one embodiment, the space is a physical space.

In one embodiment, product differentiation is applied to tables and table combinations within a restaurant space.

In a further aspect, the present invention provides computing system for allocating one or more booking requests for the provision of a service in a venue, the service including the allocation of a space within the venue and the provision of one or more products, the system comprising:

a processor arranged to execute a booking allocation software module, the module being in communication with a product database including product information relevant to a plurality of products, the product information for each one of the plurality of products being associated with a product capacity value;
the allocation module being arranged to request product constraint information related to one or more constraints provided by a booking requestor and retrieve associated product capacity values from the database, and utilise the product capacity values and product constraint information to determine product availability; and
a user interface arranged to interact with the requestor and provide additional product information and additional constraints to the requestor, wherein the requestor may one of agree to the additional constraints and request allocation of the booking on the basis of acceptance of the one or more additional constraints or reject the constraints and not be allocated.

In one embodiment, the module determines table availability using an iterative allocation process.

In one embodiment, the module utilises qualified product information to determine table availability using the classification of tables into categories.

In one embodiment, the module utilises the qualified product information to determine table availability within a space comprising one or more spaces.

In one embodiment, the module utilises the qualified product information to determine the table availability to effect an optimised condition.

In one embodiment, if the product request is not confirmed then the booking requestor is provided with at least one alternative determined utilising the constraint information.

In one embodiment, a product is one or more of the number of courses associated with a menu, a food item, a beverage item or a combination thereof.

In one embodiment, product attributes include a:

a. specific service;
b. specific booking time;
c. specific duration time;
d. specific day of the week;
e. specific date;
f. specific group size;
g. specific occasion; and
h. specific booking duration.

In one embodiment, the product information includes constraint information regarding supplementary items including:

a. extended duration times;
b. locations within a venue;
c. classes of tables within a venue;
d. specific types of table;
e. specific tables within a venue; and
f. specific levels of service.

In one embodiment, the product information includes constraint information regarding third party items including:

a. flowers;
b. entertainment;
c. changes to order of service; and
d. additional complementary products.

In one embodiment, the price is dynamically set according to:

a. Price by product;
b. Price by product by time;
c. Price by product group size;
d. Price by occasion;
e. Price by period of extended duration time;
f. Price by peak and off-peak times;
g. Price by table based on table utility and table location characteristics;
h. Booking fees;
i. Price by additional services; and
j. Discounts, promotions during less popular times.

A computing system for allocating one or more booking requests for the provision of a service in a venue, the service including the allocation of a space within the venue and the provision of one or more products comprising:

a processor in communication with a product database including a plurality of products,
each one of the plurality of products being associated with a product capacity value,
a user interface arranged to interact with a booking requestor and the processor,
the interface being arranged to request product constraint information regarding one or more constraints provided by the booking requestor,

retrieve product capacity values from the database, and utilise the product capacity values and product constraint information to determine a product potential yield information,

and use the potential product yield information and a predetermined product yield metric to determine additional constraint information that increases the minimum predetermined product yield metric, the additional constraint information being provided to the booking requestor via the interface,

wherein the requestor may agree to the additional constraints and request table capacity allocation for confirmation of the booking or reject the constraints and not be allocated.

As defined above, in a first aspect the invention provides a framework for yield management to be undertaken properly by developing and providing a systems procedures, methods and steps to permit the differentiation of an otherwise similar products or an even greater differentiation of generally similar products so that these differences and differentiation can be used to price a product or service differently and implement a dynamic pricing strategy to maximise revenue. Further, this framework and systems and procedures permit differences and differentiation to be used as an integral part of the marketing and communication of the product and the strategic control and release of capacity regulate the supply and availability of the product to maximise revenue.

In one embodiment the current invention has developed a system to differentiate a restaurant “product” and hence online booking process that can differentiate a product as follows:

### 1. Product

a) Product—Physical Utility: In one embodiment, a system for the differentiation of a restaurant space based on the physical characteristics within the restaurant. For example, using the different price for the same product, such as a window table being treated differently to a table at the back of a restaurant and next to the toilet. This requirement includes a full and proper understanding of the benefits of each different aspect of a restaurant is utility, ambiance, table rankings and benefits. Creating different classes of tables, different rankings of tables etc. such that different prices can be charged for differently differentiated physical characteristics. In one embodiment this also includes the creation and use of different spaces such as private dining rooms, exclusive use spaces, free areas around a table etc.
b) Product—Physical Size of Area: In one embodiment, a system for the differentiation is based on the physical area required for the booking after taking into account the physical utility of that area.
c) Product—Menu (Food and Beverage): In one embodiment, a system for the differentiation of the menu by having different menus available at different times by different durations and requiring users to commit to a different number of courses and/or durations. In one embodiment permitting a user to design their own menu for different prices or minimum spend commitments. In a further embodiment requesting the restaurant to source and secure different items such as specific beverages for a booking request.
d) Product—Booking Arrival Time: In one embodiment a system that permits a restaurant to differentiate the control the allocation of bookings by time such that different prices can be charged by time. For example, a booking request for 7:30 pm on a Saturday evening may be of higher demand and perceived value permitting the charge of a higher price than a booking request for 10:00 pm on a Saturday evening.
e) Product—Duration Time: In one embodiment a system that permits a restaurant to differentiate by creating different duration times for different occasions (anniversary, pre theatre, hens party) or different group sizes, or different group make-up (table of two versus a family of five with three children under 5 years of age) or odd number bookings.
f) Product—Booking Request Time: In one embodiment a system that permits a restaurant to differentiate the time period a booking request is made and apply a higher or lower price. For example, a restaurant may wish to offer a discount to booking requests confirmed that are at least 21 days before the date of the service booked. Alternatively, it may wish to apply a premium for a last-minute booking request.
g) Product—Ancillary items: In one embodiment a system that allows a restaurant to differentiate its product offer and suggest to a booking requestor a list of booking enhancements. For example, their personal waiter, a visit to the table by the Head Chef, flowers, a box of chocolates, etc.
h) Product—Personalisation: In one embodiment the ability for a restaurant to offer a customer the ability to rearrange the normal order of service within the restaurant, or design their own menu for a different price. For example, this could also include the provision of only dessert, champagne without the provision of food for a booking requestor who wanted a celebration style event as long as they met a minimum spend or at a predetermined or negotiated price

### 2. Customers

i) Customers—Experience: In one embodiment a system to differentiate through the creation of different packages with different components, be they class of table or type of table, or class of area or class of space, or class of ambiance. For example, charging different price based on different experience characteristics within the restaurant.
j) Customers—Occasion: In one embodiment a system to differentiate by occasion. For example, anniversary dinner for two versus a hen's party for twenty.
k) Customers—Group Size: In one embodiment a system to differentiate by group size with respect to meus offered, booking times, odd or even booking numbers
l) Customers—Budget: In one embodiment a system to differentiate by budget by offering different environments (e.g. view versus no view), ambiance, different size gaps between tables, number of courses etc.
m) Customers—Relationship (CRM): In one embodiment a system that permits the identification of a booking requestors history, previous spend, membership level or other information such that this information can be used and applied to supplement or over-ride other differentiation constraints.

### 3. Time

n) Time—Booking Request Time: In one embodiment a system to differentiate time by the time the booking request is made, such that different promotions can be applied to different times and potentially offer greater discounts to earlier bookings such as those made more than 21 days before, as generally earlier made bookings relate to personal events and are more price sensitive than last minute bookings.
o) Time—Booking Arrival Time: In one embodiment, a system to differentiate by the time, service and day the booking is requested for.
p) Time—Booking Duration Length: In one embodiment, a system to differentiate by length of time required for the booking.

### 4. Promotion

q) Promotion—Premium Promotions: In one embodiment, a system for the offering of promotions during off peak times, seatings, services and days. In one embodiment, the premium promotions can include promotions that are ongoing, one-off, or constrained by some other event or trigger.
r) Promotion—Back-fill Promotions: In one embodiment, a system for the offering of “back-fill” promotions for duration periods where the booking duration is less than the normally permitted but still sufficient for the undertaking of a “quicker service. For example, a booking may be booked to finish at 7 pm and the next booking is for 7:45, in this example the system would advertise a booking for the limited time period of 7 pm to 7:45 pm for a one course meal which may or may not be required to pre-order with a 50% discount.
s) Promotion—Off Peak Promotions: In one embodiment, a system for the offering comprising different and interchangeable elements and terms and conditions. In one embodiment, the off-peak promotions can include promotions that are ongoing, one-off, or constrained by some other event or trigger.

### 5. Distribution

t) Distribution—Channel: In one embodiment the ability to tailor offers by channel. The definition of channel including the method of communicating availability or an offer to booking requestors or potential booking requestors. These channels include, but are not limited to different widgets on different websites, different apps, voice activated modules and artificial intelligence, telephone requests placed directly into the booking allocation module and self-seating processes. These differences in offers can include one or more of the following, such that different channels can further differentiate and target offers to specific groups, individuals:
1. Offer different products by channel
2. Offer different times by channel
3. Offer different promotions by channel
4. Offer different prices by channel
5. Offer different terms and conditions by channel
6. Offer different capacities by channel
7. Release different capacities by channel
Offer different products, capacities, tables, prices, menus, payment terms, and other terms and conditions etc., through different booking widgets, apps or channels.

### 6. Terms and Conditions

u) Terms and conditions—Product: In one embodiment a system to offer the ability to have different deposit requirements or payment terms for different products, menus, booking times, tables, etc.,
v) Terms and Conditions—Distribution Channel: In one embodiment a system to offer the ability to have different deposit requirements or payment terms by channel for different products, menus, bookings times, tables, etc.,
w) Terms and Conditions—by service: In one embodiment a system to offer the ability to have different requirements or terms and conditions by service by channel, for different products, menus, booking times, tables, occasion, group size, etc. as these different constraints carry different risks to the restaurant. For example, a party of 10 not showing up represents a different risk to a 40-seat restaurant than a table of 2 not showing up.
x) Terms and Conditions—Payment: In one embodiment a system to offer the ability to have different deposit requirements or payment terms by service by channel, for different products, menus, booking times, tables, etc., For example, this would require different payment terms and conditions for Valentine's Day dinner versus Valentine's Day lunch.

### 7. Price

y) Price: In one embodiment a system that can allow for and set different prices to be applied dynamically and adjusted manually or automatically by product, service, booking time, channel etc.

### 8. Capacity

z) Capacity—The setting of Capacities and their Availability: In one embodiment a system for the determination of the capacity to be made available (this capacity determination however, still remains flexible within certain defined parameters, for example, based on bookings and the composition of the tables within the permitted floor space).

### 9. Release of Capacity

aa) Release of Capacity—Controlled Release of Capacity: In one embodiment a system for the forecasting of future demand by product, time, group size, occasion etc., so as to control the release of capacity and make changes to the available capacity to include the last received booking request.

### Differentiation—Floor Plan to Scale

In one embodiment, the constraints include a floor plan to scale comprising doors, exits and other openings to scale.

In one embodiment, the constraints include a floor plan to scale comprising walls, columns and other fixed barriers to scale.

In one embodiment, the constraints include a floor plan to scale comprising kitchen, bar, waiters' stations and other service areas to scale.

In one embodiment, the constraints include a floor plan to scale comprising walkways, aisles, and other areas that can not be obstructed to scale.

In one embodiment, the constraints include a floor plan to scale comprising different areas, sub-areas, rooms and other differentiable areas to scale.

In one embodiment, the constraints include a floor plan to scale comprising fixed, flexible seating areas and other differentiable areas to scale.

In one embodiment, the constraints include a floor plan to scale comprising different classes of locations, different classes of tables, different classes of ambiance (such as a widow view class, or a private class, or a less favourable class), different locations that can undertake different menus or different activities, and other differentiable aspect.

In one embodiment, the constraints include a floor plan to scale including all different furniture to scale and areas, subareas, fixed seating areas and flexible seating areas and details as to where that furniture can be placed within the floor plan.

In one embodiment, the constraints include a floor plan to scale including details if additional chairs can be placed around a table which are over and above the normal chairs that would be applied to that table.

In one embodiment, the constraints include the normal preferred quantity of chairs that can be placed around a table as well as a dimension as to the maximum number of chairs that can be placed around at table, including triggers as to when to use the normal quantity of chairs versus the maximum number of chairs.

In one embodiment, the constraints include a floor plan to scale including the quantity of furniture that is owned by the restaurant, the restaurant has in storage or the restaurant can hire and bring, place on the floor plan and how it can “mix and match” in its use.

In one embodiment, the constraints include a floor plan to scale including the table types and chairs types that can be joined and a module to place the tables on the floor plan to scale as well as to calculate the quantity and the position of chairs around a table.

In one embodiment, the constraints include a floor plan to scale including detail of the dimensions or gaps to be allowed between different tables created, the gaps between chairs to different tables etc., placed on the scaled floor plan.

In one embodiment, the constraints include a floor plan to scale including details of dimensions for walkways, aisle widths, exit corridors and other space that is required to be left free between tables and furniture and cannot be obstructed.

In one embodiment, the constraints include a floor plan to scale comprising the relationships, relativities, interchangeabilities of all constraints and information related to the floor plan to scale and the use of the floor plan to scale.

### Differentiation—Menu (Food and Beverage)

In one embodiment, the constraints include different menus including different number of courses that are mandatory for different booking times, different seating, different meal periods/services and different days.

In one embodiment, the constraints include different menus by different courses by different permitted duration times

In one embodiment, the constraints include the option for a user to completely design their own menu, within or without additional menu construction parameters for a fee, an additional fee or a minimum spend requirement within an agreed duration period that can be increased or decreased with an additional payment or discount.

### Differentiation—Booking Time

In one embodiment, the constraints include booking intervals that have different rules attached to them including, number of people for a booking (such that odd number bookings can be eliminated from peak times as they generally result in loss of revenue as the restaurant would have one unproductive chair).

In one embodiment, the constraints include booking intervals that have different rules such that booking requestors are required to accept different conditions for different booking intervals. For example, requiring a user to agree to have a three-course meal or a minimum spend at a peak time.

In one embodiment, the constraints include the booking intervals in the form of a decision tree and different booking interval constraints can be applied to different booking requestors or to different situations. For example, a booking interval constraint can be linked to a CRM (Customer Relationship Management) system and/or to customer history and/or to other third-party systems such that the booking interval constraints are applied differently to different booking requestors.

### Differentiation—Duration Time

In one embodiment, the constraints include duration times that are based on menu and courses selected.

In one embodiment, the constraints include duration times that are based on occasion.

In one embodiment, the constraints include duration times that are based on booking time.

In one embodiment, the constraints include duration times that are based on seating, and/or service, and/or day, and/or day of the week.

In one embodiment, the constraints include duration times that are based on, if the booking is for an odd or even number of guests

In one embodiment, the constraints include booking duration times based on the total number of guests

In one embodiment, the constraints include booking duration times based a minimum spend or the payment of an additional amount for the extension or the booking duration time.

### Differentiation—Purchase Time

In one embodiment, the constraints include the difference in time between the time when the booking is made and the booking time.

In one embodiment, the constraints include the payment of an additional amount or a discount depending of the time the booking is made. For example, a 21-day advance purchase discount.

Differentiation—Ancillary items

In one embodiment, the constraints include a list of ancillary items with an additional price attached that can be recommended to a booking requestor depending on their selections to tempt the customer to upgrade their selection.

In one embodiment, the constraints include a list of personalisation items that a booking requestor can select from with or without the payment of an additional charge.

In one embodiment, the constraints include additional benefits that can be offered to a booking requestor if it appears that they are not happy with the options available as compared to their originally requested constraints.

### Differentiation—Personalisation

In one embodiment the constraints include requests that can be made by a booking requestor which may also include a price the booking requestor is willing to pay and such booking requests can be linked to a pricing table or other third party site so that an estimated amount can be provided or a response can be provided to the requestors estimated amount and such personalisation information and potential additional revenue can be included in any booking allocation decision.

In one embodiment, the constraints for personalisation may include a minimum spend or fixed payment.

In one embodiment, the constraints for personalisation may include any one or more of menu, booking time, duration time, group size, location, class, menu, additional services, payment terms, terms and conditions, etc.

### Differentiation—Customer Experience

In one embodiment, the constraints include different packages with different components including class, table, type of table, area, subarea, group size.

### Differentiation—Customer Occasion

In one embodiment, the constraints include constraints related to the occasion or event. For example, a booking for a wedding may impose additional restrictions and costs to defray the additional costs borne by the venue in preparing and hosting a wedding.

### Differentiation—Customer Group Size

In one embodiment, the constraints include constraints related to the group size. For example, a large group size may be inconvenient depending on a number of factors, including seating arrangements available, staff available, etc.

### Differentiation—Customer Budget

In one embodiment, the constraints include constraints related to a desired amount to be spent by the customer. A customer may have a budget in mind and the system can utilise the budget to include or exclude certain times, dates, products, etc.

### Differentiation—Customer Information and Membership Details

In one embodiment, the constraints include constraints dependent on the customer's membership, such as their status, relative ranking, etc. For example, a SVIP customer may be allocated a window seat, which in turn may affect the bookings of other customers.

### Differentiation—Time Booking/Purchase is Made

In one embodiment, the constraints include the time and date at which the purchase was made. For example, if a purchase was made 6 months ahead of the booking date, different constraints may apply compared to making a booking 6 hours ahead of the booking time.

### Differentiation—Booking Duration Length

In one embodiment, the constraints include the duration time of the booking. For example, a longer booking duration during a busy time may result in the inability to take other bookings and may therefore attract a premium. Conversely, a longer duration booking during a quiet time may be provided free of charge in order to incentivise the customer to stay longer and therefore spend more.

### Differentiation—Promotions

In one embodiment, the constraints include constraints regarding whether a booking is made during a peak time (e.g. Valentine's Day) compared to a quiet time (e.g. Monday lunchtime). Similarly, the constraints may include constraints relevant to any type of promotion, such as a back-fill promotion, an off-peak promotion, a peak-time promotion or a premium promotion.

### Differentiation—Distribution Channel

In one embodiment, the constraints include constraints relevant to the distribution channel. That is, each channel through which a customer may book may have constraints specific to that channel. For example, a channel which is specific to American Express customers may offer a fixed discount of 20% on all wine if a booking is made for dinner on a Tuesday night. The constraint is specific to the channel and not a general promotion to all customers.

As a corollary, there may be constraints specific to distribution channel terms and conditions, product terms and conditions, specific service terms and conditions and payment terms and conditions.

### Differentiation—Price

In one embodiment, the constraints include the price of products and services provided by the venue.

### Differentiation—Capacity Determination

In one embodiment, the constraints include the forecasting of capacity, based on available tables, chairs, table/chair combinations and other factors, such as bad weather, or unusual events, such as a section of the restaurant being shut off due to unusual circumstances, such as renovation.

### Differentiation—Capacity Release and Capacity Readjustment

In one embodiment, the constraints include an ability to estimate or forecast the need for capacity release and capacity readjustment. That is, the constraints may take into account the fact that, on average, a certain percentage of bookings are cancelled.

### Second Aspect—Yield Management—Metrics

In a second aspect the invention provides a system to monitor and measure the performance of the products and services offered, their mix and what changes can be made to improve the performance and outcomes.

In one embodiment, the performance metrics measure and monitor “utilisation” is revenue generating seat hours divide by divided by available seats hours when a space has maximum seats and tables based of a capacity maximisation process.

In one embodiment, the performance metrics measure and monitor “revenue yield” is the actual revenue generated divided by the theoretical revenue that could have been generated if all items sold and item given away as complimentary, we assumed to have been sold at the full recommended retail price.

In one embodiment, the performance metrics measure and monitor “efficiency” being the multiplication of the utilisation percentage with the revenue yield percentage to give you the resulting efficiency percentage.

In one embodiment, the performance metrics measure and monitor all historical seating and booking configurations.

In one embodiment, the performance metrics measure and record the booking profiles of when bookings are made by time, class, table, seating, service and day.

In one embodiment, the performance metrics measure and record the details of all booking times versus arrival times.

In one embodiment, the performance metrices recording all arrival times and departure times, by menu, by courses selected, by booking size, so as to create a matrix of duration times.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1a is an example computing system on which a method and/or a computer program may be operated, in accordance with an embodiment of the invention;

FIG. 1b is an example of a flowchart illustrating a computer system upon which a computer enabled method may be operated, in accordance with an embodiment of the invention;

FIGS. 2a-2e are flowcharts illustrating a computer enabled method for a booking process in accordance with an embodiment of the invention;

FIGS. 2f-2g are flowcharts illustrating a computer enabled method for a booking process in accordance with an embodiment of the prior art;

FIGS. 3a and 3c-h are illustrations of a volumetric (three-dimensional) framework for providing a complex product and service in accordance with an embodiment of the invention;

FIG. 3b is an illustration of a volumetric (three-dimensional) framework for providing a complex product and service in accordance with an embodiment of the invention, as compared to an embodiment of the prior art;

FIGS. 3i-m are illustrations of a framework for providing a product and service in accordance with an embodiment of the prior art;

FIG. 4a is a flowchart illustrating a computer enabled method for a setup process in accordance with an embodiment of the invention;

FIGS. 4b-4c are screenshots of an interface for a setup process in accordance with an embodiment of the invention;

FIG. 4d is a flowchart illustrating a setup process in accordance with an embodiment of the invention;

FIGS. 4e-f are screenshots of an interface for a setup process in accordance with an embodiment of the invention;

FIG. 5a is a flowchart illustrating a setup process in accordance with an embodiment of the invention;

FIG. 5b is a screenshot of an interface for a setup process in accordance with an embodiment of the invention;

FIGS. 6a-c are flowcharts illustrating a setup process in accordance with an embodiment of the invention;

FIGS. 6d-i are screenshots of an interface for a setup process in accordance with an embodiment of the invention;

FIG. 7a is a flowchart illustrating a setup process in accordance with an embodiment of the invention;

FIGS. 7b-l are screenshots of an interface for a setup process in accordance with an embodiment of the invention;

FIG. 8a is a flowchart illustrating a setup process in accordance with an embodiment of the invention;

FIGS. 8b-c are screenshots of an interface for a setup process in accordance with an embodiment of the invention;

FIG. 9a is a screenshot of an interface in accordance with an embodiment of the invention;

FIG. 10a is a flowchart illustrating a setup process in accordance with an embodiment of the invention;

FIG. 10b is a screenshot of an interface for a setup process in accordance with an embodiment of the invention;

FIG. 11a is a flowchart illustrating a setup process in accordance with an embodiment of the invention;

FIGS. 11b-c are screenshots of an interface for a setup process in accordance with an embodiment of the invention;

FIG. 12a is a flowchart illustrating a setup process in accordance with an embodiment of the invention;

FIGS. 12b-e are screenshots of an interface for a setup process in accordance with an embodiment of the invention;

FIGS. 13a-13o are screenshots illustrating a computer enabled method for a booking process utilising an app/widget in accordance with an embodiment of the invention;

FIG. 14a is a diagrammatic representation of a widget configuration in accordance with an embodiment of the invention;

FIG. 15a is a screenshot interface for a setup process in accordance with an embodiment of the invention

FIG. 15b is a diagram illustrating customer ranking rules in accordance with an embodiment of the system;

FIGS. 16a-16b are flowcharts illustrating a computer enabled method for a booking process utilising an app/widget in accordance with an embodiment of the invention;

FIGS. 17a-c are screenshots of a widget in accordance with an embodiment of the invention;

FIGS. 18a to 18e are screenshots illustrating constraint set-ups within the system including pre-order constraints, menu set-up, menu and course duration time set-ups, Super VIP and VIP overrides, table reset times, alternate reporting calendar set-up an embodiment of the invention;

FIG. 19a is a flowchart illustrating constraint set-ups within the system including a menu decision tree in accordance with an embodiment of the invention;

FIGS. 20a-20d are screenshots illustrating setups for an aspect of the booking process utilising an app/widget in accordance with an embodiment of the invention;

FIGS. 21a to 21f are screenshots illustrating the product tree and product set-ups in accordance with an embodiment of the invention;

FIG. 22a-f are screenshots illustrating setups for aspects of the booking process utilising an app/widget in accordance with an embodiment of the invention;

FIGS. 23a to 23c are constraints and flowcharts illustrating a computer enabled method for payment requirements and a pre-payment decision tree;

FIG. 24a is a flowchart illustrating a setup process in accordance with an embodiment of the invention;

FIGS. 24b-c are screenshots of an interface for a setup process in accordance with an embodiment of the invention;

FIG. 25a is a flowchart illustrating a setup process in accordance with an embodiment of the invention;

FIGS. 25b-c is a screenshot of an interface for a setup process in accordance with an embodiment of the invention;

FIG. 26a is a screenshot illustrating a user interface screen in accordance with an embodiment of the invention;

FIG. 27a is a modular representation of the data constructs and the modules utilised to process a booking request in accordance with an embodiment of the invention;

FIG. 28a is a modular representation of the data constructs and the modules utilised to process a booking request in accordance with another embodiment of the invention; and

FIG. 29a-h are flowcharts illustrating a booking process in accordance with another embodiment (hair salon) of the invention.

### THE COMPUTING SYSTEM

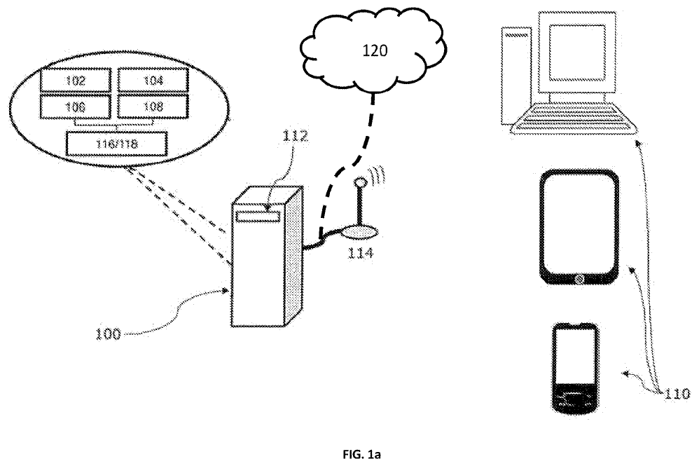

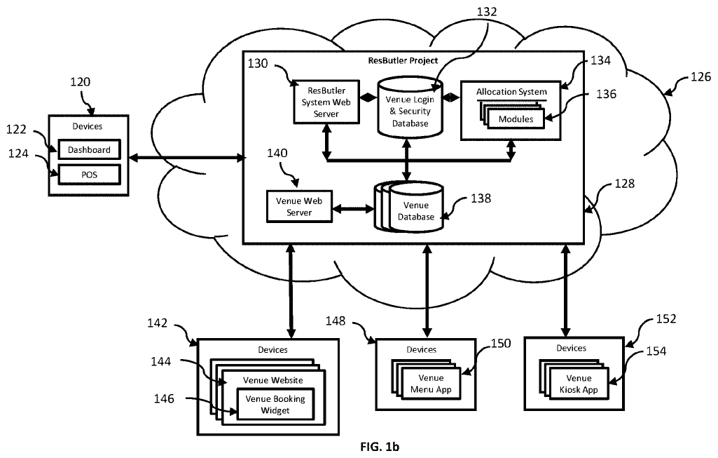

One embodiment of the computing system is shown at FIG. 1a.

In FIG. 1a there is shown a schematic diagram of a computing system, which in this embodiment is a computing system 100 suitable for use with an embodiment of the present invention. The computing system 100 may be used to execute application and/or system services such as a computer program and an interface in accordance with an embodiment of the present invention.

With reference to FIG. 1a, the computing system 100 may comprise suitable components necessary to receive, store and execute appropriate computer instructions. The components may include a processor 102, read only memory (ROM) 104, random access memory (RAM) 106, an input/output devices such as disc drives 108, remote or connected mobile devices 110 (such as computers, smartphones or tablets and the like), and one or more communications link(s) 114 including internet links to other applications, websites and system services including Internet cloud services 120.

The computing system 100 includes instructions that may be installed in ROM 104, RAM 106 or disc drives 112 and may be executed by the processor 102. There may be provided a plurality of communication links 114 which may variously connect to one or more user devices 110, such as computers, smartphones or tablets, wherein the one or more user devices have a user interface for interacting with user by collecting and displaying data or information using the conventional means provided by such devices. At least one of a plurality of communications link 114 may be connected to an external computing network through a telecommunications network, including Internet cloud services 120.

In one particular embodiment the device may include a database 116 which may reside on the storage device 112. It will be understood that the database may reside on any suitable storage device, which may encompass solid state drives, hard disc drives, optical drives or magnetic tape drives. The database 116 may reside on a single physical storage device or may be spread across multiple storage devices, either locally or remotely.

The computing system 100 includes a suitable operating system 118 which may also reside on a storage device or in the ROM of the server 100. The operating system is arranged to interact with the database 116 and with one or more computer programs to cause the server to carry out the steps, functions and/or procedures in accordance with the embodiments of the invention described herein.

The user interface 110 of one or more mobile devices facilitates the collection and display of user data for the computing system 100. The user interface 110 may be a program or website accessed on a computer or mobile device via a communication network, such as the Internet. Alternatively, the user interface 110 may be a widget arranged on a website that may be accessed by a user using a computer or mobile device via a communication network such as the Internet. The user interface 110 may also be provided as a mobile application or “app” present on the user device, such as a tablet or smart phone.

The at least one user interacts with the user interface 110 and may be a first user (also referred to as the “booking requestor”) requesting to use a space in a venue. The at least one user may also include a second user (referred to as the “operator” or “venue operator”), who is associated with the venue and utilizes the optimised space allocation instruction set provided by the allocation module to enable the use of the space by the booking requestor.

The booking requestor interacts with the computing system to make a request. The requestor may make a request for one or more patrons of the venue to use the space in a venue, where the requestor may also be one of the patrons of the venue. That is, a user that interacts with the system is referred (on their own behalf or on behalf of a group of people) is referred to as a booking requestor and the person (or group of people) that will be allocated a table (i.e. attend the venue or restaurant) may be variously referred to as the “patron” or “patrons”, the “customer” or “customers”, the “guest” or “guests” and/or the “diner” or “diners”, or any other term as appropriate for the venue.

An embodiment includes the computer system 100 processing the request and undertaking all subsequent steps in an autonomous manner. Alternatively, in another embodiment, the operator may use one of the user interfaces 110 provided to one or more devices to receive, input, or modify information in order to provide further input to the computer system 100, so that the computing system may process the request and provide instructions to the entity.

In processing the request, the computer system 100 may arrange objects in the space in accordance with the optimised space allocation instruction set. That is, the booking requestor acts as a customer making a request which is to be “serviced” by the operator in accordance with the optimised space allocation instruction set. As may be appreciated by a skilled addressee, there may be any number of remote users and operators who are able to interact with the computing system via the user interface 110 via any number of different devices.

Referring to FIG. 1b there is shown a schematic diagram of the ResButler project. The ResButler application 126 is hosted in a cloud computing environment. The ResButler project 128 includes a web server 130 a venue login and security database 132, an allocation module or system 134 comprising one or more modules or algorithms 136, which connect to a venue database 138 and a venue web server 140. The ResButler project 128 connects with multiple devices 142, 148 and 152. The device 142 is a third party desktop forward/laptop that is capable of displaying a website rendered by venue web server 140. The venue web server 144 incorporates a venue booking widget 146. Similarly, device 148 is a mobile device such as a smartphone or tablet computing system. The device 148 includes an instance of the menu app 150. Analogously, device 152 is a kiosk including a computing system capable of executing a venue kiosk app 154. The ResButler project 128 also interfaces with a device 120 which is located within the venue. The devices 120 may include a point of sale device (POS) 124 and or a device capable of displaying a dashboard 122 in accordance with an embodiment of the invention.

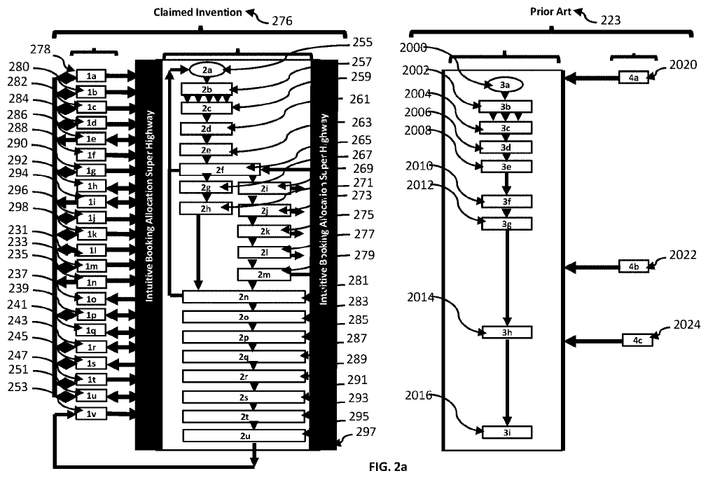

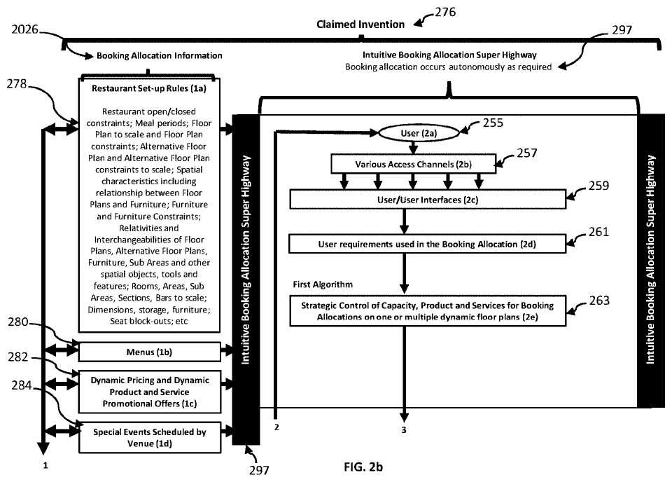

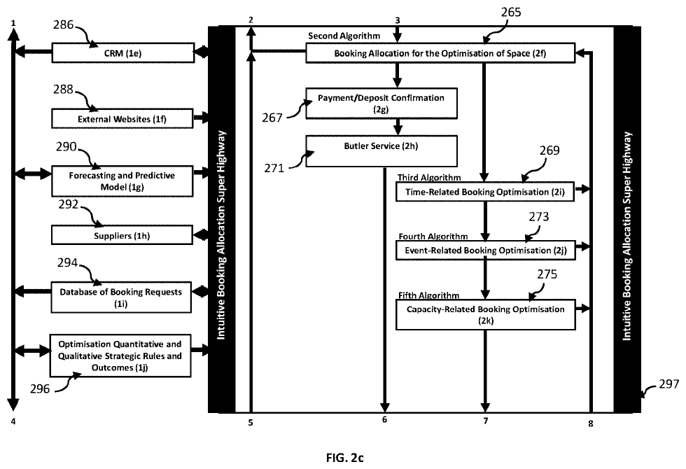

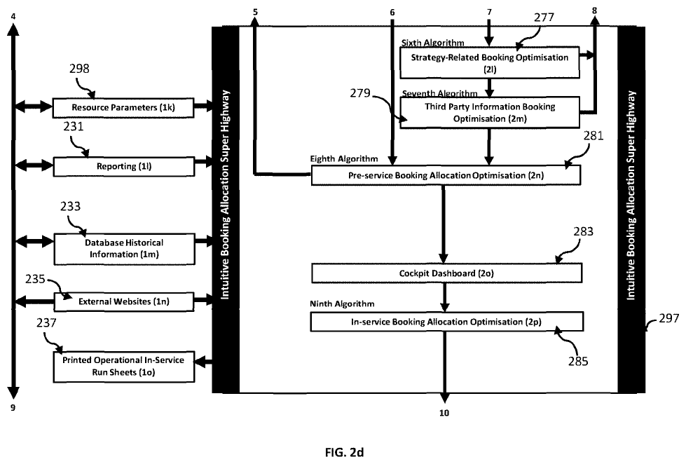

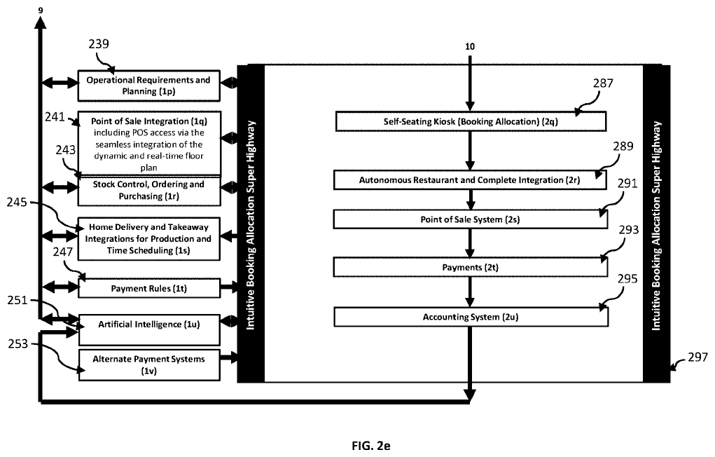

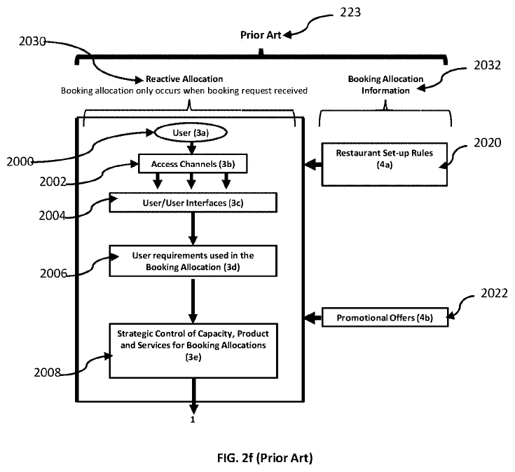

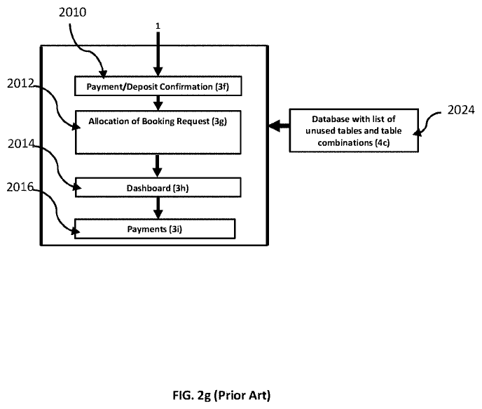

Referring to FIGS. 2a-2g, there is shown a series of flow charts illustrating a comparison between the prior art and a system in accordance with an embodiment of the invention. These figures were previously included in PCT application PCT/AU2018/051168 (and co-pending PCT application PCT/AU2018/051169, PCT/AU2018/051170 and PCT/AU2018/051171) as noted in the background above and also, in the artificial intelligence Australian provisional application AU2019/900128. These figures are also included in the further 11 additional co-pending Australian provisional patent applications lodged on 29 Apr. 2019 which are also related to and support this application. The aforementioned applications are incorporated herein, in their entirety, by reference and are listed below in table 1.

TABLE 1

| Title of related applications | Shorthand |
|---|---|
| A computer-enabled method, system and computer program for providing an intuitive | Space |
| user interface arranged to create a dynamic floor plan utilisable by an allocation | |
| algorithm to perform the task of allocating a space, furniture, equipment or service | |
| A computer-enabled method, system and computer program for generating a dynamic | Widget |
| user interface for use by a user in the allocation of a space, furniture, equipment or | |
| service | |
| A computer-enabled method, system and computer program for dynamically altering | Yield Management |
| constraints utilised in the management of a space, furniture, equipment or service | (The present application) |
| A computer-enabled method, system and computer program for the management of a | POS Transactions |
| multi stage transaction including management of a booking and service delivery | |
| process | |
| A computer-enabled method, system and computer program for providing an intuitive | Rosters |
| user interface and algorithm arranged to create a dynamic roster utilising an allocation | |
| algorithm to perform the task of the allocation of staff to tasks in a workplace | |
| A computer-enabled method, system and computer program for providing an intuitive | Operations |
| user interface arranged to create a dynamic floor plan utilisable by an allocation | |
| algorithm to perform the task of organising and operating a provision of a service | |
| A computer-enabled method, system and computer program for providing an intuitive | Menus |
| user interface arranged to create a dynamic product list integrable into a service | |
| provision process to perform the task of delivering a complex service and managing | |
| an associated transaction | |
| A computer-enabled method, system and computer program for providing an intuitive | Functions |
| user interface arranged to create a dynamic floor plan utilisable by an allocation | |
| algorithm to perform the task of managing a function or event | |
| A computer-enabled method, system and computer program for autonomously | Ordering and Allocation |
| allocating and managing a space, furniture, equipment and/or a service via an | Integration |
| electronic device | |
| A computer-enabled method, system and computer program for managing the | Exchange |
| exchange between third parties of service contracts for the provision of a restaurant | |
| booking or other analogous service | |
| A computer-enabled method, system and computer program for monitoring a plurality | Gaming |
| of gaming machines and other games of chance, and providing a booking and | |
| monitoring service for gaming enthusiasts and gaming venues | |
| An autonomous, integrated computer-enabled method, system and computer program | Artificial Intelligence |
| utilising an artificial intelligence engine for dynamic allocation and optimisation of | |
| space, furniture, equipment and/or services (AU2019/900128) | |
| PCT/AU2018/051168 (and co-pending PCT application PCT/AU2018/051169, | PCT Applications |
| PCT/AU2018/051170 and PCT/AU2018/051171) | |

Referring to now FIGS. 2a to 2e, there is shown a diagrammatic representation of each of the component parts of the system in accordance with an embodiment of the invention. The following descriptions and information add further matter to the original disclosure in the above-mentioned PCT applications to further particularise the features and embodiments described herein. To the extent that the additional description of features and integers contained herein contradicts any disclosure with respect to a feature or integer disclosed in the previous applications, it will be understood that, to the extent of the contradiction, the present application will be taken as being correct for the purpose of the inventions and embodiments disclosed and defined in the present application.

The following references serve as a summary of the information referred to within the embodiment detailed by FIGS. 2a-2g

### Information and Set-Up for Embodiments Described Herein

Restaurant Set-up Rules (278): There are three basic embodiments disclosed herein, each of which utilise a different set of rules to set up a restaurant or any other space that can be reserved for any purpose. In all embodiments, the rules and constraints are arranged to permit the proper contextual relationships, relativities, utility of and flexible table and chair or equipment capacity to allow for effective differentiation, discrimination, yield management, dynamic pricing, revenue management, cost and operations management and the achievement of bespoke (configurable) individual quantitative and qualitative goals of a restaurant.

In the context of the specification and the embodiments and broader invention described herein, the terms “relationship”, “relativity”, “utility” and “contextual relationships” have specific meanings as related to equipment, furniture and other items which can be arranged within a space/venue and which can be ascribed specific attributes, constraints and by extension rules which utilise the attributes and constraints.

Firstly, the term “relativity” in the context of the specification refers to quantifiable attributes and constraints that describe quantifiable variables of a table, chair, furniture or equipment that in turn form the basis for a qualitative assessment of the table, chair and/or equipment. For example, the size and shape of the table, which are quantitative variables, may have an impact on a qualitative attribute of the table, such as the “class” of table. A first class table may be of a larger size and a first class chair may be more luxurious (larger chair). The attribute, however, is relative to other attributes and therefore in and of itself may not be determinative of the overall qualitative assessment of the table. For example, in addition to a physical attribute of the table, the location of the table relative to the space may also be determinative of the class of the table. For example, a table that is near a window and has a view may be considered a first class table, even if the physical attributes of the physical table do not necessarily match those of a “first class” table.

In other words, the term “relativity” refers to quantifiable attributes of furniture/equipment.

Correspondingly, the term “utility” refers to the overall utility that is derivable from the relative attributes and constraints that are associated with each item of furniture, including tables, chairs and other items of equipment.

Secondly, the term “relationship” refers to an association between two or more items, objects etc. For example, a relationship may be that a table is capable of being placed in a particular section. This is a constraint that defines a relationship between the table and the section.

Relationships may be one-to-one, or may be multiple, in that an object or item may have a relationship with a number of other objects or items. In other words, the relationships behave as a constraint with respect to how the two objects or items can interact.

In the past specification, the reference to a “contextual relationship” or to “context”, refers to a relationship that acts as a constraint when specific conditions are met. For example, two tables may have a contextual relationship when placed adjacent to each other, or together, but have no such relationship when they are not placed adjacent to each other.

The rules and constraints stand in contrast to the prior art solutions, which are limited to a predetermined and unchanging limited solution set of non-descript tables and table combinations with simple minimum and maximum chair constraints. The three embodiments shown at (278) are “space”, “tables” and “tables, table combinations and shadow tables” described further below:

### Space

The space embodiment uses a volumetric framework, and a restaurant floor plan or other file or data base to provide a series of restaurant allocation and organisation rules, including the relationships, relativities, utility and capacity of tables, chairs, other furniture and all other constraints within the restaurant.

### Tables

Each table is ascribed an extensive set of characteristics and constraints, such that each table has a specific relativity, relationship, utility and capacity relative to each other table. Moreover, each chair is also ascribed a space relativity which is treated as a second aspect of the invention. This embodiment is similar to the space embodiment noted above. However, there is no utilisation of exact dimensions. In other words, less emphasis is placed on the spatial/dimensional aspect of the “space”, but the rules and algorithm still mimic the “space” embodiment above to achieve a similar outcome. This additional embodiment permits the addition and/or removal of tables from the total capacity of the restaurant.

The use of a list of tables and associated attributes as the underlying set of variables used to define the relativity, relationship, utility and capacity of each table and chair acts as a “common denominator” or as a benchmark for those relativities, relationships, utilities and capacities that provides that relativity. Hence, the use of a list of tables detailing the relationships, relativities, utilities and capacity between each other is an embodiment of the claimed invention. A further embodiment is any combination or permutation of relativities, relationships utilities and capacities of tables, chairs, and the restaurant rules that permits the differentiation, discrimination, yield management, dynamic pricing, revenue management, cost and operations management to achieve bespoke outcomes as disclosed within this and the other related applications.

### Tables, Table Combinations and Shadow Tables

Through an extensive definition of the relationship, relativity, utility and capacity of each table and table combination with each other table and table combination to define a set of constraints rules can be applied to achieve desired outcomes. The development of rules provide granular differentiation and improve outcomes.

Within this embodiment is the concept of “shadow tables”, defined as tables that do not physically exist in the total solution set of tables and table combinations as in the prior art. Alternatively stated, these “shadow tables” are not shown and do not exist on the floor plan within the prior art. These “shadow tables” are a list of permutations of tables that can be placed in an area, sub area, or space such that they can replace previously existing table or table combination within that area, sub area or space such that the allocation process permits the addition of or removal of tables and or chairs from the floor plan to provide a different and more optimised outcome than the prior art.

It will be understood that the permutations are not limited to a fixed number of tables, but can include the addition or removal of tables. For example, a permutation may include two separate tables T1 and T2 and a combined table T1+T2 as per the prior art. However, in the present embodiment, there can also be provided a further table not existing in the prior art (T3) which permits the addition of a different combined table T1+T2+T3. In other words, the permutation allows for the incorporation of additional tables or removal of tables providing completely different configurations and numbers of table to vary the seating capacity, orientation or any other aspect of the table combination in the sub area or area.

Embodiments and aspects of this application are supported by, and with further details provided within the additional related patent applications, but more specifically with the following related patent applications:
1. Space—as described in Table 1

2. Widget—as described in Table 1
3. Menus—as described in Table 1
4. Yield Management—as described in Table 1
5. POS Transactions—as described in Table 1
6. Rosters—as described in Table 1
7. Operations—as described in Table 1
8. Ordering and Allocation Integration—as described in Table 1
9. Gaming—as described in Table 1
10. Exchange—as described in Table 1
11. Artificial Intelligence—as described in Table 1
12. PCT Applications—as described in Table 1

The restaurant set-up rules shown at (278) in one embodiment also include set-up rules for all other spaces or purposes such as for the set-up and booking of functions and/or events with an area, subarea, private room or the entire restaurant. In a further embodiment the set-up rules referred to at (278) also refer to function spaces, event spaces, theatre, show and other spaces, such that a complete event can be enquired, modified, confirmed with or without part or full payment on-line and without the requirement of manual intervention by venue staff.

Embodiments are further described in related co-pending patent applications, with particular reference to the following related patent applications:
1. Functions—as described in Table 1

In a further embodiment, the restaurant set-up measurements provide information that permits a venue to detail the normal or standard set-up for a restaurant including the type, size and normal number of chairs that would be used for a table at a particular location. The restaurant set-up information can be used to determine if more than the standard number of chairs normally set for that table at that location is the physical maximum number of chairs that can be allocated to the table. In a further embodiment the restaurant set-up information can include information which indicates where one or more extra chairs can be placed on a table to increase the capacity of a table (which may also be determined by the relative location of the table in the venue).

For example where a table of two is placed up against a wall (and, hence the wall side is unusable) but, the other side can take an extra chair (as that chair will not be in a walk-way or interfere with any other table, the system is aware of the constraint and can add an extra chair to the table to increase its capacity if required during the booking allocation process.

In a further embodiment the information where the “change” of a table top from say one that is say 750 mm by 700 mm to one that is 800 mm round to permit the seating of 4 people and not 2 (as per the original 750 mm by 700 mm) in the same location, the restaurant set-up rules can include information as to when a restaurant reaches a certain threshold or capacity, such that the rules and algorithms can be used to apply one or more of increasing the capacity to some or all the tables to the maximum number of chairs; or to the maximum table top size, or some other permutation within the information provided and available within the restaurant set-up rules.

In another embodiment the restaurant set-up rules can be combined with any other information or any other permutation of the available information as described herein such that the restaurant allocation rules and algorithms can achieve any of the required quantitative and qualitative outcomes desired by the restaurant. For example, knowledge of the restaurant space, tables, table classes, table locations can be used in conjunction with the information available within a customer's history or CRM to allocate the customer's booking request instantaneously to their favourite or preferred table and preferred chair, or if the customer's favourite is not available to the customer's second preferred table and a preferred seating position, or failing that allocate the booking request to the next highest ranking class of table or table location as so on until that booking is allocated.

In one embodiment, the allocation of a booking can be associated with one physical space, physical item and the same booking can be transferred to another physical space or physical item such that a booking can comprise more than one “experience”. For example, a booking can be allocated to a bar table or bar stool for say 7 pm to 7:30 pm and then moved to the main dining room from 7:30 μm to 9:30 pm and then back to the bar at 9:30 pm for a night cap. In a further embodiment, as this sequence of events can treated as a single booking during the booking allocation process then the system can maintain all financial details and information within that one booking and one account so that information does not have to be manually transferred, or manually reconciled, including any pre-payments within the system or the process by which it is integrated within any POS system.

In a further embodiment the restaurant set-up rules referred to above could be applied to other industries and businesses including, for example, hairdressers, gyms, libraries, accommodation, car rentals and aviation, or any business that requires the allocation of a physical space, physical item during a booking allocation process.

In a further embodiment, the framework, rules, methods, procedures and algorithms, of the current invention can also be applied to the booking of appointments where the primary purpose of the appointment is not the physical space or a physical item but the provision of services such as legal advice, accounting advice, doctors' appointments, hospital appointments etc.

Menus (280): Menus and the use of menus, rather than simply being a presentation of products available for purchase, are integrated into various aspects of the broader system These include channel and widget configuration to offer different menus, not only by time, but by other constraints such as class and specific table; availability and search by different courses and menus; the ability to require customers to commit to different menus and different courses at different times; the ability to recognise and identify different channels and customers to offer specific menus and tailored menus with different conditions such as duration times, prices, payment conditions etc.; eliminate the need for indicating allergy details on menus as alternate menu items would be displayed that did not include the “offending” allergic ingredients, similarly with dietary requirements; the use of alternate menu items not only makes the display to the customer more friendly and personal but permits proper stock decrementing and revenue/sales analysis; the requirement for a customer to select a menu and the number of courses so that more accurate duration times can be calculated or requiring customers to accept variable duration times based on the number of courses they have selected in conjunction with one or more other constraints (such as occasion, time of booking, group size, etc.) in determining the duration a booking would be permitted to occupy a table; the integration of menus into a “product tree” to permit the seamless integration of pre-orders into point of sales systems and the seamless integration of the reconciliation process of prepayments and deposits without the need to create separate pre-paid accounts within POS systems. These embodiments shown at (280).

### Channel Configurability, Differentiation and Identification

In one embodiment, the claimed invention includes the ability of the operator to offer different menus with different dishes, different prices, different numbers of courses, different time durations and can be incorporated with different time durations and that specific information can be used and applied as part of the optimisation and booking allocation process.

### Individual Identification

In one embodiment, the booking allocation system can identify the customer seeking to make a booking and present them with an individual menu or another specific menu and with the knowledge of the individual access that individuals CRM details and apply other additional constraints with respect to their menu selection such as a different duration time or a different duration time at their preferred table as part of the optimisation and booking process.

### Required Selection of a Menus and or Courses

In one embodiment, a customer can be required to select a specific menu and or courses and with that required selection would be a set time such that the selection of the menu item and/o courses, a specific time duration could be applied to that selected menu and courses, incorporating other additional constraint information such as group size, occasion, day of the week, time of booking etc., to apply and or determine a duration time to be applied to that booking request and for that duration time to be used and applied as part of the booking allocation process.

### Alternate Menu Items

In one embodiment, a customer who has an allergy or dietary preference is only shown dishes that are compatible with their requirements, such that the menu item displayed does not include the inappropriate ingredients and simply shows the menu item as the dish will be presented when cooked.

### Menu Systems Integration

In one embodiment the booking allocation system contains a menu building module and/or a separate menu building module includes a product tree structure for the development of menu items (products) that contain ingredients for stock decrementing as well as alternate menu items and ingredients where those menu items are modified for allergies or dietary requirements so that proper stock decrementation can occur. In one embodiment, each menu item by being linked to a product tree permits seamless integration with POS systems, kitchen and bar printing.

In a further embodiment pre-orders are linked to the booking and there is no need to manually re-enter any pre-payments or pre-orders to a POS system as prepayment accounts as prepaid amounts can remain and be controlled within the ordering system and the booking allocation process such that an automatic reconciliation process can be applied when the booking arrives such that the manual transfer between accounts is not required.

Embodiments and aspects of this application are supported by, and with further details provided within the additional related patent application, but more specifically with the following related patent applications which are incorporated herein by reference:
1. Menus—as described in Table 1
2. Widget—as described in Table 1
3. Yield management—as described in Table 1
4. POS Transactions—as described in Table 1
5. Rosters—as described in Table 1
6. Functions—as described in Table 1
7. Artificial Intelligence—as described in Table 1
8. PCT Applications—as described in Table 1

Dynamic Pricing and Dynamic Product and Service Promotional Offers (282): The embodiments described herein include the complete differentiation of the products, services and benefits that can be utilised in the differentiation of a product and service during a booking or appointment process; the use of the complete list of options available for the differentiation of the product or service to create a unique set of differentiated products and services as compared to competitors that can then be offered to their customers; the use of the differentiated products and services as part of a booking or appointment process.

Through these processes, a restaurant online booking process, or other booking or appointment process can be used and permits a restaurant or other business to apply proper and complete yield management including dynamic pricing, peak period pricing, higher pricing of tables with better or higher utility, etc., as compared to the current practice of only offering simple discounts during off-peak periods and incorrectly referring to this as yield management. In a further embodiment the use of and the ability of adding the tailoring of a dining or other bookable experience or appointment such that additional, related or the simple re-arrangement of the sequence of activities can offer greater satisfaction and personalisation to create a total revenue management process. These embodiments are shown at (282) and include the differentiation of products.

In one embodiment additional constraints have been developed and incorporated within the booking allocation system including through the use of the volumetric framework within one embodiment of the invention to permit a full and complete differentiation of the products and services offered by a restaurant including differentiation not considered or accounted for by the prior art including by location, by ambiance, by class, by privacy, by individual table, by ranking of each individual table, by menu, by number of courses, by occasion, by category of customer, by ranking of customer, by event, by conditions or constraints by time of booking, by payment terms, by additional supplementary items committed to, by channel and then these additional differentiation aspects being incorporated and used within the booking allocation process so that the a restaurant can configure these items to optimise their preferred quantitative and qualitative outcomes.

### The Yield Management and Revenue Management of Products

In one embodiment the additional product differentiation referred to above is utilised by the claimed invention to permit the control of capacity offered by differentiated products and services and then to apply yield management techniques which permit the incorporation of dynamic pricing, differential pricing by the differentiated items. In a further embodiment the incorporation of additional and supplementary items including the ability to tailor the sequence of events within a booking or appointment (as one simple example of this embodiment is the ability to permit customers to design their own sharing platters and eliminating the need have an entrée and/or a main course in a traditionally three course a la carte restaurant.

### Promotions

In one embodiment the incorporation of configurable promotions, configurable back fill promotions, and interactive tactical upsell promotions to people hesitating during the booking process or to people who have already booked or to encouraging people to pre-order or while at the restaurant in-service ordering process.

### Sale of Specific Tables and Packages, Auction of Specific Tables and Packages and the Sale of Specific Tables or Packages Through a Restaurant Table Exchange.

In one embodiment the incorporation the sale of specific tables or packages by individual sale by the restaurant or through an “exchange”, “website” or other process that permits the resale of the tables and packages.

### Butler and Concierge Service

In one embodiment there is provided a module that allows the incorporation of additional third-party or ancillary items to personalise the restaurant experience, change the order of service, provide bespoke offerings and experiences not normally or traditionally provided by restaurants, upsell during the booking and ordering process unusual items so that a restaurant can create greater differentiation to competitors. These experiences are not limited to the experiences normally provided by restaurants but targeted at experiences and offering that are outside existing norms to include anything desired by a customer and within the level of acceptability of the restaurant. In a further embodiment the additional information, spending and revenue for a booking can be used within the booking allocation process to provide higher spending, higher revenue, higher contribution or other classification of customers, or more specific experience requirements in the booking allocation process of the claimed invention. In one embodiment this can result in a higher spending customer being given a better table or being provided with an upgrade to a better class of table, extended duration or other benefits or preferential treatment.

Embodiments and aspects of this application are supported by, and with further details provided within the additional related patent applications, but more specifically with the following related patent applications which are incorporated herein by reference:
1. Widget—as described in Table 1
2. Yield management—as described in Table 1
3. Space—as described in Table 1
4. Exchange—as described in Table 1
5. Gaming—as described in Table 1
6. Rosters—as described in Table 1
7. POS Transactions—as described in Table 1
8. Artificial Intelligence—as described in Table 1

Special Events Scheduled by Venue (284): In some embodiments, there is provided a process by which special events may be included by utilising the forecasting and planning modules to create and classify specific events as “one off” events so that they can be properly understood and interpreted by the forecasting modules and therefore also correctly classified and utilised as input data by the artificial intelligence module. More specifically these embodiments are shown at (284).

Embodiments and aspects of this application are supported by, and with further details provided within the additional related patent applications, but more specifically with the following related patent applications which are incorporated herein by reference:
1. Yield Management—as described in Table 1
2. Rosters—as described in Table 1
3. Artificial Intelligence—as described in Table 1

CRM (286): In the embodiments described herein, the CRM is not merely a repository of information and historical data base, as is the case with all prior art, but is a system that contains constraints and information that can be accessed and utilised as part of the booking allocation process. These embodiments include the allocation of a Super VIP and or VIP to their favourite or preferred table automatically during the booking allocation process and not through a manual allocation process undertaken after the booking is accepted, as is the case with the prior art.

Further, in additional embodiments the restaurant or the venue can provide additional information and constraints as to how this CRM information should be utilised, how it should be enhanced, modified or applied during the booking allocation process, including, the addition of complementary items being added to their “running sheet” or “order of service” for their booking, for example, a free glass of wine, or an extended booking duration time, that no deposit or prepayment is required unlike other bookings or other benefit or information.

In a further embodiment, the booking allocation process can automatically embellish the booking allocation process by permitting differentiation between customers and better tailoring and personalise a person's restaurant experience. More specifically these embodiments are shown at (286). Embodiments and aspects of this application are supported by, and with further details provided within all the additional related patent applications:

External Websites (288): In some embodiments, external websites are utilised as not merely a source of information or reference data but as data and information that can be accessed and utilised in the booking allocation process. Embodiments of the allocation methodology, processes and rules can include, a person's social media influence rating, a person's occupation, or other distinguishing feature as inputs to determine the constraints to be utilised by the booking allocation process. More specifically these embodiments are shown at (288)

Embodiments and aspects of this application are supported by, and with further details provided within the additional related patent applications.

Forecasting and Predictive Model (290): The level of detail used by the embodiments in the differentiation of the product or service, yield management, dynamic pricing, revenue management, the detail within a restaurant the personalisation of services etc., allow the forecasting and predictive model of the embodiment to be extremely sensitive and therefore results in far more accurate forecasts and predictions as there is greater monitoring ability as well as “levers” to make changes to achieve desired outcomes.

Specifically in one embodiment the forecasting and predictive model directly accesses the extensive constraints, variables, inputs, historical outcomes and trends, allocation rules, as well as planned events, third party websites, and use that information to develop its forecasts and then to monitor activity against those forecasts by the allocation methods, procedures, algorithms and allocation rules in the allocation of bookings to a space, a table, a table combination, chair or other item to achieve better forecasts and to make changes to the constraints so as to achieve even better outcomes. Embodiments also include the forecasts of functions and events as well as the monitoring of those events and the recommendation of changes or the making of changes to the applied constraints; booking capacities; booking classes; staffing; rosters; resource requirements; operational requirements; maintenance requirements, etc. More specifically these embodiments are shown at (290). Embodiments and aspects of this application are supported by, and with further details provided within the additional related patent applications, but more specifically with the following patent applications:
1. Yield management—as described in Table 1
2. Rosters—as described in Table 1
3. Artificial Intelligence—as described in Table 1
4. Functions—as described in Table 1
5. Operations—as described in Table 1
6. PCT applications—as described in Table 1

Suppliers (292): Orders; Deliveries; Constraints, details etc. (292) The embodiment includes the ability to link a supplier to the booking allocation process such that the suppliers items can be offered within the booking process, the selection of what a person has chosen can then be added to the booking allocation process and algorithm and then an order be placed with the supplier when a person confirms their booking to create a completely integrated process. Embodiments of this process are supported by, and with further details provided within the additional related patent applications.

Database of Booking Requests (294): In one embodiment, the historical booking requests are directly accessed by the booking allocation methods, procedures, algorithms and allocation rules for the allocation of bookings to a space, a table, a table combination, chair, other item or for the allocation or creation of an appointment.

In a further embodiment additional information can be added to the data base of historical booking requests, their behaviour at the restaurant, the allocation provided to them in previous booking requests, overall demand for a time or a service that could not be satisfied and the timing and booking profile of those bookings, etc., (294) Embodiments and aspects of this application are supported by, and with further details provided within the additional related patent applications.

Optimisation Quantitative and Qualitative Strategic Rules and Outcomes (296): Embodiments of the allocations, methods, procedures, algorithms and allocation rules include the creation of specific rules to undertake specific outcomes which can be selected by a venue to create specific outcomes dynamically (the prior art cannot dynamically allocate bookings and relies on a predetermined single priority table and table combination list to allocate bookings).

The specific dynamic allocation can also be combined in different sequences combinations by different time periods, different services, etc., so as to create bespoke outcomes for the benefit of individual venues to better meet their targeted goals and the requirements of their customers. Embodiments with respect to this aspect are not limited to the following examples, detailed; Floor Space Optimisation Algorithm; Time Related Optimisation Algorithm; Event Related Optimisation Algorithm; Strategy Related Optimisation Algorithm; Third-Party Optimisation Algorithm; Pre-service Optimisation Algorithm; In-service Optimisation Algorithm; Self-Seating Optimisation Algorithm (296). Embodiments and aspects of this application are supported by, and with further details provided within all the additional patent applications:
1. PCT applications—as described in Table 1

Resource Parameters (298): The resource parameters include; Venue set-up times, bar set-up times, hosting requirements, kitchen set-up times, roster structures and frameworks including staff metrics such as customers that each staff member can cater for, minimum staffing levels, amount of food that each chef or food station can produce, minimum hours, pay rates, broken chairs, broken tables, equipment out of service etc. (298). Embodiments and aspects of this application are supported by, and with further details provided within the additional related patent applications, but more specifically with the following patent applications:
1. Rosters—as described in Table 1
2. Operations—as described in Table 1
3. Artificial Intelligence—as described in Table 1

Reporting (231): Performance analysis; Customer satisfaction; Deliverables; Labour Analysis; Actual v. Predicted etc. (231) Reporting relates to the additional constraints possible within the claimed invention and the analysis of those constraints and their outcomes. In one embodiment, reporting relates to the use of that analysis to better forecast and utilise that information to create a feedback loop and information to the artificial intelligence module so that it can continually learn and improve this processes and outcomes. This application is supported by, and with further details provided within the additional related patent applications, but more specifically with the following patent applications:
1. Yield Management—as described in Table 1
2. Artificial Intelligence—as described in Table 1

Database Historical Information (233): Database historical information relate to information not currently available or used by the prior art. This information includes: booking duration times by courses, by individual table, by class of table, by occasion etc.; the time bookings made—booking time; classes of bookings; spend by booking types; yield management outcomes; revenue efficiency; walk-in promotions; etc. and wherein this information can be accessed and utilised within the booking allocation process and all other modules including forecasting and artificial intelligence (233) this application is supported by, and with further details provided within the additional related patent applications, but more specifically with the following patent applications, but more specifically with the following patent applications:
1. Yield—as described in Table 1
2. Artificial Intelligence—as described in Table 1

External Websites (235): External websites including weather information relate to information that is accessed and used by the current invention within it booking allocation process, forecasting and artificial intelligence. Embodiments relating to the use of information from external websites within the claimed are supported by, and with further details provided within the additional related patent applications.

Printed Operational In-Service Run Sheets (237): Printed operational and in-service run sheets relate to information that includes the results of the autonomous booking allocation process, the autonomous chair allocation or selection process etc., and is supported by, and with further details provided within the additional related patent applications.

Operational Requirements and Planning (239): Operational requirements and planning within this application refer to staffing levels; rosters, including roster frameworks and standard rosters, roster creation, staff allocation to rosters, adjustments to rosters based on bookings received as compared to bookings forecasted; start/finish times, including pre-times, set-up times, closing procedures and times; orders; delivery schedules; maintenance planning; equipment replacement; occupational health and safety; procedure and policy monitoring; etc. (239). Embodiments within this aspect of the application are supported by, and with further details provided within the additional related patent applications, but more specifically:
1. Rostering—as described in Table 1
2. Operations—as described in Table 1
3. POS Transactions—as described in Table 1

Point of Sale Integration (241): In one aspect, embodiments of the point of sale (POS) integration relate to transactional aspects. These embodiments include the “real time” dynamic floor plan created by the claimed invention being integrated into POS systems with or without the application of the Cartesian “volumetric framework” (which in one embodiment includes more than a three dimensional volumetric framework, as it can include more than three axis) within the integrated POS systems such that the “real time dynamic floor plan” including details of the table, the chairs and booking details by chair, replaces the existing static floor plan within the prior art POS systems. The benefits of this dynamic real time floor plan ensure that restaurant tables are always shown as how they appear in real life, that the tables have the correct table numbers, that the tables show the correct chair set up and all pre-orders are shown on the correct table and the correct chair numbers that change in accordance with the customer's request and the booking allocation process.

In a further embodiment any pre-payments, part payments or deposits including food, beverage and other items are transferred and referenced in detail by the booking system or ordering system, to the POS system on arrival and eliminate the need for the opening of pre-paid accounts within POS systems or other accounting systems which then require manual transfer of amounts between accounts etc. and a subsequent manual reconciliation process. Embodiments, therefore include integrations for dynamic floor plans; table and chair seating plans, allocations and details; orders; payments; deposits; sale items; Etc.; CRM detail integration as it related to the booking allocation and ordering processes of the current invention (241) Embodiments of this application are supported by, and with further details provided within the additional related patent applications:
1. POS Transactions—as described in Table 1
2. Space—as described in Table 1
3. Menus—as described in Table 1

In a further embodiment, the booking allocation system incorporates a transaction system that replaces and enhances the functionality of a traditional P.O.S. system. A transaction system is far more efficient and renders a traditional P.O.S. system obsolete, as most transactions do not occur at one point (hence the current name and terminology of Point-of-Sale systems) but the transactions occur at multiple points and the traditional P.O.S. systems no longer represent an efficient core revenue or accounting system.

In a further aspect the current invention with respect to POS systems relates to the integration and use of POS systems with a booking allocation system such that a person making an order at a counter can be allocated a table and or seat within the venue at the same time with or without a stipulated duration time. In another embodiment a person making an order at an ordering kiosk within a venue can be allocated a table or a seat at the venue with or without a stipulated duration time. In another embodiment where a person is allowed to enter a venue and choose a table or seat of their choice and then order, the embodiment through the integration of a booking system can advise the person how long they can occupy or use the table or chair. In another embodiment through the integration of a seating kiosk (self-seating kiosk), an appointment app a person can be allocated a table including duration permitted. In other embodiments the application of the invention to gyms, hairdressers and even to the appointment setting processes of lawyers etc. Embodiments of this application are supported by, and with further details provided within the additional related patent applications and more specifically:
1. Ordering and Allocation Integration—as described in Table 1

Stock Control, Ordering and Purchasing (243): In one aspect, embodiments of stock control relate the creation of alternate menu item for allergies and dietary requirements of the claimed invention. In one aspect the ordering and purchasing of the claimed invention relate to the creation offering for sale items not traditionally associated with restaurants and the automation of the transactional aspects so that no manual intervention or work is required. This includes the ordering of additional tables and chairs if the allocation model determines the requirement for additional furniture. Embodiments and aspects of this application are supported by, and with further details provided within the additional related patent applications:
1. Space—as described in Table 1
2. Rosters—as described in Table 1
3. POS Transactions—as described in Table 1

Home Delivery and Takeaway Integrations for Production and Time Scheduling (245): In one aspect, embodiments of the home delivery, takeaway integrations for production and time scheduling include the monitoring of time durations, and the autonomous turning on, turning off, or provision of time information concerning food production times, yield management, dynamic pricing and point of sale (POS) integration of the transactional aspects. Embodiments and aspects of this application are supported by, and with further details provided within all the relevant patent applications.

Payment Rules (247): In one aspect, embodiments of payments include the ability to have different payment rules for different menus, different courses, different booking times different prices by booking channel, etc, so that a completely dynamic pricing system and payment constraints are created. Embodiments include; payment decision trees; prepayment and payment constraints, different channel constraints, product differentiation, dynamic pricing etc. (247) Embodiments and aspects of this application are supported by, and with further details provided within the additional related patent applications.

Artificial Intelligence (251): In one aspect, embodiments of artificial intelligence include the complete automation of the entire restaurant process from a systems perspective which is beyond the ability and scope of prior art systems. Including data mining, advanced analytics, modelling and predictive analysis to automatically amend constraints. (251) Embodiments and aspects of this application are supported by, and with further details provided within additional patent applications and more specifically by the following applications:
1. Artificial Intelligence—as described in Table 1
2. Yield Management—as described in Table 1

Alternate Payment Systems (253): In one aspect, embodiments of the alternate payment systems is the ability of a venue to offer alternate payment such as a progress payment option, not available within the prior art. This becomes a viable option within the claimed invention as the autonomous reconciliation of part payments means that the manual reconciliation processes and labour burdens of the prior art are no longer cost prohibitive. Embodiments and aspects of this application are supported by, and with further details provided within the additional related patent applications.

Referring to FIGS. 2a to 2e, the following references are provided as a summary of one embodiment of the information referred to within the flow chart as “Claimed Invention” 276, “Intuitive booking allocation super highway” (297) and booking allocation information 2026, utilising the information and constraints identified and developed 1a to 1v above:

Processes, Methods and Algorithms within the Current Invention

User, in one embodiment (255)

Various Configurable Access Channels, such that the offers, products services etc., can be completely different by channel (257)

Configurable User/User Interfaces: Restaurant booking widget, function booking widget, self-seating kiosk, self-seating app, restaurant booking app, menu pre-ordering app/widget, promotional apps/widgets, booking form, and integrated systems such as POS systems. (259)

User requirements used in the Booking Allocation: Buy a specific table, request a specific table, request an extended dining duration, flowers, chocolates, card, entertainment, gift, different order of service, personal waiter, specific personal waiter, budget, occasion etc. (261)

Strategic Control of Capacity, Product and Services for Booking Allocations: Strategic capacity availability by Area, Sub-area, Section and Class. Strategic Product and Service Availability by Menu, by Courses, by Variable Time Durations to meet revenue and yield management targets. (263)

Booking Allocation for the Optimisation of Space: (Sale of specific tables with guaranteed allocation, Super VIP guaranteed seating, VIP prioritised seating, Optimisation of remaining table allocations to Area, Sub-areas, Sections and Classes based on venue strategy, the introduction of additional tables and/or chairs, the removal of tables and/or chairs, the interchange of tables, the interchange of table tops, etc. (265)

Payment/Deposit Confirmation (267)

Butler Service: Ordering of 3^{rd} Party Services/Products, the changing of the order of service, the introduction of items not traditionally offered by restaurants. (271)

Time-Related Booking Optimisation: At a predetermined time (e.g. 1 hr before service), reallocation of all bookings to offer the best tables to the highest ranking, non-guaranteed table-allocated customers (Musical Chairs) (269)

Event-Related Booking Optimisation: At the occurrence of an event, e.g.: Rain, reallocation of outdoor bookings to tables in undercover Areas, Sub-areas, Sections and Classes. Such a reallocation can be automatic through a linking of the booking process to a third party weather site or through a re-allocation allocation process that has been programmed and can identify the weather affected tables. (273)

Capacity-Related Booking Optimisation: An event that a particular class of table is at full capacity, a determination if demand for other classes of tables is such that they can be reduced and additional tables offered for the class in demand. (275)

Strategy-Related Booking Optimisation: An ambience re-allocation: if restaurant is not expected to fill up or other parameters apply. (277)

Third Party Information Booking Optimisation: Theatre information, website information which may have an impact on capacity decision. E.g. allocating bookings to a minimum space in anticipation of a full theatre next door. (279)

Pre-service Booking Allocation Optimisation: A final optimisation before service taking all the above factors into account, as well as opening up capacity for walk-ins, if such capacity had been previously excluded from the allocated capacity. Creation of run sheets and service notes for staff. If a venue selects self-seating option, floor plans and seating locations as they would appear at time of arrival of each booking are sent to each customer. (281)

Cockpit Dashboard: Dynamic Floor Plan; Time-based floor plan, the booking system having an inbuilt POS system, and the ability to take orders, receive orders, reconcile accounts, etc. including integration to other systems including other POS systems to create a completely integrated dynamic real-time systems environment (283)

In-service Booking Allocation Optimisation: Optimisation can be based on any combination or permutation of the above optimisation algorithms or different algorithms which can only use tables located within the restaurant and/or without moving pre-allocated bookings and/or allocating bookings based on space optimisation or other dimension such as allocation to the best table. (285)

Self-Seating Kiosk (Booking Allocation): Applicable for venues that have selected the self-seating option. The kiosk can provide information on the seating location of confirmed bookings as well as the ability of accepting new walk in bookings as well as providing direction such that a host or someone to seat guests is not required. (287)

Autonomous Restaurant and Complete Integration: Fully integrated information system including table and position sensors. (289)

Point of Sale System: A fully integrated with dynamic real-time table plan layout with orders sent to kitchen and bar as appropriate and automatic reconciliations. (291)

Payments: Fully integrated with links to original booking including part payments by table, customer and position number. (293)

Accounting System: The complete integration of the booking systems with all accounting and transaction systems to produce all reports including revenue; P&L statements such that manual input is minimal (295). Including the implementation of a volumetric framework within the various accounting systems, for example the use of the volumetric framework for per-ordering, the POS system and other accounting systems.

Referring to FIGS. 2f to 2g, the following references are provided as a summary of the information referred to within the flow chart as “Prior Art” 223, “Reactive Allocation” 2030 with booking allocation information 2032:

Prior Art (223)

User (2000)

Access Channels (2002)

User/User Interfaces: Restaurant Booking Widget, Booking Form. (2004)

User requirements used in the Booking Allocation: (Prior Art) Date, time, meal period, pax (2006)

Strategic Control of Capacity, Product and Services for Booking Allocations: (Prior Art) Capacity and Max Group Size by booking time interval for a standard time duration for the whole service or by group size (2008).

Payment/Deposit Confirmation (2010)

Allocation of Booking Request: (Prior Art) Use of a prioritised list of tables and table combinations to allocate bookings. Prior Art process finishes with this step. (2012)

Dashboard: Static Floor Plan (2014)

Payments (2016)

Referring to FIG. 2f and FIG. 2g, the following references are provided as a summary of the information referred to within the flow chart as “Prior Art” 223, “Booking Allocation Information” 2032:

Restaurant Set-up Rules: Open/closed; Meal periods; Floor Plan (not to scale); Seat block-outs; Rooms, Areas, Bars; Tables and table combinations prioritised list; Standard booking time duration or by group size (2020)

Promotional Offers: Discount by time interval (2022)

Database: List of unused tables and table combinations (2024)

It will be understood that the description with regard to FIG. 2a to FIG. 2e are not to be taken as an exhaustive description of the invention or embodiments, but rather a summary of an embodiment, to enable a person skilled in the art to gain an understanding of the broader inventive concept. It will be understood that the preceding and subsequent Figures describe the specific embodiments and aspects as are claimed herein in more detail and provide examples of reduction to practice. Moreover, the description with regard to FIG. 2a to FIG. 2e are not to be taken as evidence that the inventive concept is “abstract” or the mere implementation of an abstract concept. Rather, the description of FIG. 2a to FIG. 2e is intended as a primer or high-level view of the system as a whole, to enable the person skilled in the art to better understand the inventive concept.

It will be understood that the description with regard to FIGS. 2a to 2e are not prescriptive in that all herein features, steps and algorithms are required to be taken or taken in the order that they are shown the description or that they form a definitive list of features, steps and algorithms that comprise the invention. The purpose of FIGS. 2a to 2e and the comparison to a prior art system shown in FIGS. 2f and 2g is to highlight the inventive concept of using the knowledge of space, objects and their relativity and utility data combined with a series of algorithms optimise a space based on the strategic parameters or constraints of a venue.

Moreover, there is described below a series of algorithms, which for convenience, are numbered. However, it will be understood that each algorithm is independent, and the numbering is not reflective of any specific order in which the algorithms are to be applied. The embodiment may apply one or more algorithms dependent on constraint information and the application can be separate to other algorithms, in conjunction with one or more other algorithms, in different sequences with the one or more other algorithms to achieve the desired outcomes for the booking time period in question. The application, sequence, mixture of the algorithms can be configured by each individual restaurant in accordance with their individual strategies and required outcomes.

The first embodiment referred to as the First Algorithm is termed the “Strategic Capacity Control” algorithm, module 263, which makes an assessment of requests based on availability with reference to allocations by space, subspace, class, by time, allowing capacity for walk-ins, by menu, by course, etc.

The second embodiment referred to as the Second Algorithm is termed the “Optimisation of Space Outcomes” module 265, and is relevant to guaranteed table allocations. The algorithm which is an iterative seating optimisation algorithm which is arranged to allocate seating first to Super VIP's and guaranteed seating allocations then based on availability by VIP, group size, etc., to optimise the allocation and position of tables. This algorithm is arranged to optimise floor space efficiency around guaranteed table allocations.

The third embodiment referred to as the Third Algorithm is termed the “Time Related Optimisation” algorithm, module 269, which is best described by an example. For example, one hour before service, if it is decided that no new tables should be added, all bookings are reviewed, and, if there are two different bookings at 6 pm and one booking is from a regular customer and one is from a first time visitor, the regular customer is allocated to the better table and the first time customer is allocated to the other table.

The fourth embodiment referred to as the Fourth Algorithm is termed the “Event Related Optimisation” algorithm, module, 273, which is triggered or undertaken by the occurrence of an event. For example, if it rains, the algorithm would re-allocate part or all of the bookings to outside tables to inside tables as all or part of the outside tables may be rendered unusable.

The fifth embodiment referred to as the Fifth Algorithm is termed the “Full Capacity Optimisation”, module, 275, which is triggered or undertaken when one space, subspace, or class is full. For example, if a specific class within the restaurant was full the algorithm would evaluate if demand for the other classes for that service had availability. If other classes had availability then it would determine if those tables would be filled and what the revenue and contribution would be and if it then determined that it would be best to increase the size of the class that was full and reduce the seating availability in another class it could do so and increase the capacity within the class for which the booking request was received and allocate the booking request against one of the additional tables created in the expanded class.

The sixth embodiment referred to as the Sixth Algorithm is termed the “Strategy and Ambiance Optimisation”, module 277, algorithm. All bookings are reviewed, and if it is found that the restaurant will not be at capacity, the bookings are spread around the restaurant so that a better ambience is achieved within the restaurant. For example, if a restaurant only has two bookings for a Monday evening, the Second Algorithm may have sat both bookings next to each other in a back corner of the restaurant as this was the most efficient use of the restaurant space. This algorithm recognises that this arrangement is not an ideal seating arrangement for an empty restaurant and allocates the two bookings in this example to give both bookings the two best available tables.

The seventh embodiment referred to as the Seventh Algorithm is termed the “Third Party Information Optimisation”, module 279 algorithm. For example, the optimisation algorithm could access third party information such as the bookings for the local theatre and the start and finish times of a show to determine capacity allotments and constraints. Further, it can determine not to offer discounts or promotions at 9 pm as the theatre will finish and it expects numerous walk-in customers.

The eighth embodiment referred to as the Eighth Algorithm is termed the “Pre-Service Quantitative and Qualitative” algorithm, module 281. This is the final optimisation algorithm before a service and can be a combination of one or more of the previous algorithms at the discretion of the restaurant manager. It is run at a predetermined time before service and is also used to create run sheets and provide information to restaurant staff as well as provide final seating plans and arrangements for self-seating customers. As another example, as a restaurant can be split into different classes part of a restaurant can offer self-seating and part of a restaurant can offer full table service.

The ninth embodiment referred to as the Ninth Algorithm is termed the “In-service Allocations without additional tables or changing existing table allocations” algorithm, module 285. This algorithm is executed after service begins and new bookings are limited to the use of only tables physically available within the restaurant. The in-service optimisation process uses the In-service Allocations algorithm to provide a limited optimisation process which limits the allocation process by means of additional constraints to optimise request allocation process with minimise the disturbance to current patrons.

The Ninth Algorithm is not mandatory as the eighth algorithm or any other algorithm or a combination thereof could continue to be used without the need to unseat existing bookings whilst maintaining the ability to add or remove one or more tables. Further, additional algorithms or variations of the booking algorithms could be added to provide additional and different allocation outcomes and as a consequence provide additional tools for both the customer and the restaurant to achieve their preferred objectives and customer service standards.

A co-pending PCT application filed contemporaneously with this application in the name of Grand Performance Online Pty Ltd and entitled “A COMPUTER-ENABLED METHOD, SYSTEM AND COMPUTER PROGRAM FOR PROVIDING AN INTUITIVE USER INTERFACE ARRANGED TO CREATE A DYNAMIC FLOOR PLAN UTILISABLE BY AN ALLOCATION ALGORITHM TO PERFORM THE TASK OF ALLOCATING A SPACE, FURNITURE, EQUIPMENT OR SERVICE” includes a number of annexures number 1 to 11, which are herein incorporated by reference. Referring to Annexures 1 to 11 details are provided of the measures and metrics used by the prior art and by the embodiments and broader invention described herein which are significantly greater and beyond the scope, functionality, integration and ability of the prior art. Specifically the prior art measures and metrics are contained within Annexure 1 while embodiments of the measures and metrics utilised within our claimed invention are detailed in annexures 2 to 11. The prior art is extremely limited in the ability to analyse and report as the prior art firstly does not appreciate and recognise the importance of additional measures and metrics for reporting, forecasting and artificial intelligence. Secondly the prior art does not have the structures, methods and procedures to be capable of calculating the measures and metric calculations to achieve better outcomes. Two such measures are “revenue yield” and “efficiency”.

Referring to Annexures 1 to 11 the following references are provided as a summary of the measures and metrics detailed within the Annexures:

Annexure 1 Prior art measures and metrics: This annexure highlights the prior art metrics and measures are limited to a limited number of practical and theoretical measures that are used and taught within universities to measure restaurant performance and measurements.

Annexure 2 Floor plan guidelines, rankings, and space efficiency measures for the claimed invention: This annexure provides variables related to spatial guidelines and measures, such as; floor space allocation, dining, bar and customer spaces, table top guide, fixed and flexible seating areas including walkways, chair size guide, spacing between tables, waiter stations guide, bar space and bar stools guide, area per person size guide, area per person size guide, area, sub-area, class, section, and table and stool rankings, table analysis, tables for sale, tables for auction, tables dedicated to specific channels, location analysis and floor space efficiency.

Annexure 3 Capacity utilisation and revenue efficiency measures for the claimed invention: This annexure provides variables related to capacity, utilisation and revenue efficiency measures, which include the concept of dynamic floor plans which is a concept of the claimed invention where by additional tables and chairs can be added to a floor plan during the booking allocation process and these additional tables and chairs need to be included within these performance measures and metrics. These measures and metrics include; revenue yield, seat capacity (production) and utilisation, table capacity (production) and utilisation, units of measure of capacity, physical constraints, hours open, service periods open, service hours open, back of house (kitchen) hours, front of house (dining room) hours, revenue measures.

Annexure 4 Booking Analysis for the claimed invention: This annexure provides variables related to booking analysis, such as; Booking requests allocated analysis, booking profile analysis, booking requests rejected analysis, source of booking analysis.

Annexure 5 Duration Time Analysis for the claimed invention: This annexure provides variables related to duration time analysis, such as; duration times by booking size, by occasion, by menu selected, by courses selected, by booking time, by booking day, by customer type, by requests for extended durations, by duration times extended, by table, by class.

Annexure 6 Product Mix Analysis for the claimed invention: This annexure provides variables related to a product mix analysis, for areas, subareas, classes, sections, tables, distribution and channel for items such as; food: by time, by service, by day, by server, by channel; Beverage: by time, by service, by day, by server, by channel; Supplementary items: by time, by service, by day, by server, by channel.

Annexure 7 Revenue and Customer Performance Analysis for the claimed invention: This annexure provides variables related to revenue and customer performance analysis, such as; detailed revenue analysis, detailed customer analysis detailed customer ranking and detailed channel analysis.

Annexure 8 Staff and Roster Parameters for the claimed invention: This annexure provides variables related to staff ratios, requirements, hours, set-up times for the creation of forecasted rosters, performance measurements against those rosters and the use of artificial intelligence to update and maintain those performance measures and use the information to create further improvements to those rosters.

Annexure 9 Profit and Loss Layout (a la carte) structure and definitions for variable costs and fixed costs and contribution analysis for the claimed invention: This annexure variables related to the structure and the relationship between revenue and costs and how those revenues and costs can be determined and understood from a contribution perspective and marginal cost perspective such that decisions and actions taken can be measured in terms of cash generation, contribution and performance for reporting, forecasting as well as for feedback in the artificial intelligence loop.

Annexure 10 Break Even Analysis, Contribution Margins and Variable Pricing Analysis for the claimed invention: This annexure provides variables related to the specific analysis of the financial performance of the claimed invention, the monitoring of the financial performance, for forecasting and for the use of these measures and metrics for learning and artificial intelligence within the framework of the other annexures detailed within this embodiment. This analysis includes; break even analysis utilising the defined profit and loss statement within annexure 9 and other cost performance and analysis measures.

Annexure 11 Supplier Pricing Comparisons and Monitoring for the claimed invention: This annexure provides variables related to requesting comparative pricing, supplier performance and reliability and the monitoring of their performance for recommendations and the automatic placement of orders.

Those skilled in the art can appreciate that the structure of the claimed invention, and more specifically with the measures and metrics referred to within the annexures, that these measures and metrics can easily be converted or adopted within the other industries referred to and to which this claimed invention can be applied to.

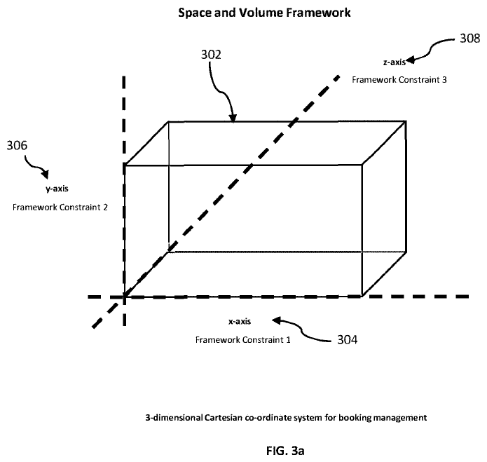

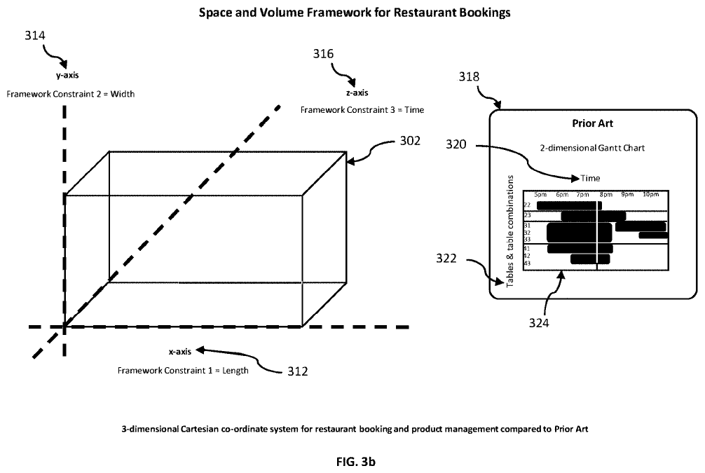

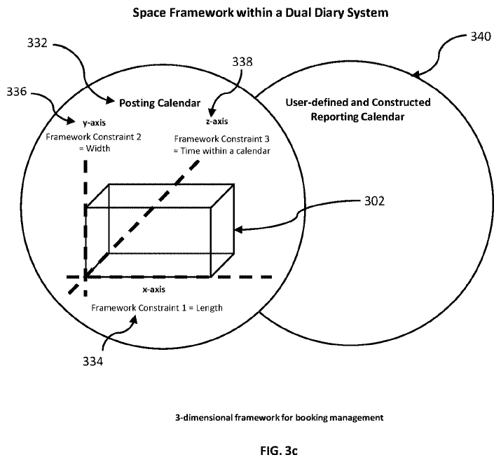

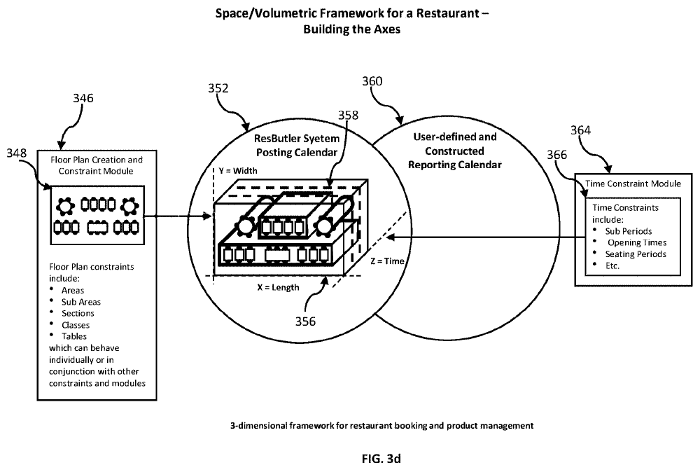

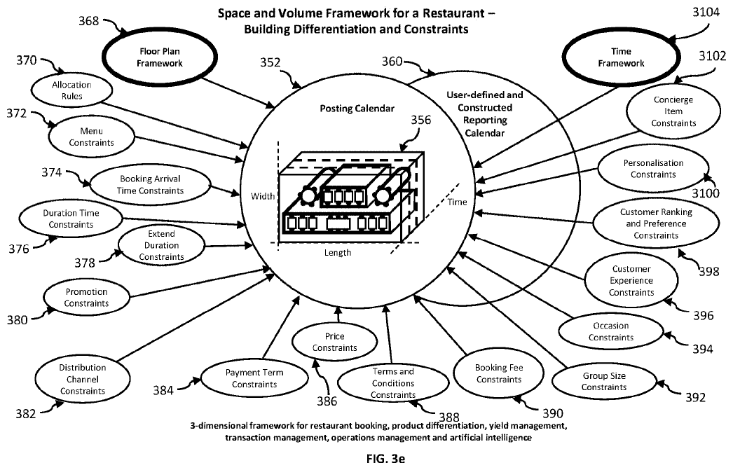

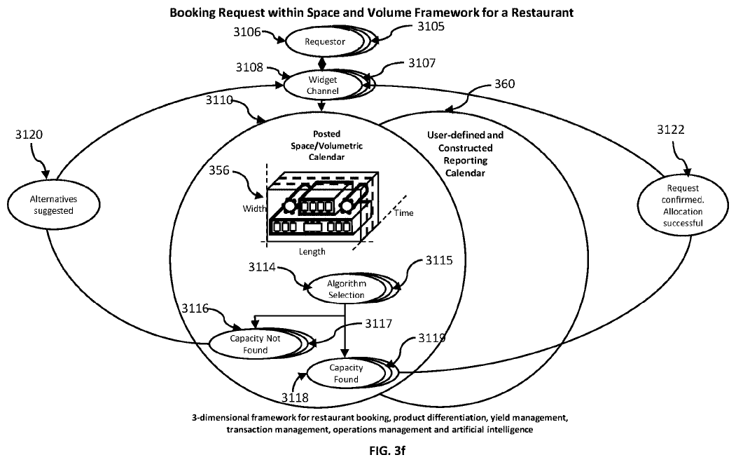

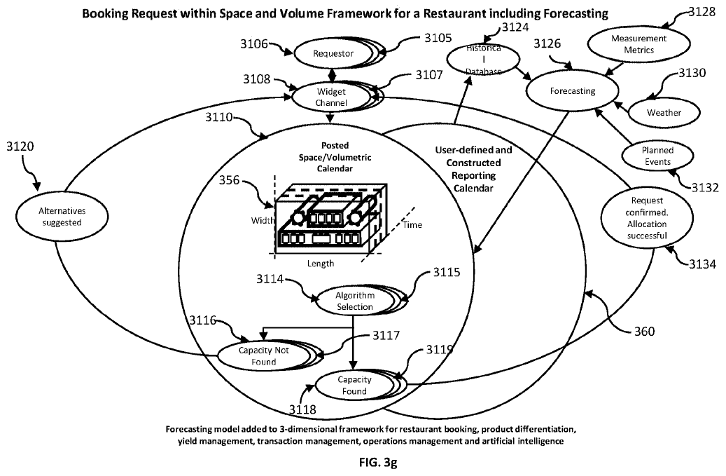

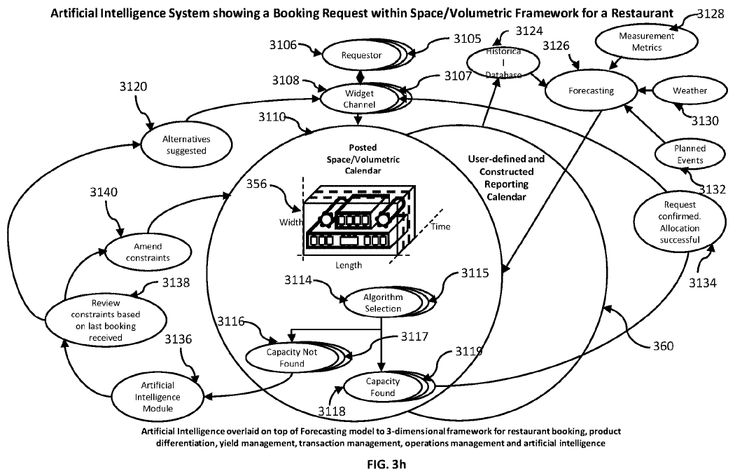

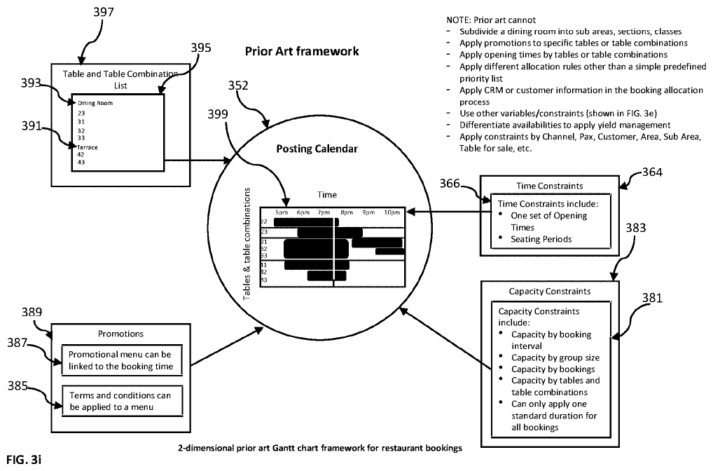

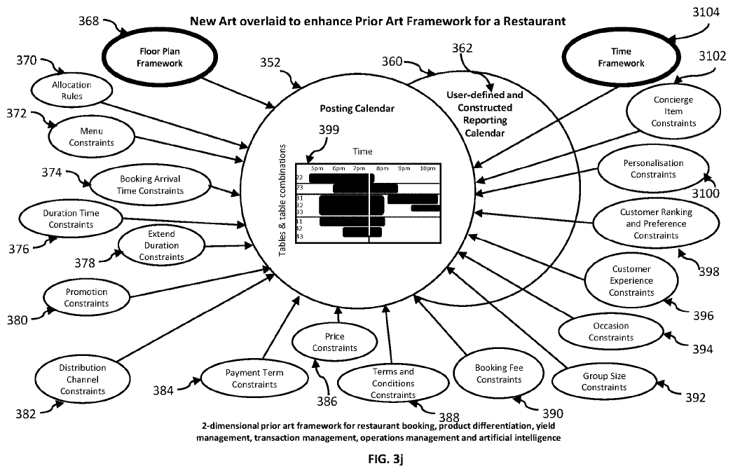

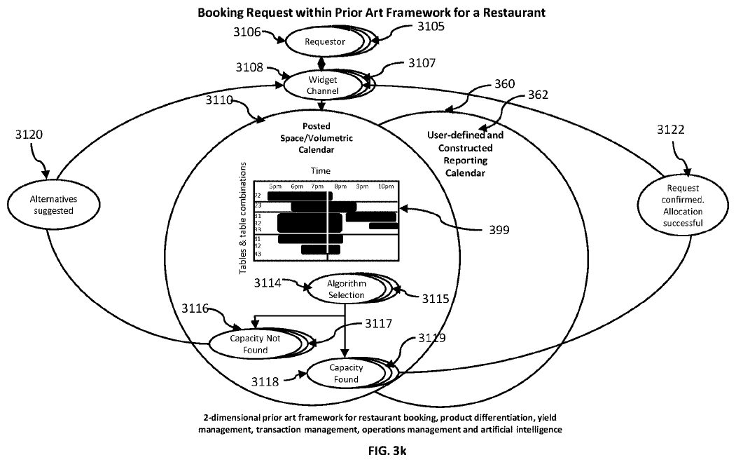

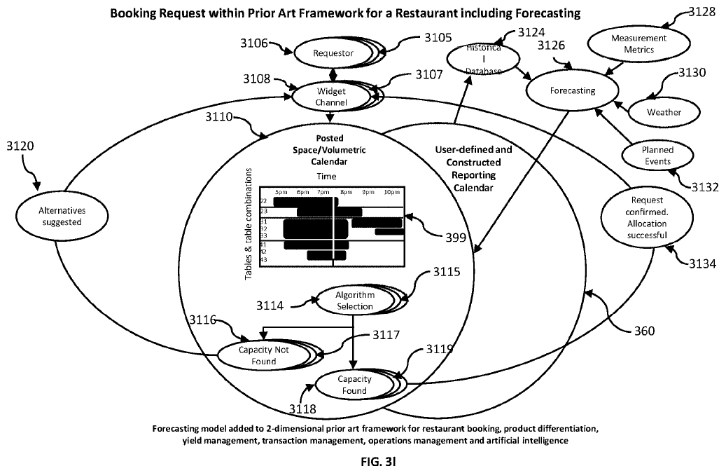

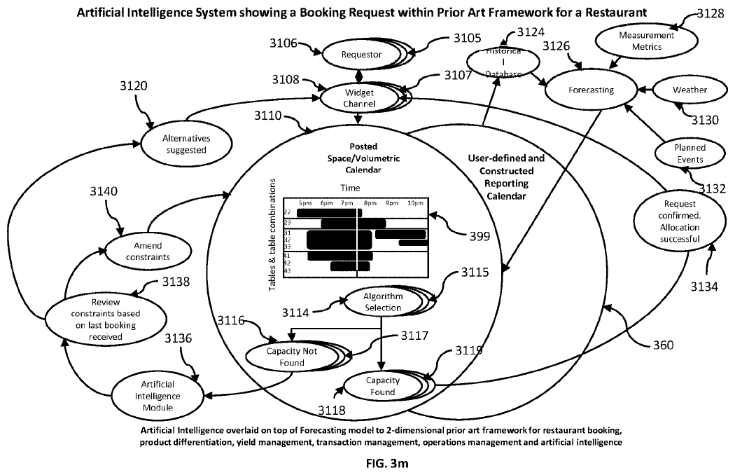

Referring to FIG. 3a, there is shown a diagrammatic representation of a space and volume framework 302. The framework 302 is based on a cartesian three-dimensional framework, which acts as a frame of reference to allow for the visualisation of the elements required to operate a space, including the physical movement of items within the space. The volumetric framework 302 operates across three axes, generically labelled the x-axis 304, the y-axis 306 and the z-axis 308. Each of the axes allow a constraint to be physically mapped relative to the two other constraints that constitute the framework. This provides an additional dimension with which to provide a complete visualisation and operation of the management of a space, as can be seen with reference to FIG. 3b.

Referring to FIG. 3b, there is shown a diagrammatic representation of a space and volume framework as applied to a restaurant booking system in accordance with the embodiment of the invention. There is shown the three-dimensional framework 302 with dimension x 312, dimension y 314 and dimension z 316, compared to a prior art framework 318 which illustrates a Gantt chart 324 including a first dimension 320 and a second dimension 322.

Referring to FIG. 3c, there is shown a diagrammatic representation of a space and volume framework as applied to a dual diary system in accordance with the embodiment of the invention. In more detail, there is described a practical application of the concept of FIG. 3b where the framework 302 with dimensions x 334, y 336 and z 338 are located within the context of a posting calendar 332, which is arranged to interact with a user-defined reporting calendar 340.

Referring to FIG. 3d, there is shown a diagrammatic representation of a space and volume framework as applied to a restaurant booking system in accordance with the embodiment of the invention. A restaurant floor plan 348 is overlaid on the three-dimensional framework. In more detail, a floor plan creation module 346 is utilised to create a floor plan for a restaurant, including the size and shape of the restaurant space, the creation of sub-areas and sections, the division of the areas and/or sub areas into classes, the addition of tables and chairs (including dimensions), etc. The floor plan is placed in the volumetric framework 358 within the calendar 352, where the x and y axes represent the length and width of the space, and the z axis represents time. As such, each area, sub area, class, table, chair, etc. can be tracked over time. The z axis is controlled by a time constraint module 364 which includes time constraints 366 such as opening hours, seating periods, etc.

In other words, the volumetric framework, in addition to the calendar and the floor creation module and time constraint module create a real time simulation of the restaurant, allowing the operator to track all aspects of the restaurant/space over time. This framework is derived from the realisation that the pivotal structure (both physical and conceptual) in the operation of a space such as a restaurant, is the booking and how the booking is allocated and managed. The placement of tables and chairs, the opening hours, the food served, the staff employed, etc., are ultimately all connected to the booking. As such, the volumetric model is a completely different manner in which to conceptualise the operation of a space (and in particular a restaurant space or any other space where a service is provided and there are multiple constraints).

Referring to FIG. 3e, there is shown a diagrammatic representation of a space and volume framework and the constraints which are applied in the context of a restaurant booking system in accordance with the embodiment of the invention. At 352, there is shown the posting calendar including a volumetric framework 356 and the associated reporting calendar 360. A large number of input values, constraints and rules are provided to the volumetric framework, including a floor plan framework 368, allocation rules 370, menu constraints 372, booking arrival time constraints 374, duration time constraints 376, extend duration constraints 378, promotion constraints 380, distribution channel constraints 382, payment term constraints 384, price constraints 386, terms and conditions constraints 388, booking fee constraints 390, group size constraints 392, occasion constraints 394, customer experience constraints 396, customer ranking and preference constraints 398, personalisation constraints 3100, concierge items 3102 and the time framework 3104.

Referring to FIG. 3f, there is shown a diagrammatic representation of a space and volume framework including processing modules arranged to interact with the volumetric framework as applied to a restaurant booking system in accordance with the embodiment of the invention. As with previous diagrams, the central aspect of the booking and management system is the volumetric framework 356 located within the volumetric calendar 3110 which can then post to a reporting calendar 360. A requestor (i.e. a person making a booking) 3106 interacts with a widget through a widget channel 3108 which in turn is in communication with the volumetric calendar. In allocating a booking, the volumetric calendar selects an algorithm 3114 from a plurality of algorithms 3115 in order to determine whether capacity is available. If capacity is found at 3118, then at 3119 the system proceeds to 3122, where the request is confirmed, and a message is returned to the widget channel 3108. If capacity is not found at 3116, an alternative is suggested at 3120 and the process returns the alternative to the widget channel 3108.

Referring to FIG. 3g, there is shown a diagrammatic representation of a space and volume framework including processing modules and a forecasting module arranged to interact with the volumetric framework as applied to a restaurant booking system in accordance with the embodiment of the invention. As with previous diagrams, the central aspect of the booking and management system is the volumetric framework 356 located within the volumetric calendar 3110 which can then post to a reporting calendar 360. A requestor (i.e. a person making a booking) 3106 interacts with a widget through a widget channel 3108 which in turn is in communication with the volumetric calendar. In allocating a booking, the volumetric calendar selects an algorithm 3114 from a plurality of algorithms 3115 in order to determine whether capacity is available. If capacity is found at 3118, then at 3119 the system proceeds to 3134, where the request is confirmed, and a message is returned to the widget channel 3108. If capacity is not found at 3116, an alternative is suggested at 3120 and the process returns the alternative to the widget channel 3108. The space/volumetric calendar also makes use of a forecasting module 3126, which includes access to a historical database 3124, measurement metrics 3128, weather information 3130 and planned events 3132.

Referring to FIG. 3h, there is shown a diagrammatic representation of a space and volume framework including processing modules arranged to interact with the volumetric framework as applied to a restaurant booking system, a forecasting module and an artificial intelligence module in accordance with the embodiment of the invention. As with previous diagrams, the central aspect of the booking and management system is the volumetric framework 356 located within the volumetric calendar 3110 which can then post to a reporting calendar 360. A requestor (i.e. a person making a booking) 3106 interacts with a widget through a widget channel 3108 which in turn is in communication with the volumetric calendar. In allocating a booking, the volumetric calendar selects an algorithm 3114 from a plurality of algorithms 3115 in order to determine whether capacity is available. If capacity is found at 3118, then at 3119 the system proceeds to 3134, where the request is confirmed, and a message is returned to the widget channel 3108. If capacity is not found at 3116, the booking request is sent to the artificial intelligence module 3136, which then at 3138, reviews constraints based on the last booking received, and either amends the constraints 3140 and returns the booking request to the calendar 3110, or alternatively, suggests an alternative at 3120 and returns the alternative to the widget channel 3108. The space/volumetric calendar also makes use of a forecasting module 3126, which includes access to a historical database 3124, measurement metrics 3128, weather information 3130 and planned events 3132.

Referring to FIG. 3i, there is shown a diagrammatic representation of a prior art framework as applied to a restaurant booking system in accordance with the embodiment of the invention. There is shown a Gantt chart 399 which is situated within a posting calendar 352. The Gantt chart is capable of being controlled by a table and table combination list module 395, which includes segmenting by areas, such as 391 and 393. There is also provided a promotions module 389 including promotional menus 387 and specific terms and conditions 385. There is also provided a time constraints module 364 including sets of time constraints 366, and a capacity constraints module 383, which includes specific capacity constraints 381, which can be modified to suit the particular circumstances of the [incomplete]

Referring to FIG. 3j, there is shown a diagrammatic representation of a framework as applied to a restaurant booking system in accordance with the embodiment of the invention. At 352 there is shown the posting calendar including a conventional Gantt chart 399 and an associated reporting calendar 360. A large number of input values, constraints and rules are provided to the volumetric framework, including a floor plan framework 368, allocation rules 370, menu constraints 372, booking arrival time constraints 374, duration time constraints 376, extend duration constraints 378, promotion constraints 380, distribution channel constraints 382, payment term constraints 384, price constraints 386, terms and conditions constraints 388, booking fee constraints 390, group size constraints 392, occasion constraints 394, customer experience constraints 396, customer ranking and preference constraints 398, personalisation constraints 3100, concierge items 3102 and the time framework 3104.

Referring to FIG. 3k, there is shown a diagrammatic representation of a space and volume framework including processing modules arranged to interact with the volumetric framework as applied to a restaurant booking system in accordance with the embodiment of the invention. As with previous diagrams, the central aspect of the booking and management system is the Gantt chart 399 located within the volumetric calendar 3110 which can then post to a reporting calendar 360. A requestor (i.e. a person making a booking) 3106 interacts with a widget through a widget channel 3108 which in turn is in communication with the volumetric calendar. In allocating a booking, the volumetric calendar selects an algorithm 3114 from a plurality of algorithms 3115 in order to determine whether capacity is available. If capacity is found at 3118, then at 3119 the system proceeds to 3122, where the request is confirmed, and a message is returned to the widget channel 3108. If capacity is not found at 3116, an alternative is suggested at 3120 and the process returns the alternative to the widget channel 3108.

Referring to FIG. 3l, there is shown a diagrammatic representation of a space and volume framework including processing modules and a forecasting module arranged to interact with the volumetric framework as applied to a restaurant booking system in accordance with the embodiment of the invention. As with previous diagrams, the central aspect of the booking and management system is the Gantt chart 399 located within the volumetric calendar 3110 which can then post to a reporting calendar 360. A requestor (i.e. a person making a booking) 3106 interacts with a widget through a widget channel 3108 which in turn is in communication with the volumetric calendar. In allocating a booking, the volumetric calendar selects an algorithm 3114 from a plurality of algorithms 3115 in order to determine whether capacity is available. If capacity is found at 3118, then at 3119 the system proceeds to 3134, where the request is confirmed, and a message is returned to the widget channel 3108. If capacity is not found at 3116, an alternative is suggested at 3120 and the process returns the alternative to the widget channel 3108. The space/volumetric calendar also makes use of a forecasting module 3126, which includes access to a historical database 3124, measurement metrics 3128, weather information 3130 and planned events 3132.

Referring FIG. 3m, there is shown a diagrammatic representation of a framework as applied to a restaurant booking system in accordance with the embodiment of the invention. As with previous diagrams, the central aspect of the booking and management system is the Gantt chart 399 located within the volumetric calendar 3110 which can then post to a reporting calendar 360. A requestor (i.e. a person making a booking) 3106 interacts with a widget through a widget channel 3108 which in turn is in communication with the volumetric calendar. In allocating a booking, the volumetric calendar selects an algorithm 3114 from a plurality of algorithms 3115 in order to determine whether capacity is available. If capacity is found at 3118, then at 3119 the system proceeds to 3134, where the request is confirmed, and a message is returned to the widget channel 3108. If capacity is not found at 3116, the booking request is sent to the artificial intelligence module 3136, which then at 3138, reviews constraints based on the last booking received, and either amends the constraints 3140 and returns the booking request to the calendar 3110, or alternatively, suggests an alternative at 3120 and returns the alternative to the widget channel 3108. The space/volumetric calendar also makes use of a forecasting module 3126, which includes access to a historical database 3124, measurement metrics 3128, weather information 3130 and planned events 3132.

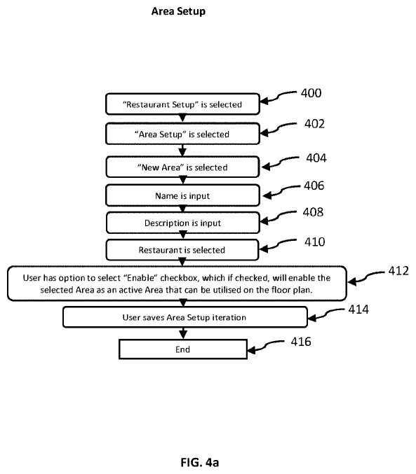

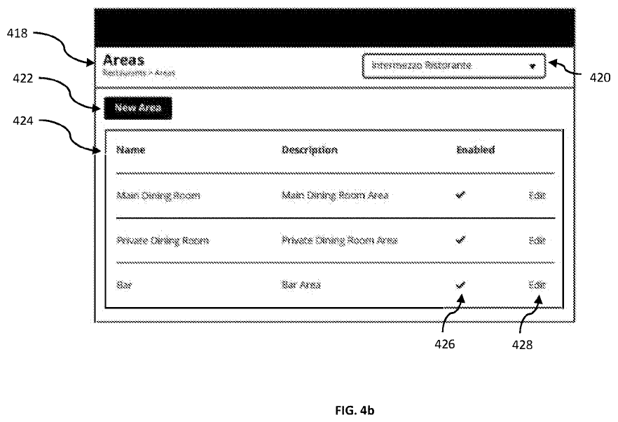

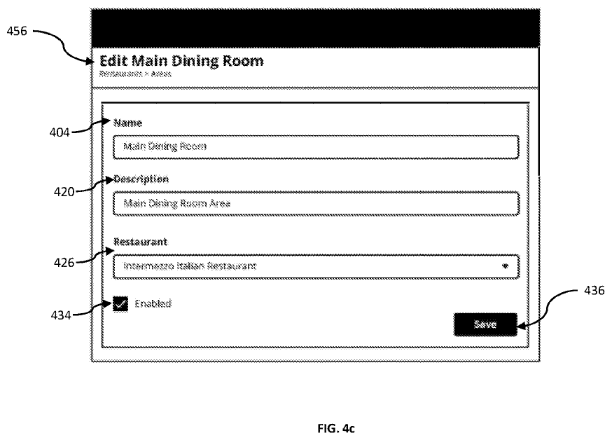

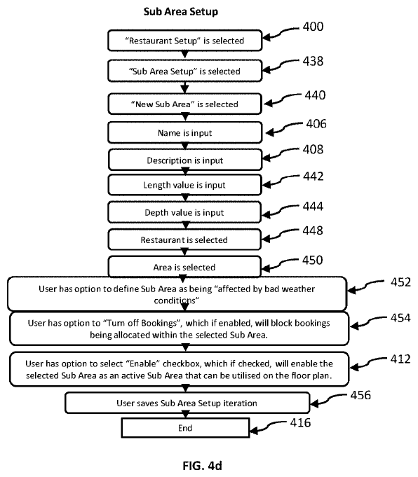

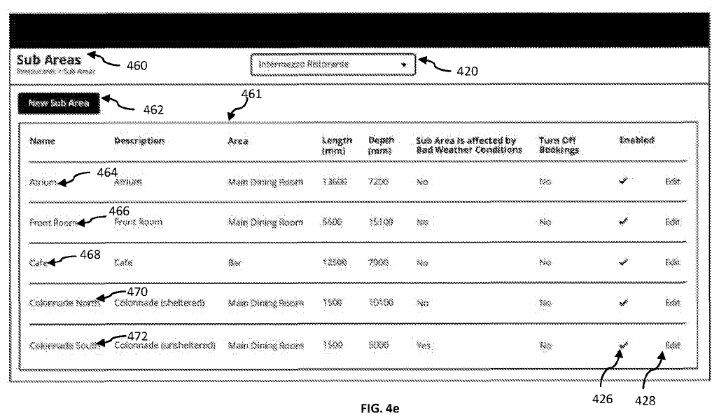

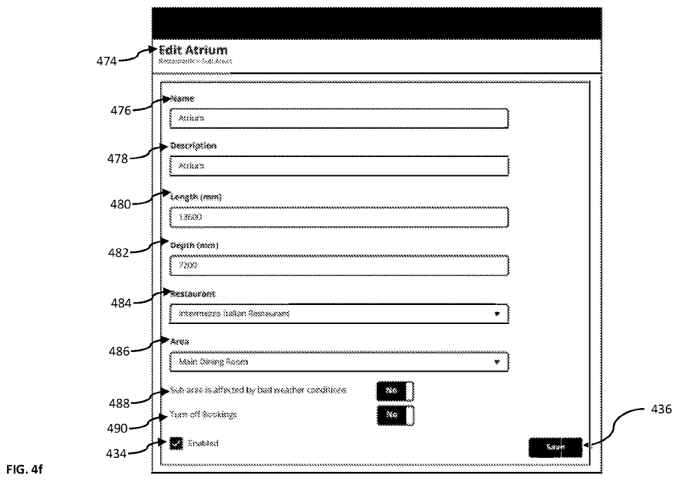

Referring now to FIG. 4a, there is shown a flowchart which outlines the process steps utilised to setup an area of a floor plan in a restaurant for placement on a floor plan (and the subsequent generation of constraints to be utilised in the determination of allocations of furniture in response to booking requests) in accordance with an embodiment of the invention. The setting up of a floor plan generates a set of constraints for use by the algorithm and also serves as a set of “starting conditions” for determining the placements of tables and chairs. However, it will be understood that the inclusion of a set of starting conditions does not serve to limit the ability of the algorithm to allocate or reallocate tables per se, but rather serves as a means by which to generate a series of constraints for use by the algorithm.

Importantly, at a practical level, the starting floor plan also serves as a visual indicator to a restaurant operator and other staff, as it serves as a visual “starting point” so that, before bookings are received, the operator is given a sense of the likely layout of a restaurant.

Turning to FIG. 4a, at step 400, the operator selects “Restaurant setup” and then at step 402 selects “Area setup”. A “new area” is selected at step 404 and a name for the new area is input at step 406. A description may also be input at step 408, and subsequently the new area is associated with a specific restaurant at step 410. At step 412, the operator can select to make the area active, such that it is displayed on the floor plan. The operator then saves the area at step 414 and the process ends at step 416.

Referring to FIGS. 4b and 4c there is shown two screenshots of area setup screens 418 and 460 which allow a user to set up areas in a restaurant to which sub-areas may be added to develop a floor plan and also generate associated constraints, as was described with reference to the process flows of FIG. 4a. Referring to FIG. 4b specifically, there is shown a screen shot 418 in which a restaurant may be selected at 420. There is also provided a new areas button 422, which if chosen, generates an interface in accordance with FIG. 4c (described below). There is further provided an area list 424 which includes the name and description of the area, and from which the operator can choose to enable the area by using check boxes 426 and edit the area by using edit function 428.

Referring to FIG. 4c, when the operator selects the new area button 422 (as shown in FIG. 4b), the interface 456 is displayed to the operator. The operator may then input a name at 404, input a description at 420, select a restaurant at 426 and determine whether the selected area is available for bookings. The operator may also save the selected and/or input options by using save button 436.

Referring to FIG. 4d there is shown a flowchart which outlines the process steps utilised to setup a sub-area in a restaurant for placement on a floor plan (and the subsequent generation of constraints to be utilised in the determination of allocations of furniture in response to booking requests) in accordance with an embodiment of the invention.

At step 400, restaurant setup is selected. Thereafter, the operator selects a sub area setup option 438. A new sub area option is selected at 440, after which a name is input 406, a description is input 408, a length value 442 is input, a depth value 444 is input, a restaurant is selected 448 and an area is selected 450. Thereafter, the operator has the option to define whether the area may be affected by weather conditions 452, the option to “turn off bookings” 454 (so that the algorithm will not allocate bookings to the sub area), select an enable checkbox 412, which allows for the utilisation of the sub area on the floor plan, and finally the operator saves the sub area setup at step 456 and the process ends at 416.

Referring to FIGS. 4e and 4f there is shown two screenshots of area setup screens 460 and 474 which allow a user to set up sub areas in a restaurant to which furniture may be added to develop a floor plan and also generate associated constraints, as was described with reference to the process flows of FIG. 4a. Referring to FIG. 4e specifically, there is shown a screen shot 460 in which a restaurant may be selected at 420. There is also provided a new sub area button 462, which if chosen, generates an interface in accordance with FIG. 4f (described below). There is further provided a sub area list 461 which includes the name and description of the sub area, and from which the operator can choose to enable the area by using check boxes 426 and edit the area by using edit function 428.

Referring to FIG. 4f, when the operator selects the new sub area button 462 or edit link 428, (as shown in FIG. 4e), the interface 474 is displayed to the operator. The operator may then input a name at 476, input a description at 478, select a restaurant at 484 and determine whether the selected sub area is available for bookings. The operator may also select whether the sub area is affected by weather at 488 and can turn off bookings at 490. Moreover, the user can choose to enable or disable the area using checkbox 434. The operator may also save the selected and/or input options by using save button 436.

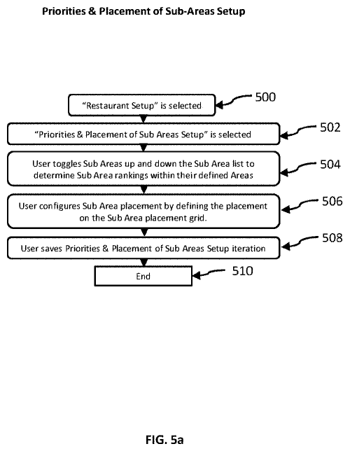

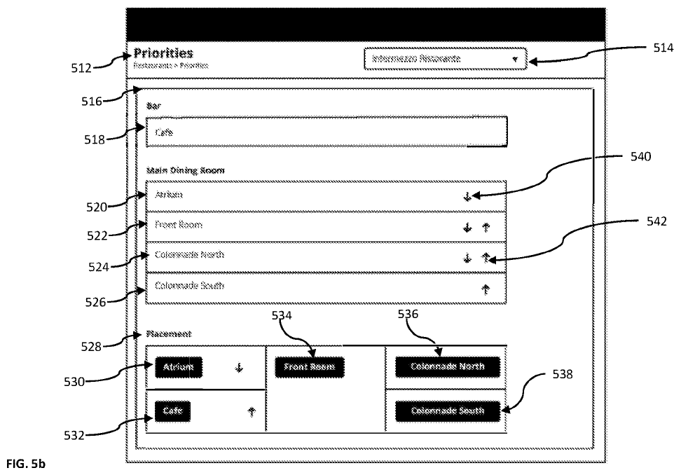

Referring to FIG. 5a there is shown a flowchart which outlines the process steps utilised to place sub-areas and prioritise sub-areas in a restaurant for placement on a floor plan (and the subsequent generation of constraints to be utilised in the determination of allocations of furniture in response to booking requests) in accordance with an embodiment of the invention. At step 500, the restaurant setup option is selected and subsequently at step 502 the priorities and placement of sub areas setup is selected. The operator may then, using the interface, move sub-areas up or down a list to allocate a relative ranking to each sub-area at step 504. The operator may also configure sub-area placement by defining the placement on a sub-area placement grid at step 506. The operator then saves the setup at step 508 and the process ends at step 510.

Referring to FIG. 5b there is shown a screenshot of setup screen 512 which allows a user to set up sub-areas and prioritise sub-areas in a restaurant and associated constraints, as was described with reference to the process flow of FIG. 5a. The operator can select a restaurant utilising selector 514. The operator can also input or configure existing data to generate constraints in area 516, which includes the ability to prioritise sub areas within an area, such as example sub areas 518, 520, 522, 524 and 526 by utilising arrows 540 and 542, and also affect the placement of sub-areas in the placement option 528, which allows for the movement of rectangular objects representing sub-areas, such as example sub-areas 530, 532, 534, 536 and 538.

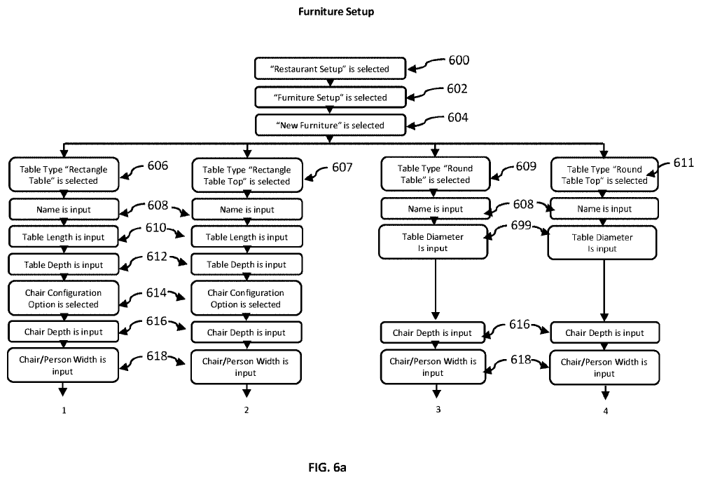

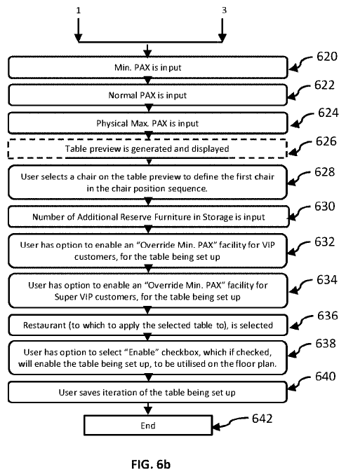

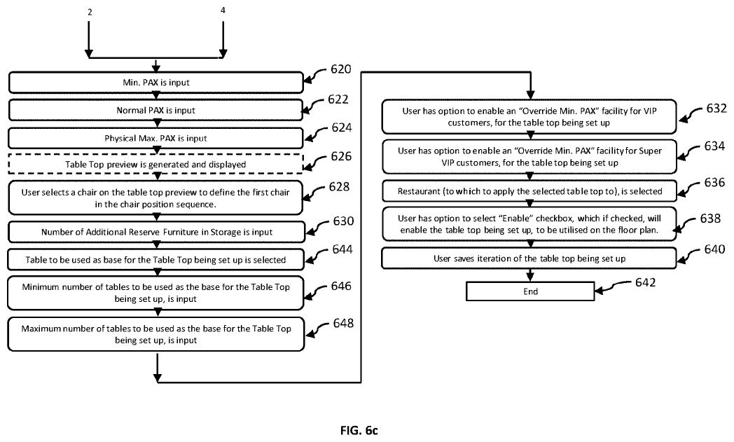

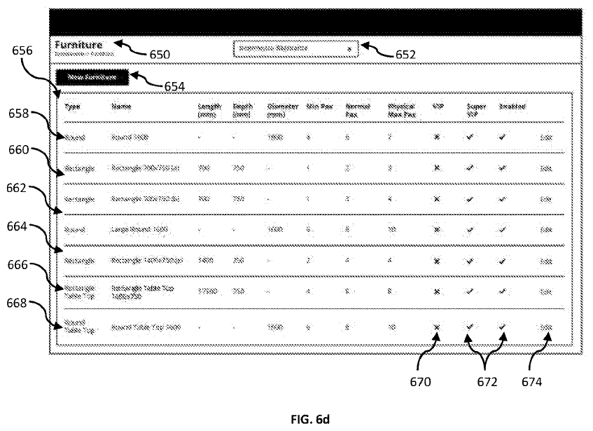

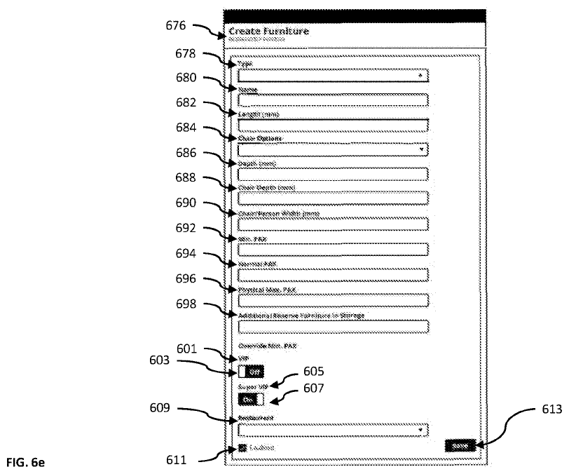

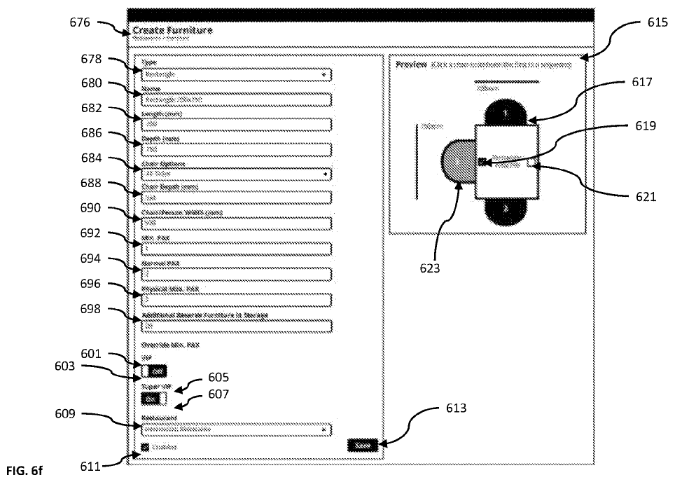

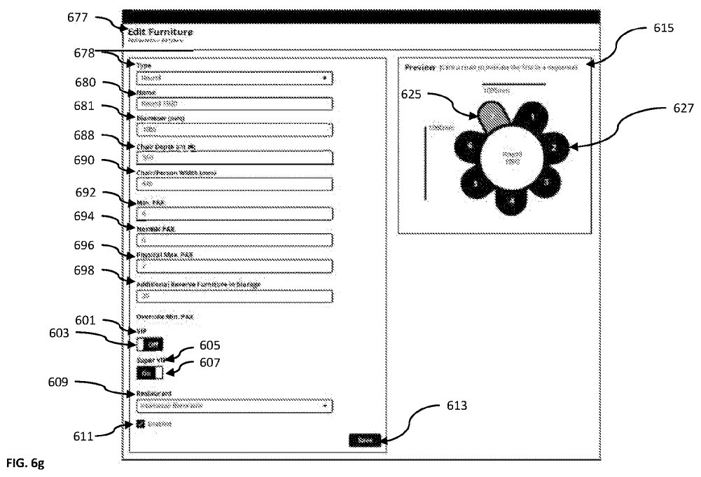

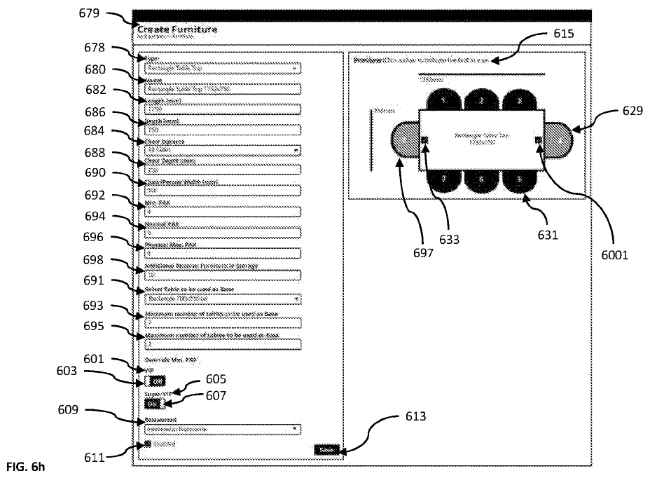

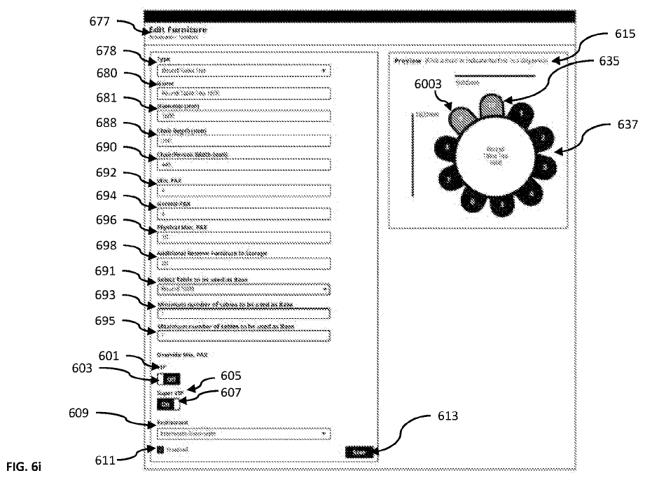

Referring to FIGS. 6a, 6b and 6c there is shown interconnected flowcharts which outline the process steps utilised to setup items of furniture in a restaurant for placement on a floor plan (and the subsequent generation of constraints to be utilised in the determination of allocations of furniture in response to booking requests) in accordance with an embodiment of the invention.

Referring firstly to FIG. 6a, there is shown a furniture setup process flow where at step 600, a restaurant setup is selected and at step 602, a furniture setup is selected, and subsequently the operator selects a new furniture option a step 604. Upon selecting a new furniture option, in the embodiment shown, there are provided four table types, namely rectangle table, rectangle table top, round table and round table top. It will be understood that these types are illustrative only and that the system may include any type of table type, of any shape and attribute.

At step 606, if the operator selects rectangle table type, the operator can then ascribe a name to the table type at step 608 (a free form name that may have significance to the operator), after which the operator inputs a table length at step 610, a table depth at step 612, a chair configuration option at step 614, a chair depth at step 616 and a chair width at step 618, before the process continues along arrow 1 which is described in FIG. 6b. Alternatively, at step 607, if the operator selects rectangle table top type, the operator can then ascribe a name to the table type at step 608 (a free form name that may have significance to the operator), after which the operator inputs a table length at step 610, a table depth at step 612, a chair configuration option at step 614, a chair depth at step 616 and a chair width at step 618, before the process continues along arrow 2 which is described in FIG. 6c. Alternatively, at step 609, if the operator selects round table type, the operator can then ascribe a name to the table type at step 608 (a free form name that may have significance to the operator), after which the operator inputs a table diameter at step 699, a chair depth at step 616 and a chair width at step 618, before the process continues along arrow 3 which is described in FIG. 6b. Alternatively, At step 611, if the operator selects round table top type, the operator can then ascribe a name to the table type at step 608 (a free form name that may have significance to the operator), after which the operator inputs a table diameter at step 699, a chair depth at step 616 and a chair width at step 618, before the process continues along arrow 4 which is described in FIG. 6c.

Referring to FIG. 6b, there is shown a continuation of arrows 1 and 3 of FIG. 6a. At step 620 the operator inputs the minimum number of people to be seated at the table, after which at step 622 the operator inputs the normal number of people to be seated at the table, after which the operator inputs the physical maximum number of people to be seated at the table at step 624 (which may be different from the “desired” maximum). At step 626, a table preview is generated and displayed. Using the generated display, at step 628 the operator selects an arbitrary chair to designate as chair ‘1’, at which time all other chairs are numbered accordingly. The number of spare tables in storage are then input at step 630 and the operator decides whether to enable an ‘override’ option which allows VIPs and SVIPs (at steps 632 and 634 respectively) to be seated at a table irrespective of whether the booking request meets the minimum criteria input in step 620, or exceeds the normal pax setting input in step 622. The operator then assigns the table to a restaurant at step 636, and also decides whether the table is to be used on the floor plan at step 638. Lastly, the user saves the iteration of the table at step 640 before the process ends at step 642.

Referring to FIG. 6c there is shown a continuation of arrows 2 and 4 of FIG. 6a. At step 620 the operator inputs the minimum number of people to be seated at the table, after which at step 622 the operator inputs the normal number of people to be seated at the table, after which the operator inputs the physical maximum number of people to be seated at the table at step 624. At step 626, a table top preview is generated and displayed. Using the generated display, at step 628 the operator selects an arbitrary chair to designate as chair ‘1’, at which time all other chairs are numbered accordingly. The number of spare tables in storage are then input at step 630. Subsequently at step 644, the table type which will be used as a base is selected, along with the minimum number of tables to be used as the base at step 646 and the maximum number of tables to be used as the base at step 648. The operator then decides whether to enable an ‘override’ option which allows VIPs and SVIPs (at steps 632 and 634 respectively) to be seated at a table irrespective of whether the booking request meets the minimum criteria input in step 620, or exceeds the normal pax setting input in step 622. The operator then assigns the table top to a restaurant at step 636, and also decides whether the table is to be used on the floor plan at step 638. Lastly, the user saves the iteration of the table at step 640 before the process ends at step 642.

Referring to FIGS. 6d through to 6i, there is shown a series of screenshots of furniture setup screens 650, 676, 677 and 679 which allow a user to set up furniture items for use in a restaurant and also generate associated constraints, as was described with reference to the process flows of FIG. 6a-6c.

Referring to FIG. 6d, there is shown a screenshot of all furniture types as inputted in an example. The screen 650 includes a restaurant selector 652, a button to add new furniture 654, and various types of furniture such as 656, 658, 660, 662, 664, 666 and 668 are shown. The user may select a furniture item as to allow for SVIP and or VIP customers to override the minimum pax and normal pax settings (670), enable furniture for use on the floor plan (672) and may edit the furniture item at 674.

Referring to FIG. 6e, there is shown a create furniture screenshot 676 which allows for a number of inputs, including selecting a furniture type 678, providing a name 680, inputting a length 682, inputting chair options 684, inputting a depth 686, inputting a chair depth 688, inputting a chair width 690, inputting a minimum number of people 692, inputting a normal number of people 694, inputting a physical maximum number of people 696 and inputting a number of reserve tables 698, plus the inclusion of toggles generally shown at 603 to override the minimum number of people and normal number of people to be seated at a table for VIPs 601 and SVIPs 605, selecting a restaurant 609 and enabling use of the table in the floor plan 611. The operator may save all changes by utilising save button 613.

Referring to FIG. 6f, in addition to the inputs shown with reference to FIG. 6e, there is shown a preview screen 615 which includes an example of the rectangular table and chair combination 617, the addition of a chair 623, and the ability to manually add or remove a chair by utilising the check boxes 619 and 621. All of the information captured at this stage serves to assist in the display of the floor plan, but more importantly, creates a series of constraints which are subsequently utilised by the allocation algorithm.

Referring to FIG. 6g in addition to the inputs shown with reference to FIG. 6e, there is shown a preview screen 615 which includes an example of a round table and chair combination 627 and the addition of a chair 625.

Referring to FIG. 6h in addition to the inputs shown with reference to FIG. 6e, there is shown a preview screen 615 which includes an example of a large rectangular table top and chair combination 631 and the addition of chairs 629 and 697, and the ability to manually add or remove a chair by utilising the check boxes 633 and 6001.

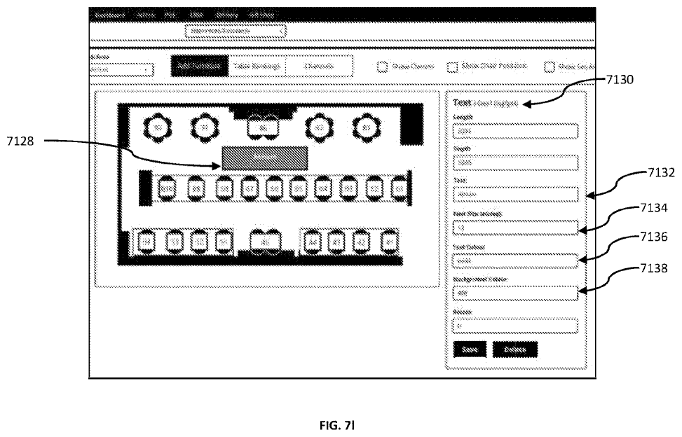

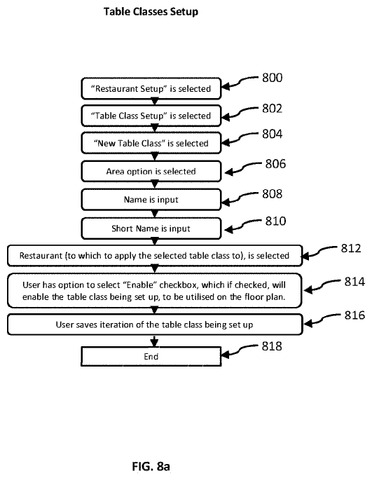

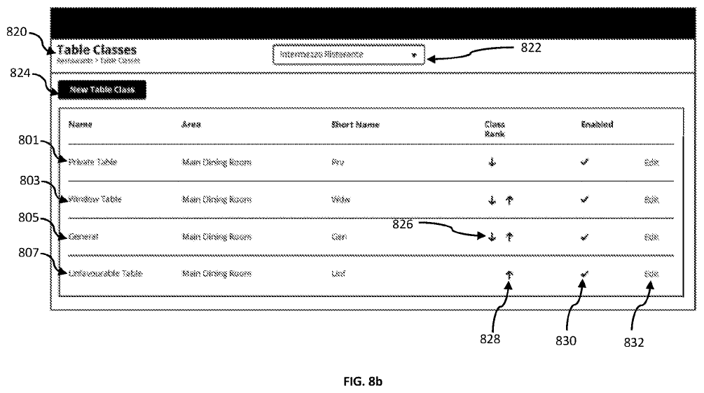

Referring to FIG. 6i in addition to the inputs shown with reference to FIG. 8e, there is shown a preview screen 615 which includes an example of a round table top and chair combination 637 and the addition of two chairs 635 and 6003.

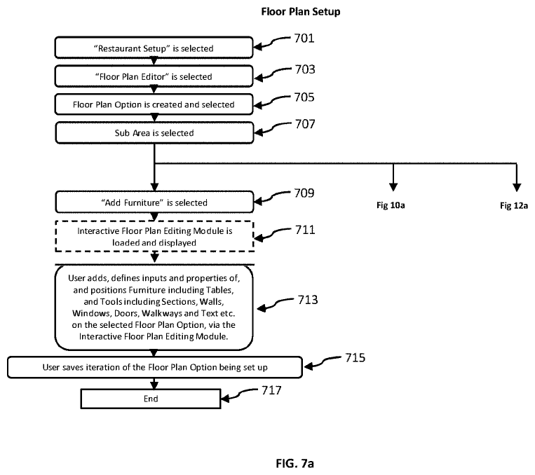

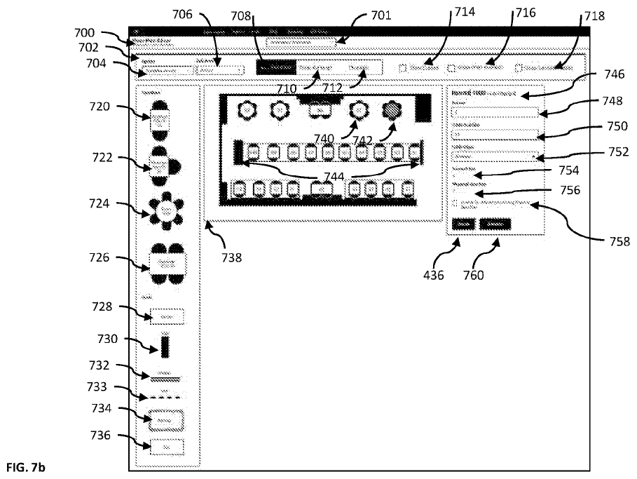

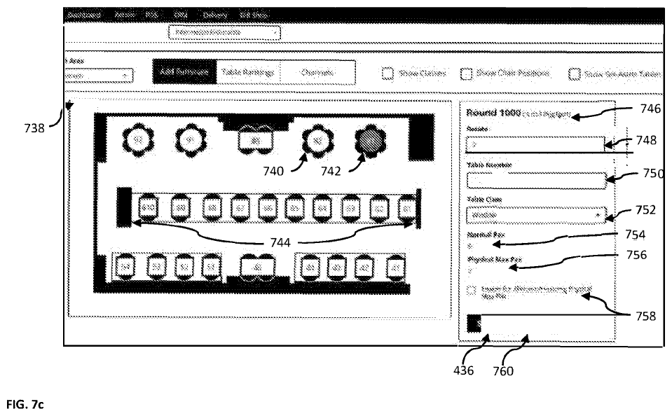

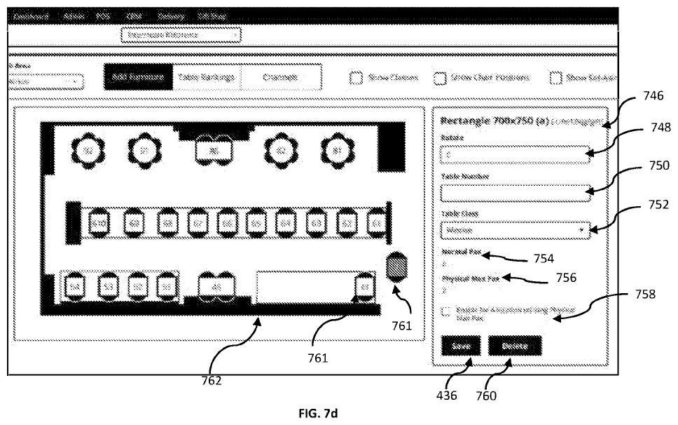

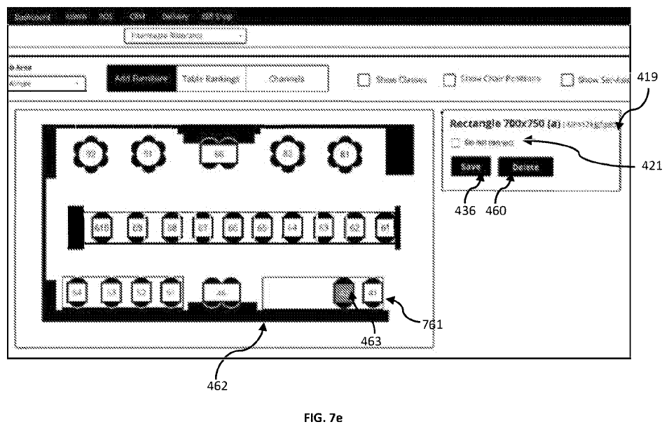

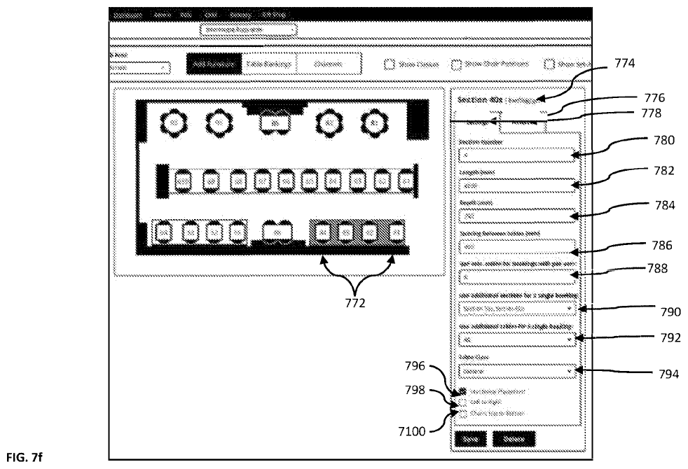

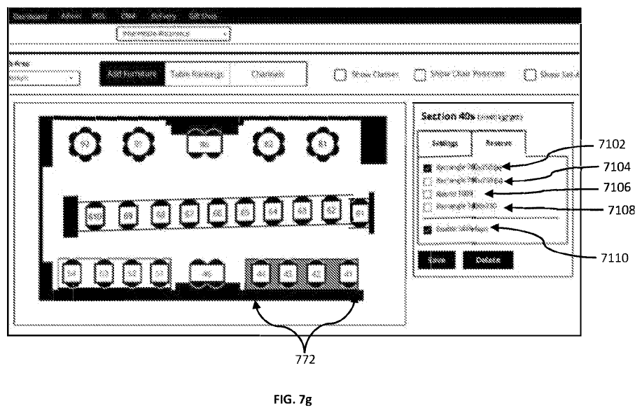

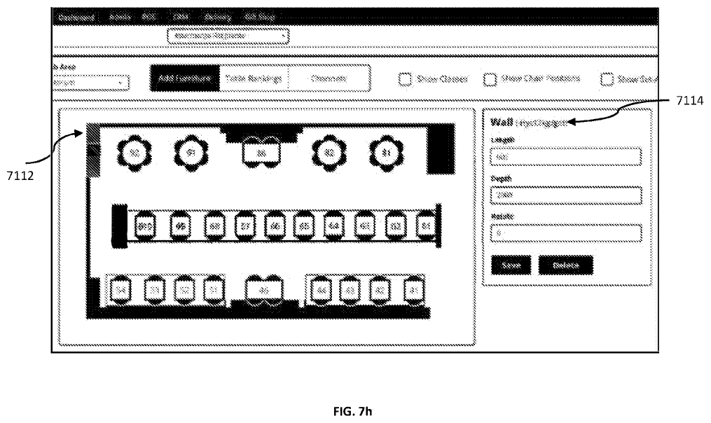

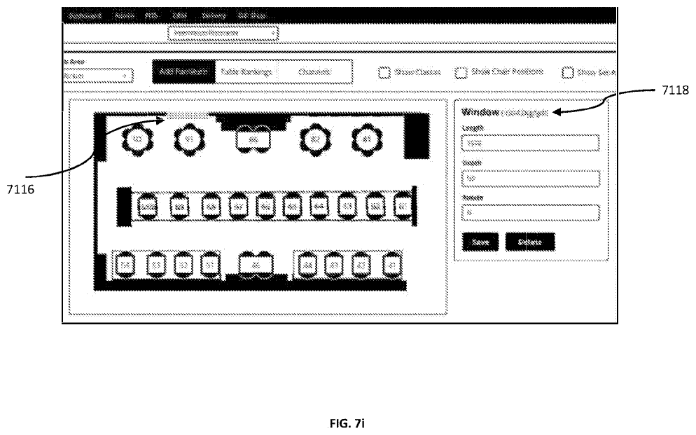

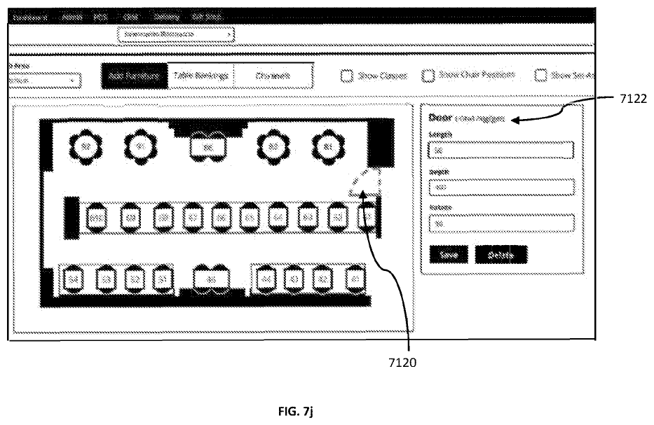

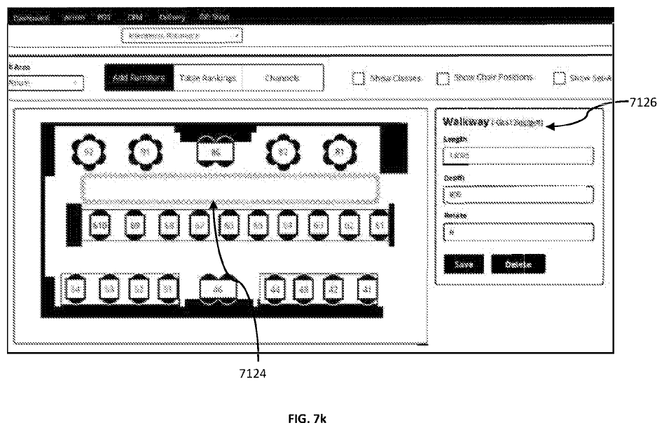

Referring to FIG. 7a, there is shown a floor plan setup process flow. The floor setup process flow advantageously allows a user with little or no planning experience to intuitively setup a floor plan and assign attributes to each item of furniture, to assign specific attributes to each specific sub-areas and/or section of the restaurant area/space, and to create an “initial” or “base” floor plan. While the allocation algorithm is capable of allocating all furniture items independently of any manual intervention, utilising the constraints provided by the operator, it is generally necessary, for practical reasons, to present restaurant staff with a base or initial floor plan, thereby allowing staff to orient themselves.

Importantly, the floor plan setup interface also serves a second purpose, namely the provision of an interface that allows a user with little or no planning or programming experience to provide all relevant venue constraints in a manner that is visual in nature and guides the user through the necessary steps to build a comprehensive set of constraints. In other words, all prior art systems (whether related to the creation of a floor plan for a restaurant or a floor plan for any other purpose) require some knowledge of how to enter constraints, how such constraints affect the system as a whole, etc. However, in the embodiment described herein, the operator does not require any knowledge of planning, how to create specialised constraint files in specialised formats, etc. The operator simply “builds” a restaurant floor plan through the use of simple drag and drop icons and through the input of simple information, and the system generates all necessary constraints. In other words, the embodiment of the invention described herein allows for intuitive creation of a set of constraints that are then used by the allocation algorithm and other algorithms within the restaurant management and booking system to operate all aspects of the restaurant. There is no need for specialised programmer or planner input. As a corollary, where a fundamental change is required to the floor plan (e.g. all 600 mm wide tables are replaced with 700 mm wide tables), the operator simply needs to make the single change in the system, and all associated constraints which are affected by the single change are also immediately updated, with the floor plan and constraints being updated automatically. As such, decisions made regarding a change in the physical setup of the restaurant can be immediately reflected in the system, with no need for specialised reprogramming or “tweaking” of any kind.

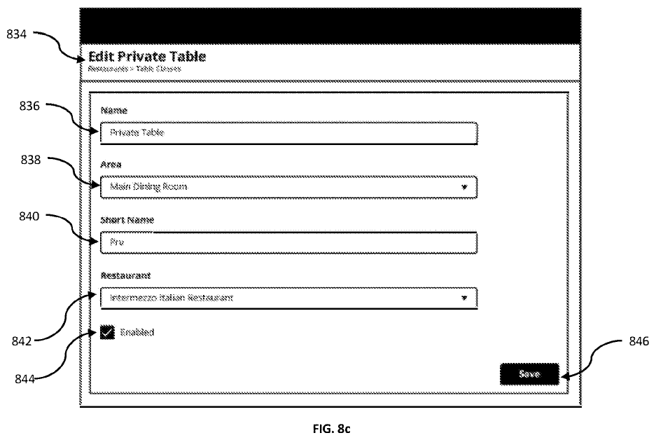

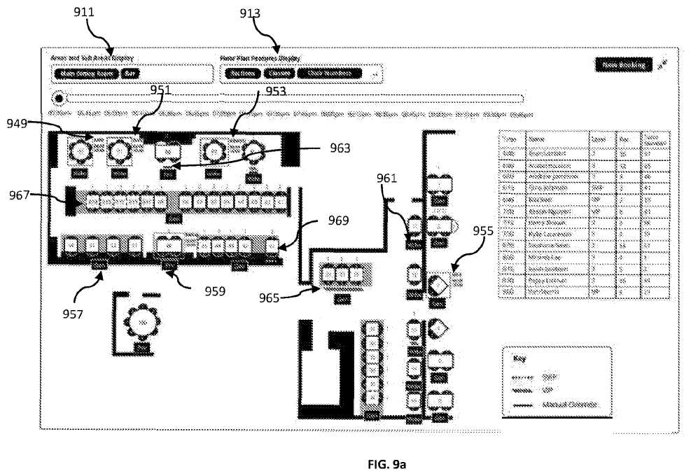

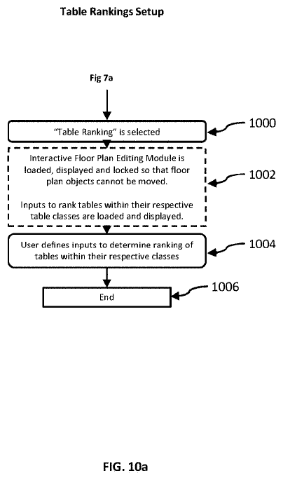

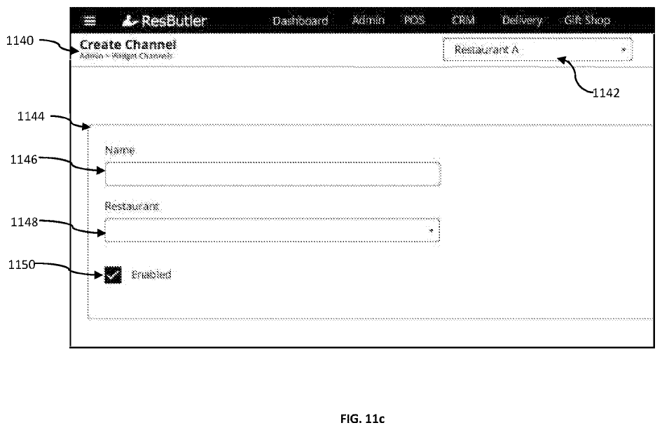

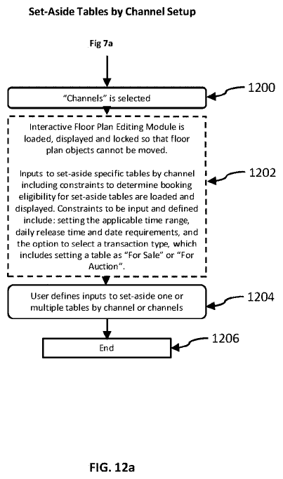

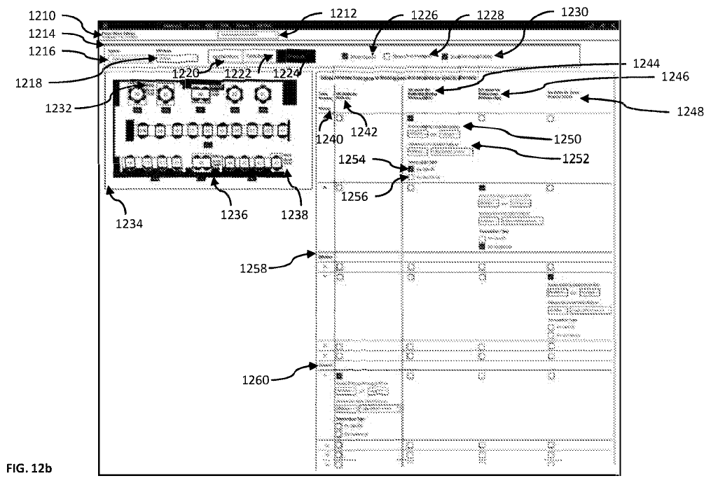

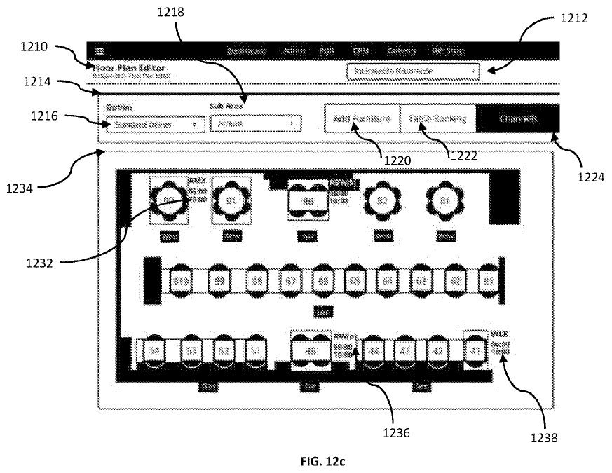

Returning to FIG. 7a, at step 701 the restaurant setup option is selected. If the operator is creating or editing a floor plan, the floor plan option is selected at 703. The floor plan option is subsequently created and selected at step 705, after which at step 707, a sub-area is selected by the operator. Depending on whether the operator wishes to build a floor plan or update some other aspect of the constraints relevant to the floor plan, the process may continue to step 709, or may continue to the process flows described in FIG. 10a or 12a (which are described herein below).

If the process continues to step 709, the add furniture option is selected. This causes an interactive floor plan editing module to be displayed at step 711. At step 713, the operator can add walls, sections, windows, doors, walkways tables, etc., as required to correctly describe the venue and all furniture, as will be described with reference to the screenshots of FIGS. 7b to 7l. Once the operator has entered all details to their satisfaction, the input information is saved and the floor plan and constraints are generated at step 715. Thereafter, the process ends at step 717.

Referring to FIG. 7b there is shown a screenshot of setup screen which allows a user to set up a floor plan and associated constraints, as was described with reference to the process flow of FIG. 7a. At 700, there is shown the title of the screen, namely “Floor Plan Editor” and a restaurant selector 701. There is also provided an option editing area 702 including a floor plan option selector 704, a sub-area selector 706, and three tabs 708, 710 and 712 for adding furniture, ranking tables and associating with channels respectively. There is also shown a number of check boxes for displaying information on floor plan depiction 738, including a show classes tick box 714, a show chair position tick box 716 and a show set-aside tables tick box 718. Along the left hand side of the interface, there is shown a graphical representation of all furniture and other objects (including walls) that can be used to create the floor plan depiction 738. The manner in which these items are generated are described in more detail below. In the screenshot of FIG. 7b, there is shown, by way of example, some of the items that may be generated an utilised, including a two person table 720, a three person table 722, a round table 724, a rectangular four person table 726, in addition to various “tools” that are not defined pieces of furniture, but rather are integral parts of the venue, such as sections 728, walls 730, windows 732, doors 733 and walkways 734. Such tools are not objects per se, but are used to provide more information regarding the layout of the floor plan and are translated into constraints. For example, to take a simple example, by defining a walkway between two sections, the allocation algorithm utilises this information to know that a table cannot be placed in a walkway. Similarly, where a door is place, the allocation algorithm knows that a table cannot be placed in front of a walkway. In this way, such artefacts of the space or venue can be factored into the algorithms decision to rearrange tables or other objects within the space.

Referring to FIG. 7c, there is shown an example of how furniture items may be setup by the operator. Screen 738 is a representative floor plan, where a user may drag and drop individual tables such as round tables 740 and 742, or may add tables to a section such as section 744. In FIG. 7c, there is also shown an input screen 746 for defining the characteristics of a round table 742. Firstly, there is provided a rotate input box, which allows the table to be rotated relative to the space, which can be important in situations where tables must be rotated (748) to fit into the space. Secondly, at 750, each table can be allocated a number. Thirdly, each table is allocated a class at 752. Fourthly, for the information of the operator, information is provided about the normal number of people that a table can sit at 754, and the physical maximum a table can sit at 756. This information is provided to assist the operator in deciding whether the table is the correct table to place in the selected space. The operator can also select whether the algorithm is allowed to use the physical maximum when allocating a booking by selecting option 758. Finally, the user can save the floor plan using button 436 or delete the floor plan utilising button 760.

Referring now to FIG. 7d, where like numerals refer to the same features as described with reference to FIG. 7c, there is also shown another example of how a rectangle table may be added to a section 762. The operator has already placed one table 761 in section 762, and newly generated table 761 has not yet been placed in a section and is therefore labelled with a ‘?’ to indicate that the table is not yet placed in a defined location, nor has had any inputs including table number saved. Once the table 761 of FIG. 7d is placed in a defined location, as shown in FIG. 7e, the newly located table (now labelled 463) is provided with a table number (42) and a new dialogue box 419 appears on the right hand of the interface, where the operator can select whether the table should be connectable to other tables. That is, whether the table can be joined with other tables to create a larger table. If the operator checks the “Do not connect” option, the algorithm will not use the table to connect to other tables, should there be a requirement due to a larger booking. The operator may make this decision for any reason whatsoever, such as requiring the maintenance of a specific ambiance in a specific area. By utilising options such as “Do Not Connect”, the operator is automatically generating a number of constraints to be utilised by the algorithm, but doing so in a manner and through an interface that is understandable to the operator and does not require any underlying knowledge of how the system operates. In other words, the embodiment of the invention does away with the need, by the operator, to have any understanding of how the system operates or how decisions are made by the algorithm. The operator simply needs to provide their requirements, from a restaurant operator point of view.

Referring to FIG. 7f there is shown a screenshot of an interface that allows an operator to apply constraints to a defined section, such as section 772. The selection of a section 772 causes a new dialogue box 774 to appear on the right hand side of the interface. The dialogue box has two tabs, namely a settings tab 776 and a reserve tab 778. The settings tab 776 provides a number of settings that influence constraints, including ascribing a section number 780, defining a length 782 and depth 784 of the section, defining a minimum distance between tables 786, defining an option to utilise the minimum number of combined tables possible for bookings over a certain number of people 788, the ability to allow bookings to “spill over” into other sections 790, the ability to allow the algorithm to use fixed tables from other sections 792, and the attribution of a class to the section 794. There is also provided three options for how the algorithm can generally place tables and chairs (i.e. the relative orientation of the tables and chairs). There is an option for the horizontal orientation of tables, the ability to add tables from left to right (or vice versa) and the ability to add chairs from top to bottom. Each of these options provide constraints which in turn affect the manner in which the algorithm dynamically allocates tables to the space.

Referring to FIG. 7g, if the reserve tab 778 (as shown in FIG. 7f) is selected, the furniture allowed, from a reserve (e.g. a reserve in a storeroom or from an outside source) can be selected, such that the algorithm has knowledge of whether this is stock, and the ability, to place extra tables in the section. For example, in FIG. 7g, there are shown four types of tables 7102, 7104, 7106 and 7108 that can be selected or deselected, which causes the algorithm either to add, if necessary, or not add, if necessary, each table type. There is also provided an option to add “table tops” 7110 (i.e. where a table remains in situ, but a larger table top is added to provide for more chairs and increase the capacity of the table, without needing to remove the original table).

Referring to FIG. 7h, there is shown a screenshot of a screen for adding a wall to a floor plan. At 7112 there is shown a wall being drag and dropped into a location on the floorplan, which in turn causes a wall dialogue box 7114 to be displayed, so that the operator can provide specific dimensions for the walls.

Referring to FIG. 7i there is shown a screenshot of a screen for adding a window to a floor plan. At 7116 there is shown a window being drag and dropped into a location on the floor plan, which in turn causes a window dialogue box 7118 to be displayed, so that the operator can provide specific dimensions for the window.

Referring to FIG. 7j there is shown a screenshot of a screen for adding a door to a floor plan. At 7120 there is shown a door being drag and dropped into a location on the floor plan, which in turn causes a door dialogue box 7122 to be displayed, so that the operator can provide specific dimensions for the door.

Referring to FIG. 7k there is shown a screenshot of a screen for adding a walkway to a floor plan. At 7124 there is shown a walkway being drag and dropped into a location on the floorplan, which in turn causes a walkway dialogue box 7126 to be displayed, so that the operator can provide specific dimensions for the walkway.

Referring to FIG. 7l there is shown a screenshot of a screen for adding a text to a floor plan at 7128. The text does not affect the floor plan per se, but provides information to end users, where there is a need to label a section. At 7130 there is shown a dialogue box, where the operator can provide specific text 7132, adjust the font size 7134, adjust the text colour 7136 and adjust the background colour 7138.

Referring to FIG. 8a there is shown a flowchart which outlines part of the process steps utilised to allocate classes to tables in a restaurant for placement on a floor plan (and the subsequent generation of constraints to be utilised in the determination of allocations of furniture in response to booking requests) in accordance with an embodiment of the invention. At step 800 restaurant setup is selected, and subsequently at step 802 a table class setup option is selected, and then at step 804 a new table class is selected. The operator then selects an area option at step 806 and inputs a name at 808 and a short name at step 810. The operator subsequently selects a restaurant to which to apply the selected table class at step 812, and the user then selects whether the table class being set up will be utilised on the floor plan at step 814. Finally, the user saves an iteration of the table class at step 816 and the process ends at step 818.

Referring to FIG. 8b there is shown a screenshot of setup screen which allows a user to create classes that can be allocated to tables in a restaurant and associated constraints, as was described with reference to the process flow of FIG. 8a. At 820, there is shown a screenshot of the table classes setup screen 820 which includes a restaurant selector 822. A new table class can be added by utilising button 824, and various table classes associated with various areas are shown (801, 803, 805, 807)] with each table class being moveable in terms of relative ranking by using arrows 826 and 828. The classes can also be enabled by using check box 830 and edited by using the edit link 832.

Referring to FIG. 8c if the new table button 824 is selected (in FIG. 8b), a new dialogue box 834 is displayed. The operator can create a name for the private table at 836, allocate the table to an area 838, add a short name (for display on the floor plan) 840 and allocate to a restaurant at 842, and also choose to enable the table as a member of a class by checking the enable box 844. The operator may also save the settings by using save button 846.

At FIG. 9a, there is shown a screenshot of an iteration of the dynamic floor plan user interface with various attribute tags displayed, such as tables set-aside by channel 949, 951 and 953, tables set-aside for walk-ins 955, classes 957, 959 and 961, reserve furniture 967 and customer types 963.

Referring to FIG. 10a there is shown a table rankings process flow for the setting up of table rankings. At step 1000, the table rankings option is selected in the setup interface. This causes, at step 1002, the execution of an interactive floor plan editing module which provides an intuitive user interface for use by an operator of the restaurant. In particular, various input options are provided (as will be described in more detail with regard to FIG. 10b). At step 1004, the operator inputs various inputs to determine the ranking of tables within their respective classes. At step 1006, the process ends.

Referring to FIG. 10b, there is shown a screenshot of an input screen for entering table rankings. The process flow of FIG. 10a is mediated via the input screen of FIG. 10b. As can be seen, at 1008, 1010 and 1012 there are shown labels representing various classes. For example, label 1008 indicates that table 92 is a window table, label 1010 indicates that table 46 is a private table and label 1012 indicates that the section that is shown having tables 41, 42, 43 and 44 is a section that is a “general” class. Each class comprises one or more tables, and where a class comprises one or more tables, the rankings of tables within the class can be modified by utilising table rankings box 1014. A class is selected at 1016, and then table numbers 1018 and rankings 1020 are displayed on the interface, where a user can change the relative rankings of the class by utilising the arrows 1001 and 1003.

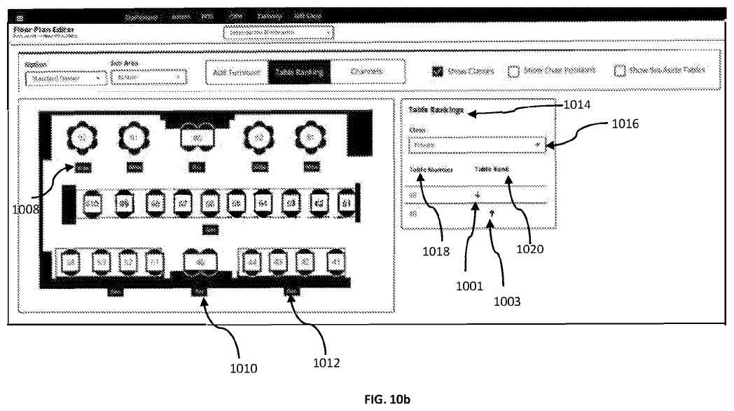

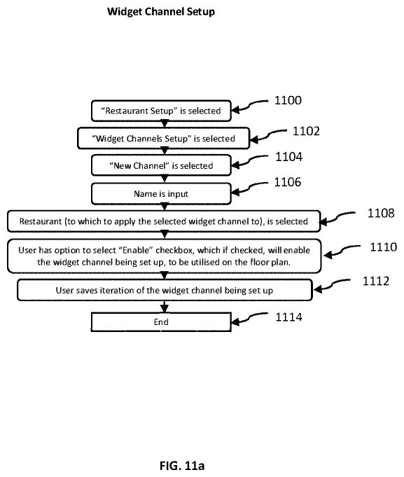

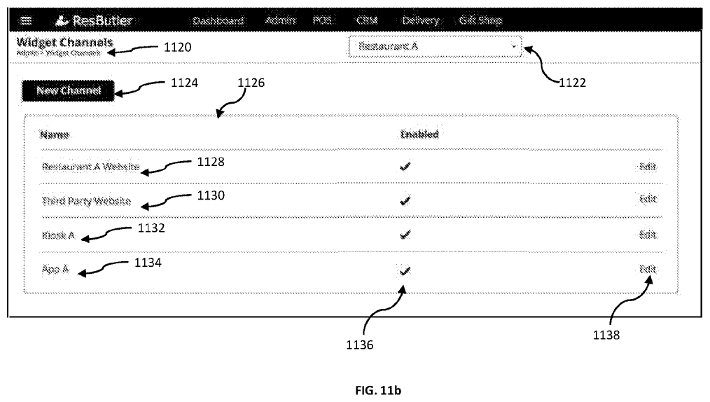

Referring to FIG. 11a there is shown a widget channel setup process flow, which allows a widget channel to be associated with a particular area, restaurant, etc, to thereby allow specific tables to be attributed to particular classes. At step 1100 restaurant setup is selected, and subsequently at step 1102, widget channels setup is selected, after which at step 1004, a new channel setup option is selected. The operator then inputs a name at 1106 and subsequently selects a restaurant to which to apply the selected widget channel at step 1008, and the user then selects whether the widget channel being set up will be utilised on the floor plan at step 1110. Finally, the user saves an iteration of the widget channel setup at step 1112 and the process ends at step 1114.

Referring to FIG. 11b there is shown a screenshot of the widget channels setup screen which allows a user to set up a floor plan and associated constraints, as was described with reference to the process flow of FIG. 11a. At 1120 there is shown a screenshot of the widget channels dialogue, including an option to select a restaurant 1122 and an option to create a new channel 1124. Current channels are shown in section 1126, which include, in the screenshot shown, four example channels 1128, 1130, 1132 and 1134, which can be enabled via use of the check boxes generally shown at 1136 and can be edited via use of the edit buttons generally shown at 1138.

Referring to FIG. 11c, if the new channel button 1124 is selected (in FIG. 11b), a new dialogue box 1140 is displayed, and a section 1144 which allows the operator to add a restaurant name 1146, select a restaurant 1148 and enable the channel by using checkbox 1150.

Referring to FIG. 12a, there is shown a flowchart illustrating the process by which set-aside tables are selected for each channel. At step 1200, channel setup is selected. This loads, at step 1202, an interactive floor plan editing module, where at step 1204, the user defines inputs to set aside one or more tables by channel or channels, after which the process ends at step 1206.

Referring to FIG. 12b, the process of FIG. 12a is illustrated with reference to screenshots of various input screens. FIG. 12b illustrates an interactive floor plan editing screen generated by the interactive floor plan editing module. The screen includes a title 1210, a restaurant selector 1212, an area (1214) containing a grouping of selectors including a floor plan option selector 1216 and a sub-area selector 1218, setup interface selectors shown by three tabs 1220, 1222 and 1224 for adding furniture, ranking tables and setting aside tables by channel respectively. There is also shown a number of check boxes for displaying information on floor plan depiction 1234, including a show classes tick box 1226, a show chair position tick box 1228 and a show set-aside tables tick box 1230. There is also shown an indicator 1232 which illustrates the connection between a table and a specific channel (e.g. “AMX” next to table 92 indicates that table 92 is reserved for the American Express Website channel, at 1236, “RW” next to table 46 indicates that table 46 is reserved for the Restaurant Website channel and “WLK” next to table 41 indicates that table 41 is reserved for “walk-in” customers (which in turn may be associated with bookings made through the kiosk).

The association of tables with channels is selectable via the interface shown at the right hand side of FIG. 12b, where there is shown a column 1240 of table numbers, a column 1242 including a tick box for every table, such that when a tic box in the same row as a table number is selected, the table becomes reserved for the relevant channel, such as in column 1244 which is the ResButler market website channel, where the tick box is checked, a number of further fields appear, including a time period setting field 1250 which allows the operator to accept bookings within a predetermined time window (where the time window is a condition set by a restaurant that allows any booking where the duration overlaps with this time window, and is booked via the specified booking widget channel, to have access to a pool of tables including the specified set-aside table during the allocation process), a release time 1252 (a time at which the table is no longer held and can now be booked through any channel), and tick boxes 1254 and 1256, which select whether the table booking incurs an extra charge, either via a flat sale price, or via an auction process. It can also be seen that, for ease of use by the operator, tables can be separated into categories according to class, such as can be seen at 1240, 1258 and 1260.

Referring to FIGS. 12c, 12d and 12e, there are shown close up views of portions of the screenshot of FIG. 12a, where the numerals of FIG. 12a refer to like features in FIGS. 12c, 12d and 12e.

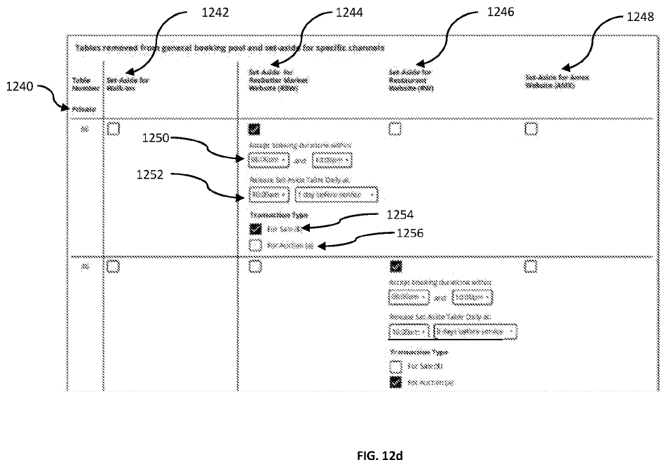

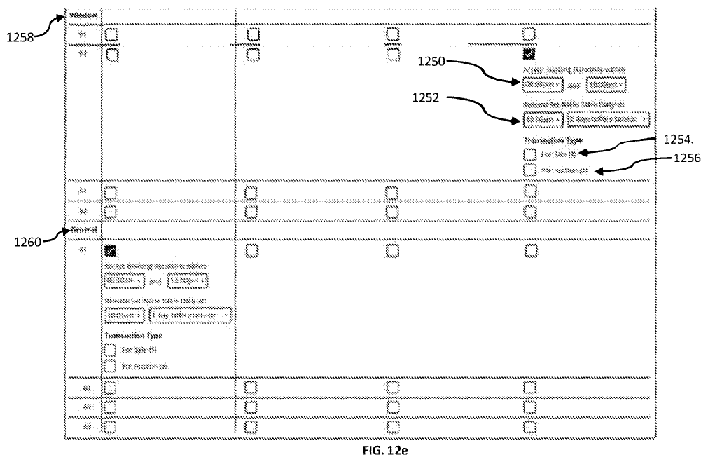

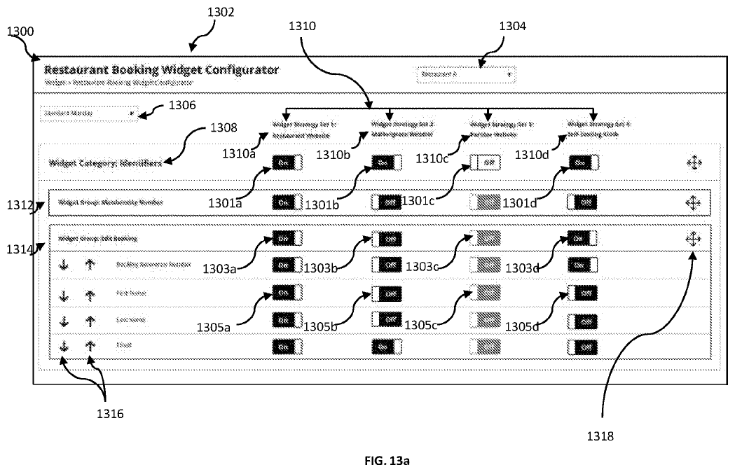

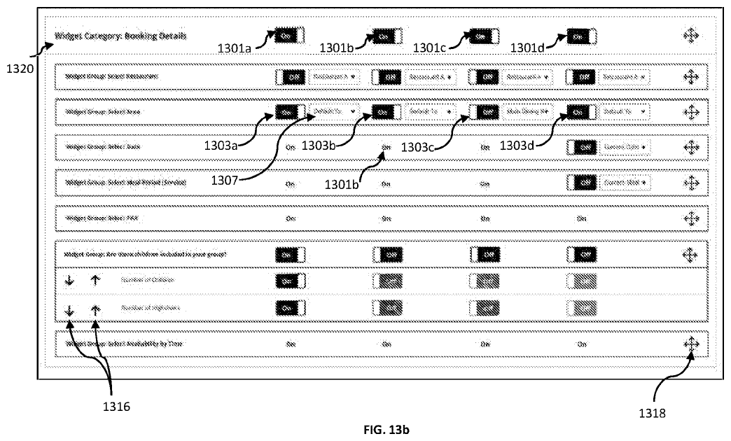

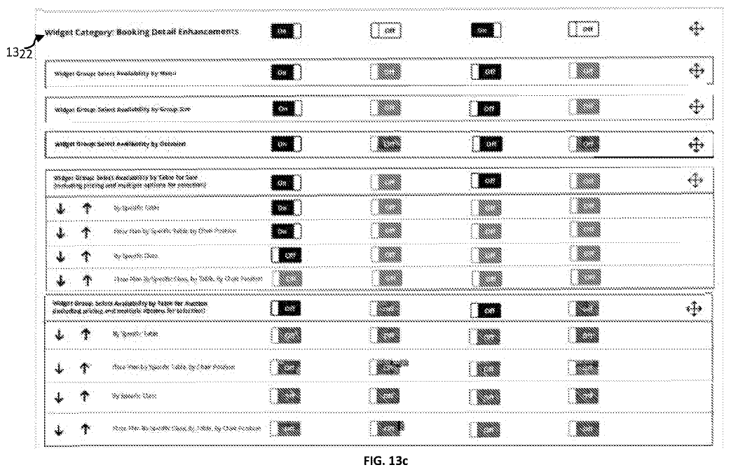

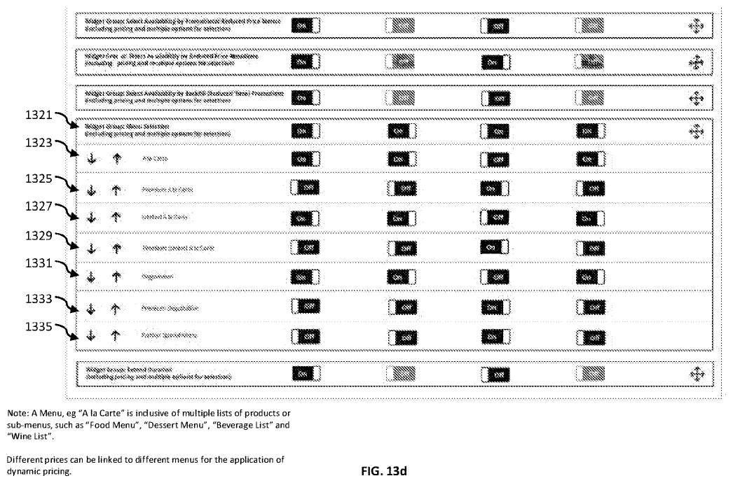

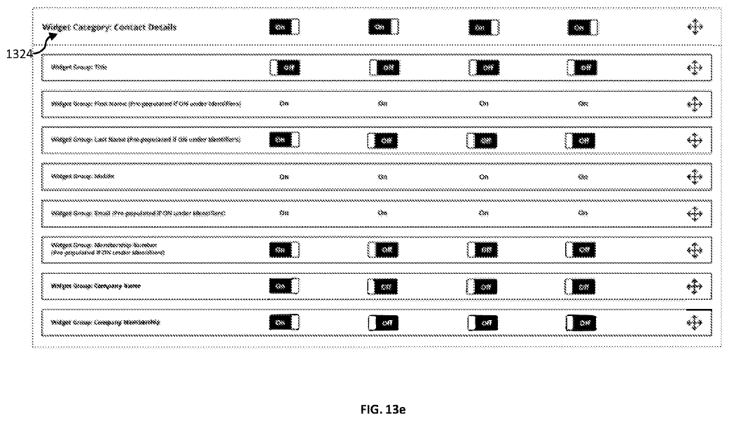

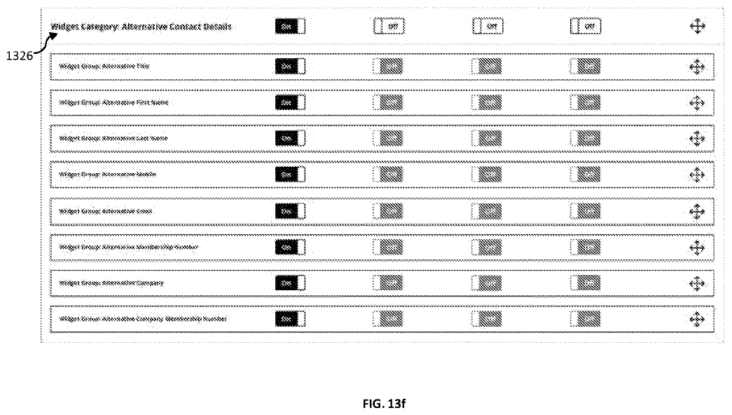

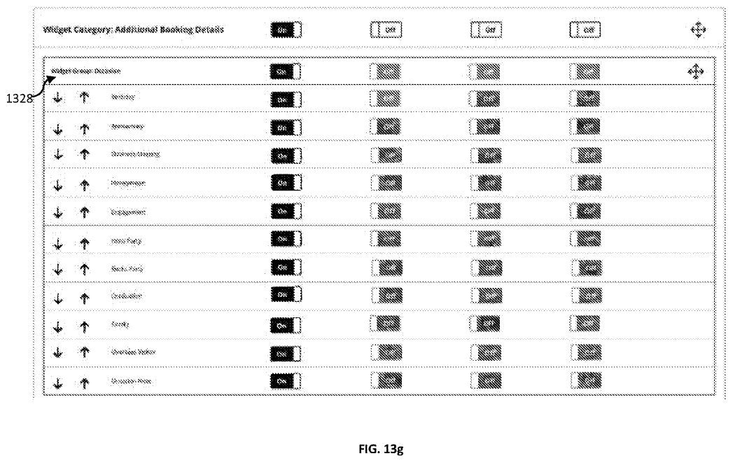

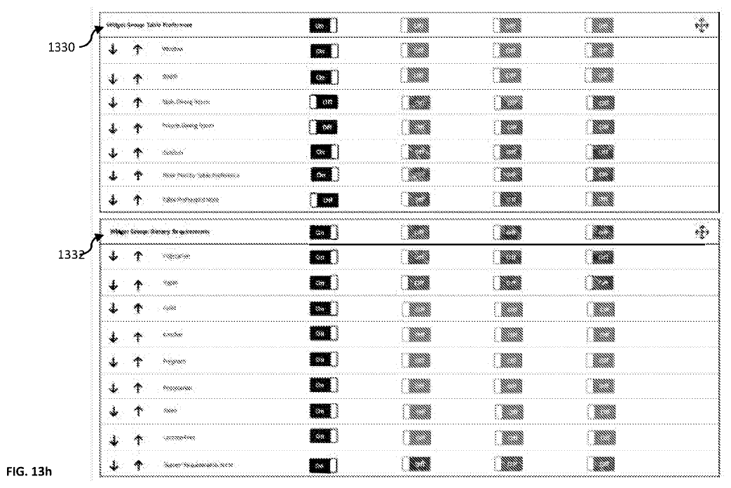

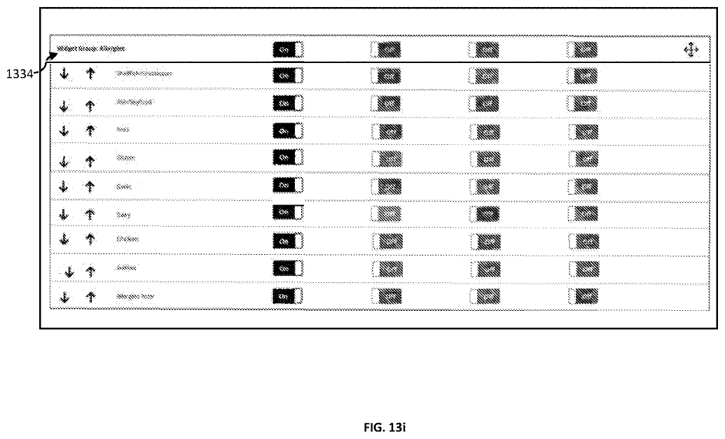

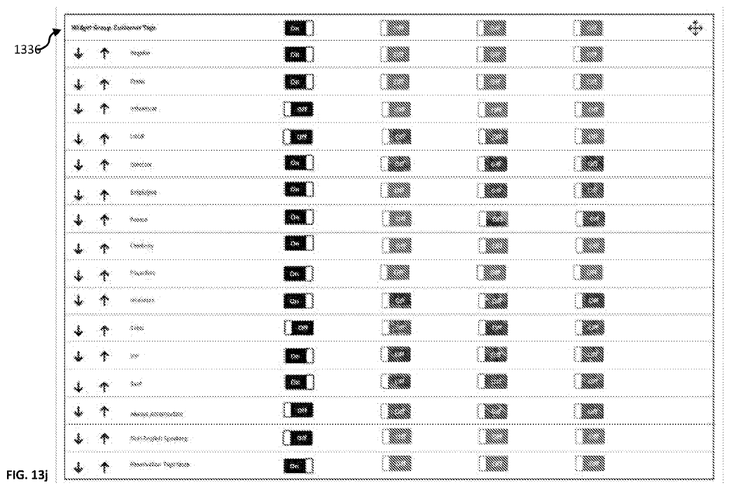

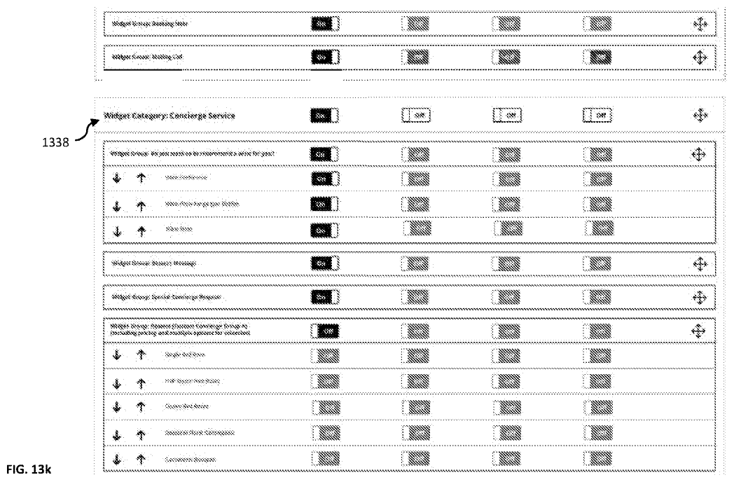

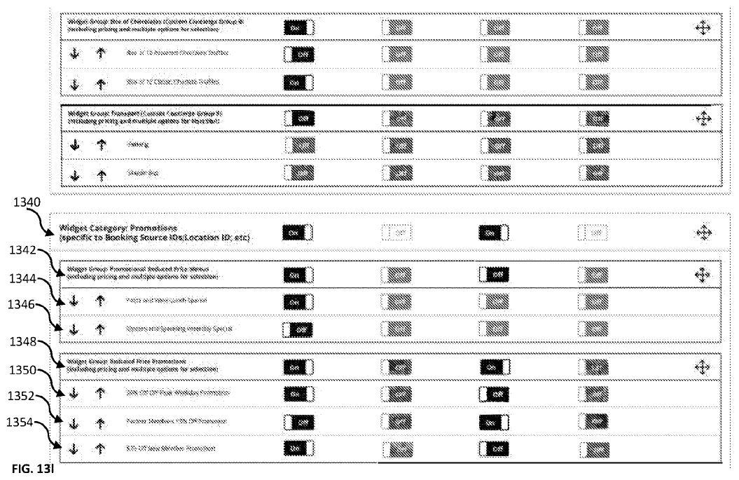

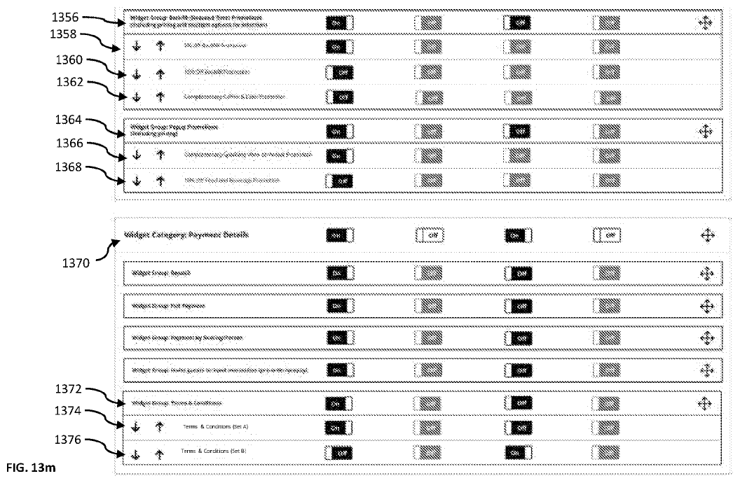

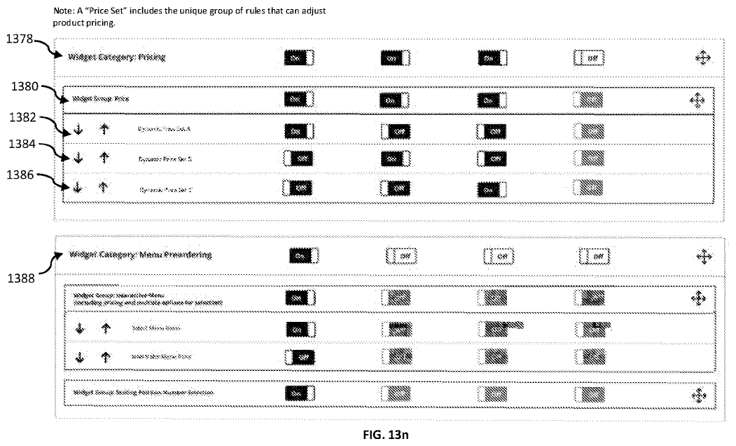

Referring to FIG. 13a there is shown a screenshot 1300 of a configurator in accordance with an embodiment of the invention. As described, the configurator allows multiple “channels” (i.e. different instances of the widget which behave differently and may be deployed to different websites, apps, etc.) to be individually controlled, wherein all features, inputs, outputs and aspects of the interface may be potentially turned off or on depending on the requirements of the restaurant.

The interface 1300 includes a title 1302, a restaurant selector 1304, booking widget configuration set selection facility 1306, a series of selectable switches as shown at 1310 generally (or 1310a, b, c and d specifically), wherein each category as denoted by 1308 includes sub-categories as denoted by 1312 and 1314. For each channel, there is also provided toggle switches 1301a, 1301b, 1301c and 1301d respectively. The interface also allows each element in each sub-category to be moved using arrows 1316 or an entire category to be moved using arrows 1318.

Referring to FIG. 13b through to 13o, there are shown screenshots 1320 through to 1390, each displaying examples of sub-categories, such as booking details, enhancements, contact details, etc. It will be appreciated that potentially any sub-categories may be included, as per the figures shown.

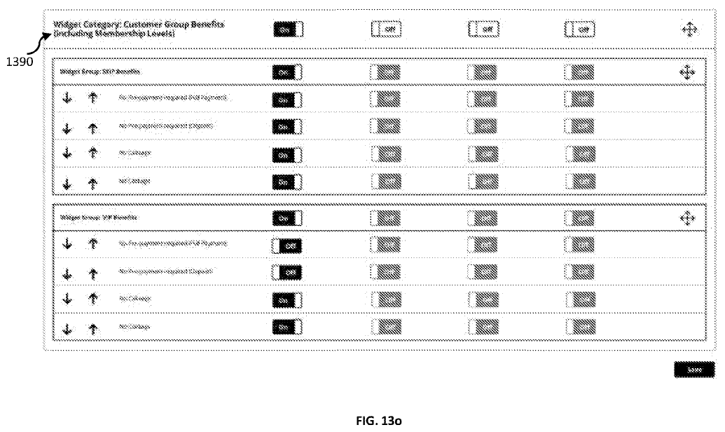

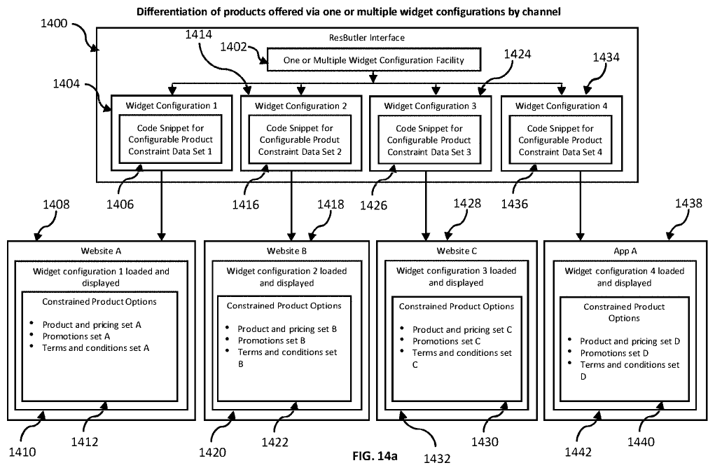

Referring to FIG. 14a, there is shown a modular diagram illustrating the interactions of multiple widget configurations, 1404, 1414, 1424 and 1434, enabled via the one or multiple widget configuration facility 1402 within the ResButler interface 1400, with the channels that each respective widget configuration has been deployed to —1408, 1418, 1428 and 1438 respectively. It is shown that widget configuration 1 (1404) has been deployed to website A (1408) by embedding the code snippet for configurable product constraint data set 1 (1406) onto website A (1408), resulting in widget configuration 1 (1410) to be loaded and displayed on website A (1408) displaying a unique set of constrained product options (1412).

It is also shown that widget configuration 2 (1414) has been deployed to website B (1418) by embedding the code snippet for configurable product constraint data set 2 (1416) onto website B (1418), resulting in widget configuration 2 (1420) to be loaded and displayed on website B (1418) displaying a unique set of constrained product options (1422).

It is also shown that widget configuration 3 (1424) has been deployed to website C (1428) by embedding the code snippet for configurable product constraint data set 3 (1426) onto website C (1428), resulting in widget configuration 3 (1424) to be loaded and displayed on website C (1428) displaying a unique set of constrained product options (1430).

Lastly, it is also shown that widget configuration 4 (1424) has been deployed to App A (1438) by embedding the code snippet for configurable product constraint data set 4 (1436) onto App A (1438), resulting in widget configuration 4 (1434) to be loaded and displayed on App A (1438) displaying a unique set of constrained product options (1440).

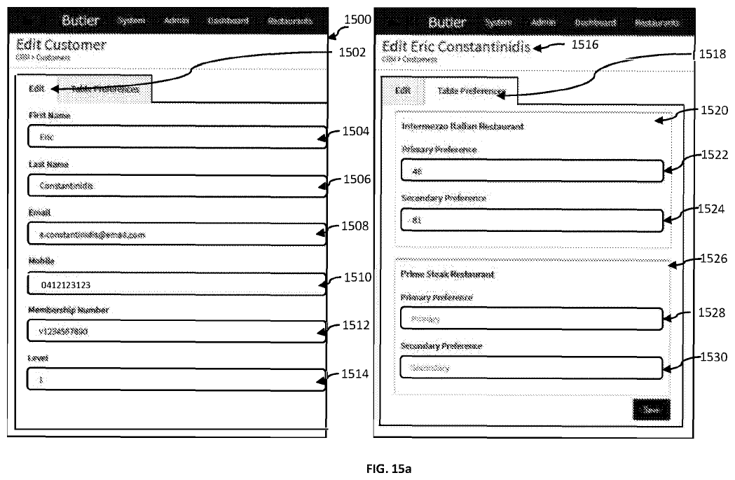

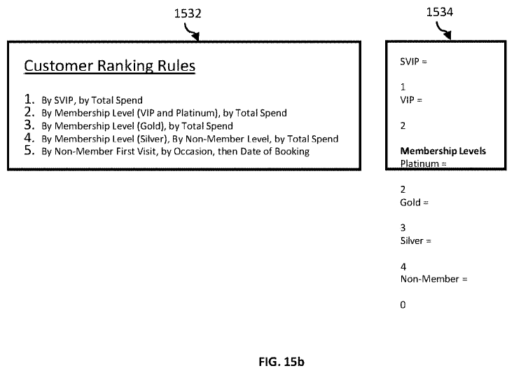

Referring to FIG. 15, a review of the CRM system shows that Eric's favourite table is table 46, which illustrates an input box 1500 for Eric's customer information including an edit tab 1502 and a table preferences tab 1518. In the edit tab 1502, the customer information includes a first name 1504, a last name 1506, an email 1508, a mobile number 1510, a membership number 1512 and a membership level 1514. In the table preferences tab 1518, there is included, for each restaurant 1520 and 1526, a primary preference (1522 and 1528 respectively) and a secondary preference (1524 and 1530 respectively).

Correspondingly, as shown in FIG. 15b, customers may also be provided with a “ranking”. At 1532, there is shown a deliberately simplified example (for the purposes of the present specification) of the manner in which customers may be ranked. Depending on the ranking as determined at table 1532, customers may be allocated a numerical ranking value according to table 1534, which may then be used to match a customer ranking to a table ranking, or for any other suitable purpose.

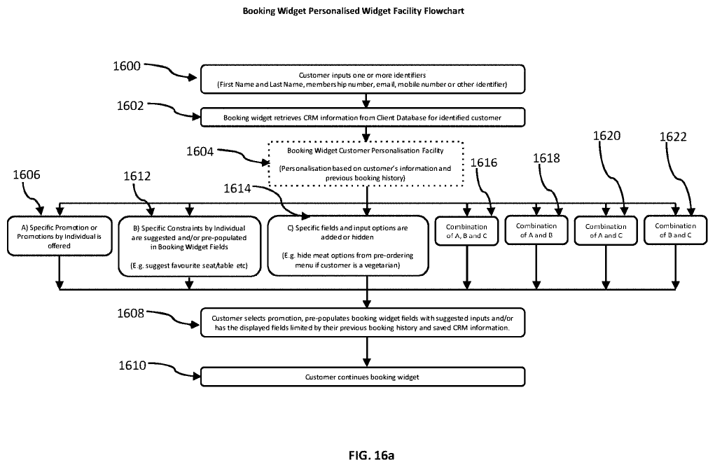

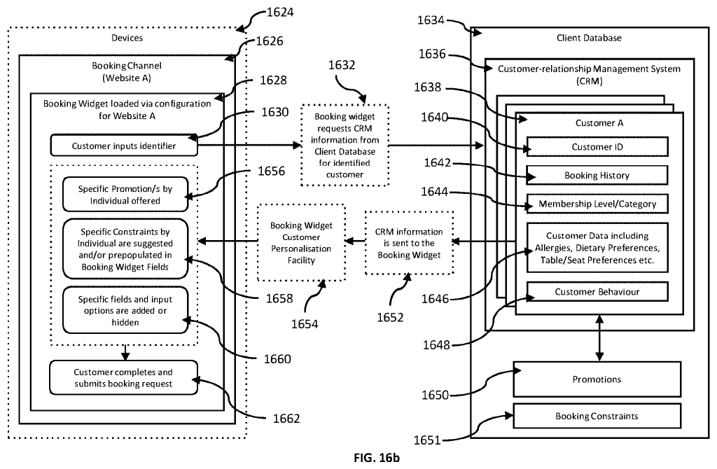

Referring to FIG. 16a, there is shown a flowchart for a booking widget where the user identifies prior to entering the booking process. The process of identifying themselves provides the user with the ability to receive a customised widget. The widget has a combination of personal and “group” customisation. That is, in broad terms, the identity of the user not only identifies the user as an individual, but also identifies the user, potentially, as a member of one or more groups. Both individual identity and group identity may have an impact on the algorithm and the information and options provided to the customer. For example, the individual may be identified as John Smith, but John Smith may also be an American Express card holder, which identifies him as a member of a group (i.e. an American Express card holder).

Returning to FIG. 16a, at step 1600 a customer inputs one or more identifiers. At step 1602 the booking widget retrieves customer information from a client database to retrieve information about the customer, to either identify the customer and/or determine customer preferences to thereby allow personalisation and customisation of the widget. In the context of the present specification, the term customisation refers to the “look and feel” of the widget interface, including the input fields displayed, the options displayed and the aesthetic appearance of the widget interface. Conversely, personalisation refers to the inclusion and/or removal of fields, pre-filling of fields with relevant data, the inclusion of promotions tailored to the customer, etc. In other words, while from a functional point of view, there is some overlap with regard to the terms customisation and personalisation, customisation refers primarily to the “look and feel” of the widget, while personalisation refers primarily to the information displayed on the widget.

Subsequently, at step 1604, the widget is personalised based on the customer's information. As shown in more detail in steps 1606, 1612, 1614, 1616, 1618, 1620 and 1622, the interface of the widget and the options displayed to the customer can vary the appearance or functionality of the widget. At step 1606, for example, the widget may offer a specific promotion. In the alternative, at step 1612 the widget may provide suggestions in the form of prepopulating certain fields. Alternatively, the widget may “hide” (i.e. not display) certain fields or may add certain fields depending on the constraints relevant t1622, the widget may utilise any combination of the steps shown in 1606, 1612 and 1614. After the customised interface is provided to the customer, the customer can select the promotion or other offer at step 1608, after which the customer, at step 1610, is taken through the booking process.

Referring to FIG. 16b, there is shown a block diagram which illustrates some of the functional connections between the booking widget or app and the customer database. FIG. 16b is not intended to provide a detailed modular representation of the hardware/software modules that comprise an embodiment of the invention, but rather to provide the person skilled in the art with a high level overview of the manner in which the booking app/widget interfaces with the client database, the client database forming part of the ResButler platform (not shown in FIG. 16b). It will be appreciated by the person skilled in the art that the data structures and modules implied by FIG. 16b are exemplary only, and variations and obvious modifications are within the purview of a person skilled in the art.

At 1624, there is shown a representation of a device, which may be a desktop computing system, a laptop, a tablet computing device, a smartphone, or any other electronic device capable of communicating with a server and database via a communications network (as per FIG. 1a). The device is capable of executing and displaying a website (referred to as a booking channel within the context of the invention described herein) 1626, the website including an integrated or embedded software application referred to herein as a widget 1628. The widget 1628 is capable of receiving (and optionally storing) a customer identifier 1630 which is utilised as information that is passed to a client database 1634 when customer information is requested 1632.

Referring to the client database 1634 there is provided a customer relationship management system (CRM) 1636, which includes multiple customer records, a single example of which is shown at 1638 (where the example is directed to hypothetical customer ‘A’). The customer record 1638 includes a customer ID 1640, booking history information 1642, membership information 1644, customer data 1646, customer behaviour information 1648 and also information regarding promotional offer 1650.

When customer information is requested 1632, CRM information is sent to the widget on the website 1652 and the widget on the website is personalised 1654, to include information regarding specific promotions for the customer 1656, specific constraints which pre-populate fields in the widget 1658, specific fields and input options which can be added or hidden 1660, which combine to provide a customised and unique interface for the customer. Once the customised interface is provided, the customer can interact with the widget and complete and submit the booking request 1662.

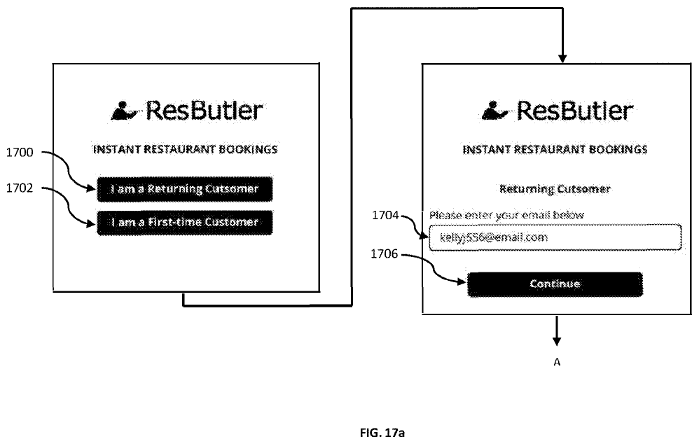

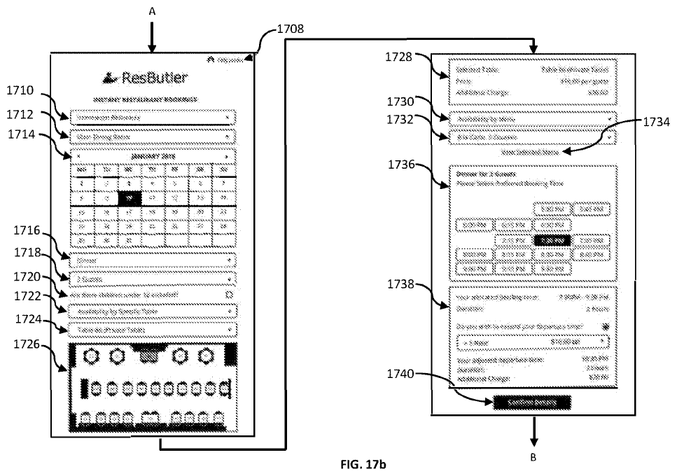

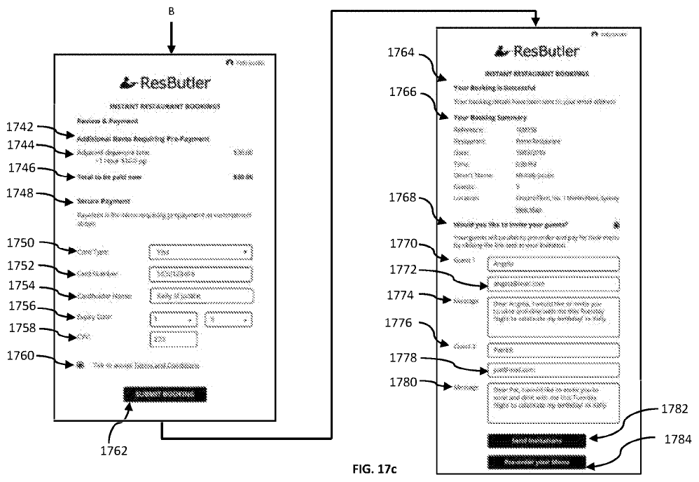

Referring to FIG. 17a, there is shown a first landing screen for an interface in accordance with an embodiment of the invention. The ResButler system provides a facility for both known customers 1700 and first-time customers 1702. If the customer is known, a second dialogue box allows the customer to enter an identifier, such as their email address 1704, before continuing 1706. The process then continues along arrow A to FIG. 17b.

Referring to FIG. 17b, which continues from arrow A of FIG. 17a, there are shown a number of options. As can be seen in the screenshot of FIG. 17b, the user has identified themselves (1708) and therefore the pull down menu items provided to the customer are a function of customer information and also constraint information. At menu 1710, the customer chooses a restaurant, and at 1712 chooses a particular area in the restaurant. Subsequently, based on previous bookings in the restaurant and particular area of the restaurant, a calendar 1714 is displayed, at which the customer chooses a date. Subsequently, depending on the date selected, available services (e.g. breakfast, lunch, dinner) are shown at 1716. The customer selects a service, and then enters the number of guests at 1718. At 1720, the customer selects whether children will be dining. At step 1722, the customer is then provided with the choice as to which constraint is most important (this aspect is described in more detail later). For example, in the screenshot shown, the customer selects the ability to choose a specific table 1724 and subsequently selects table 86. In some embodiments, as the customer is known, this field may be prepopulated with the customer's favourite table. This results into a scale image of the restaurant to appear at 1726, so that the customer may visually confirm that they have selected the correct table.

The interface also provides information on any special conditions attached to the specific table, such as an additional charge at 1728. The customer then selects a second constraint at 1730, which in the example screenshot is availability by menu. The customer then selects a menu at 1732 (further information about menus can be accessed via link 1734). Based on the information provided, the system then utilises the algorithm to provide a selection of potentially available times at 1736, from which the user can select a desired time. A summary is then provided at 1738 and the option is provided to extend the provisionally allocated dining time. The customer can then confirm the booking request at 1740, and the process continues along arrow B to FIG. 17c.

Referring to FIG. 17c, which is a continuation from arrow B of FIG. 17b, there is shown a summary and payment screen. At 1742 and 1744 there is shown a summary of additional items, and at 1746 there is shown the total amount to be prepaid. At 1748, 1750, 1752, 1754, 1756 and 1758 there is provided input boxes for payment (credit card) details, although it will be understood that any other suitable form of electronic payment may be incorporated into the widget, as different manners of payment become available from time to time. For example, direct deposit payment systems such as POLI and cryptocurrency payment systems are also envisaged.

The customer then selects check box 1760 to confirm that they agree to the terms and conditions of the booking, and then submits the booking at 1762. Thereafter, if the booking is successful, a screen 1764 is displayed, which provides a summary of the booking 1766, and the ability to invite guests at 1768. If the user wishes to invite guests, the system allows the user to input guest names (1770 and 1776), guest emails (1772 and 1778), and messages for the guests (1774 and 1780). This information is then packed into an email and sent by the system on behalf of the customer by clicking on button 1782. Moreover, the customer may also pre-order their meal form the menu by clicking on button 1784.

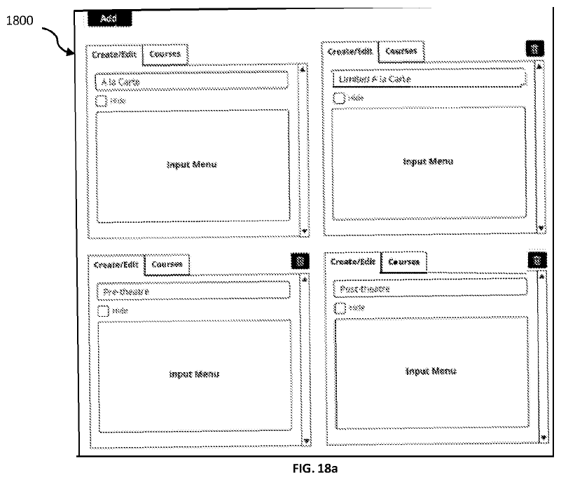

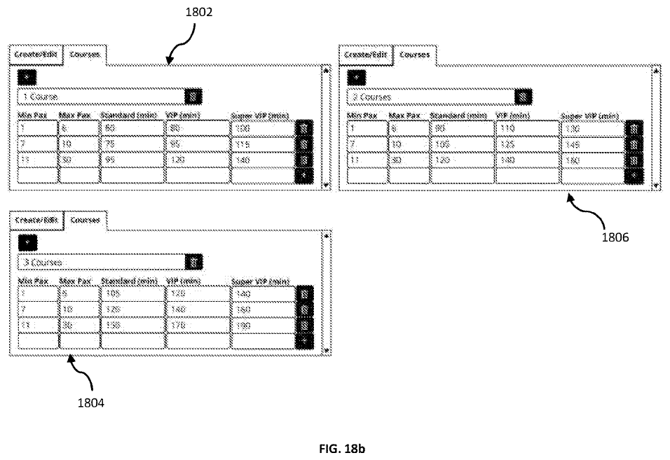

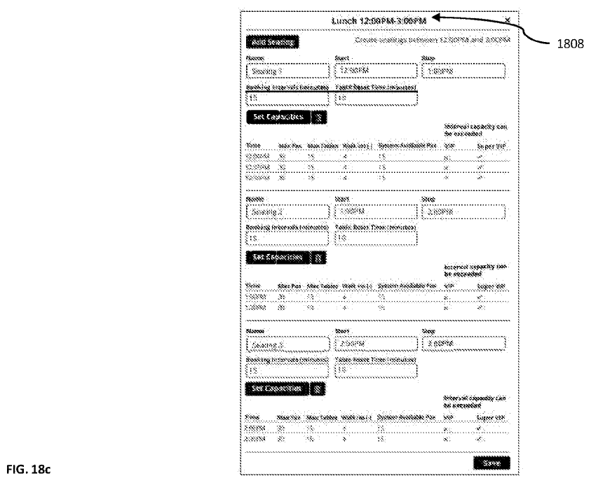

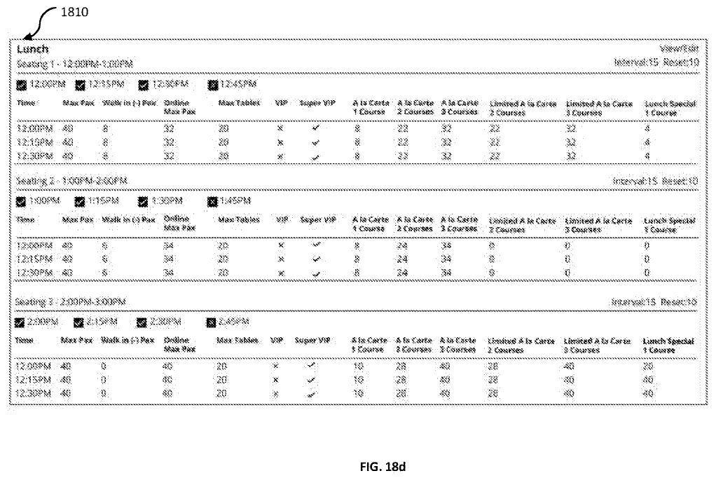

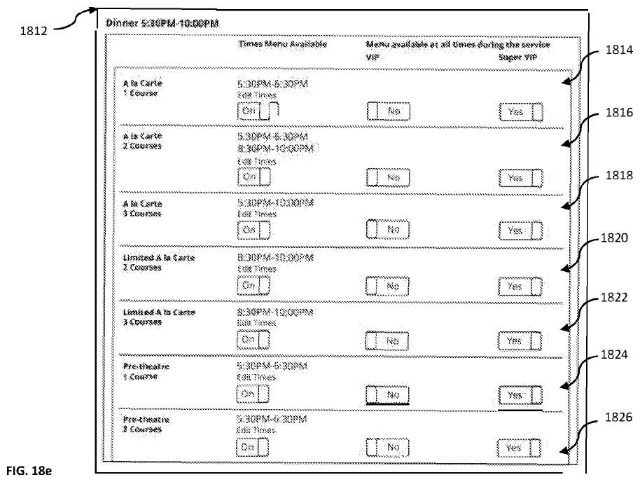

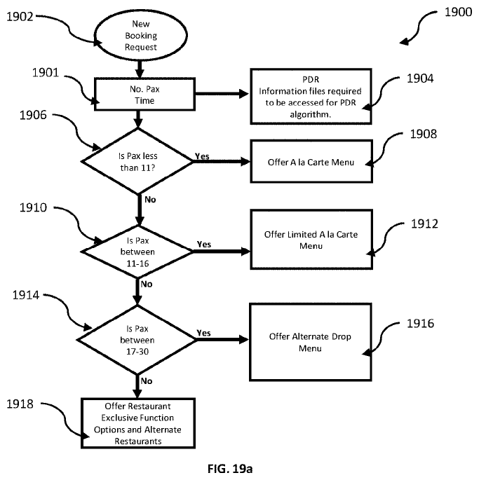

Referring to FIG. 18a, the user interface may also access manually estimated (estimated and entered by the operator) or predicted (by the predictive module) times required per course for a number of patrons. For example, referring to FIGS. 18a to 18b, the user interface which includes the input interface 1800 of the various menus and number of courses involved FIG. 18a, and then may rely on the rules shown on FIG. 18b which include the times for a first menu style (a la carte) for one course 1802, two courses 1806 and three courses 1804.

In one embodiment, the user interface relies on the duration times set by courses and/or by requestor status as shown in FIG. 18b, where input screens for the time allocated to one, two and three course menus are displayed at 1802, 1806 and 1804 respectively.

In one embodiment, the user interface groups all booking requests in accordance with the seating periods determined for a service as created and shown in FIG. 18c, including the setting of a table reset time at 1808.

The automation of the menu selection allows for larger bookings to be appropriately and automatically allocated without disrupting the normal service of the venue by reducing the time and effort required to cater to large parties of patrons. As such, the embodiment addresses one of the problems identified in the prior art by providing a complete restaurant management system that transparently and autonomously manages the relationship with the client from the beginning of the booking to payment and end of service.

In determining which menu to provide to the remote user, the user interface, may access relevant constraint information or other information, stored in one or more databases. Such information is shown in FIG. 18d, and the rules guiding the menu decision process 1810 includes but is not limited to the start and end of service times, the booking intervals, the latest time a booking would be accepted, and the maximum number of patrons, tables, walk-ins, and number of people per menu type.

Further, the user interface may also access manually estimated (estimated and entered by the operator) or predicted (by the predictive module) times required per course for a number of patrons. For example, referring to FIGS. 18a to 18b, the user interface which includes the input interface 1800 of the various menus and number of courses involved FIG. 18a, and then may rely on the rules shown in FIG. 18e which include the times for a first menu style (a la carte) for one course 1802, two courses 1806 and three courses 1804.

Alternatively, the user interface may rely on the rules 1812 which include the times for a second menu style (limited a la carte) for two courses 1820 and three courses 1822. Alternatively, the user interface may rely on the rules 1812 which include the times for a third menu style for one course 1824, two courses 1826.

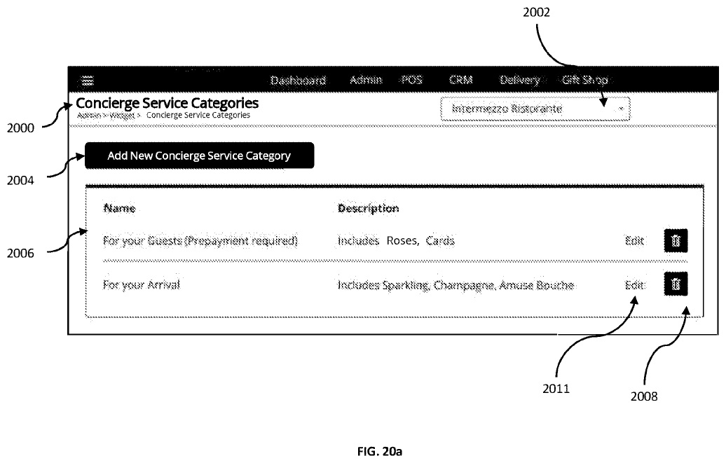

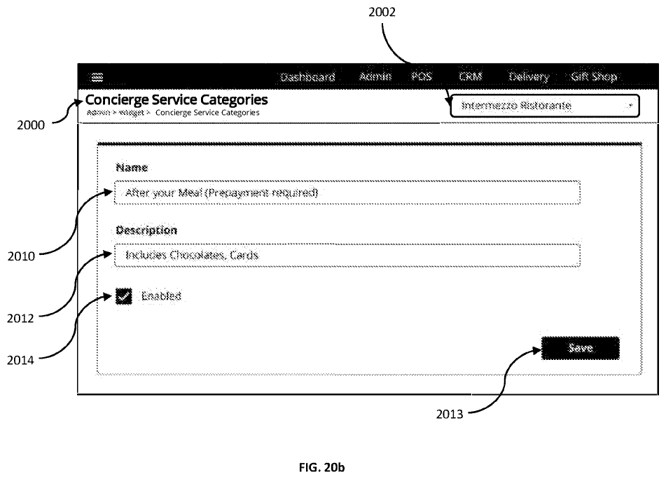

Referring to FIG. 19a, it is shown that the embodiment automatically varies the menu selection depending on the number of guests (pax). Referring to FIG. 19a, which shows a flow diagram 1900 illustrating the automatic decision making of the user interface in deciding which menu is provided to a requestor making a booking, depending on the number of guests. When receiving a new request or booking 1902, the number of guests (pax) and time are assessed at time 1901, to assess the request for whether it is a request for a private dining room (PDR) 1904. If it is not a request for a private room, and there are less than eleven pax 1906, then the user interface provides the requestor with the full a la carte menu 1908. If the number of pax is between 11-16 (1910), then the user interface provides the requestor with a limited a la carte menu 1912. If the number of pax is between 17-30 (1914), then the user interface provides the requestor with an alternate drop menu 1916. If the number of pax is over 30, exclusive function options are offered at 1918.

Alternatively, if the number of patrons is between eleven and sixteen 1910, then the user interface provides the remote user with a limited ala carte menu 1912.

Alternatively, if the number of patrons is between seventeen and thirty 1914, then the user interface provides the remote user with an alternative drop menu 1916. An “alternate drop menu” is a where the venue offers a limited selection and the remote user chooses two dishes per course which are served in an alternating manner for each guest.

Alternatively, if the number of patrons exceeds thirty patrons, the user interface provides a list of exclusive function options and/or a list of alternate venues that would be able to accommodate the booking 1918. As would be readily understood by the skilled addressee, the limitation of the number of patrons per menu type is determined based on the capacity of the venue and the exemplary values listed were provided to assist in understanding the claimed invention. As such, it would be understood that a user interface may provide the remote user with any number of menus depending on any number of patrons in the booking.

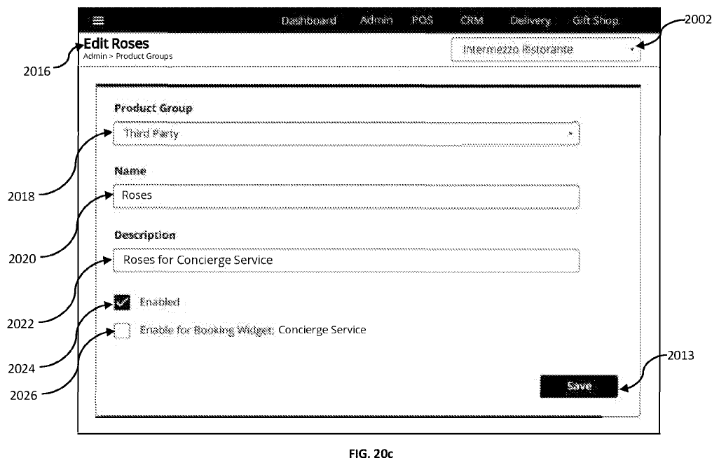

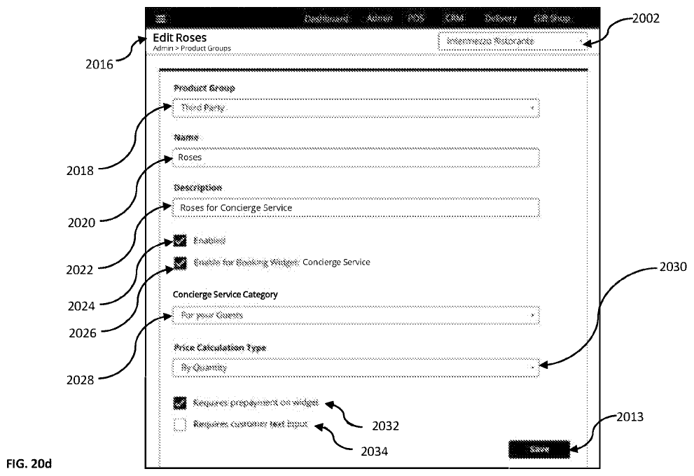

Referring to FIGS. 20a-d there is shown screenshots for the concierge service categories setup. The concierge service setup allows the operator to set up specific concierge service categories to which specific products from the POS can be added to, then displayed and offered as concierge service items on the booking widget. The operator can set up services through the interface shown in FIGS. 20a-d generally. Referring specifically to FIG. 20a, the interface includes an identifying title 2000, a drop-down menu for selecting a restaurant 2002, the ability to add a new concierge service category 2004, and a list of concierge service categories 2006, which can be edited 2011.

Referring to FIG. 20b, when a new concierge service category is added by selecting the new concierge service category button 2004 of FIG. 20a, there is displayed a further screen as per FIG. 20b, which includes an identifying title 2000, the ability to select a restaurant 2002, a name input 2010, a short description 2012, a checkbox to enable the category 2014, plus a button to save the category 2013.

Referring to FIG. 20c, there is shown a further setup screen for a product group including an identifying title 2016, the ability to select a restaurant 2002, a product group selection dropdown 2018, a name input box 2020, a description input box 2022 an enable button 2024, an enable for booking widget concierge service button 2026 and a save button 2013.

Referring to FIG. 20d, there is shown a further screenshot continued from FIG. 20c, including an identifying title 2016, the ability to select a restaurant 2002, the selection of a product group 2018, the addition of a name 2020, the addition of a description 2022, the ability to enable the service 2024 and enable for the widget 2026, the ability to place the service in a concierge service category 2028, the ability to calculate a price 2030, the ability to require prepayment 2034 and the ability to allow a customer to provide text input 2034, plus the ability to save the aforementioned information for future use 2013.

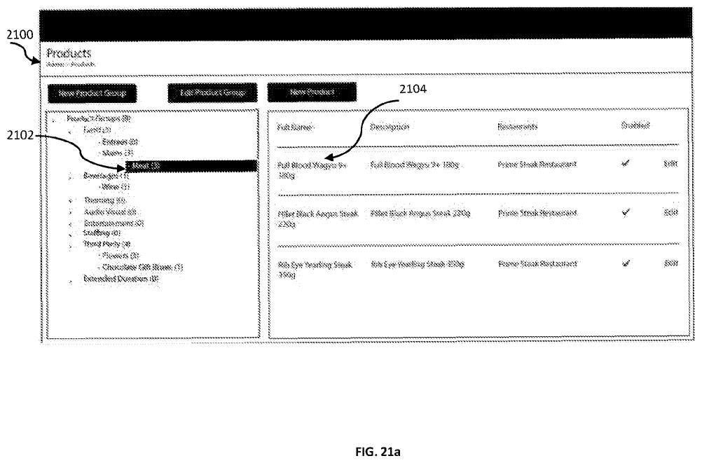

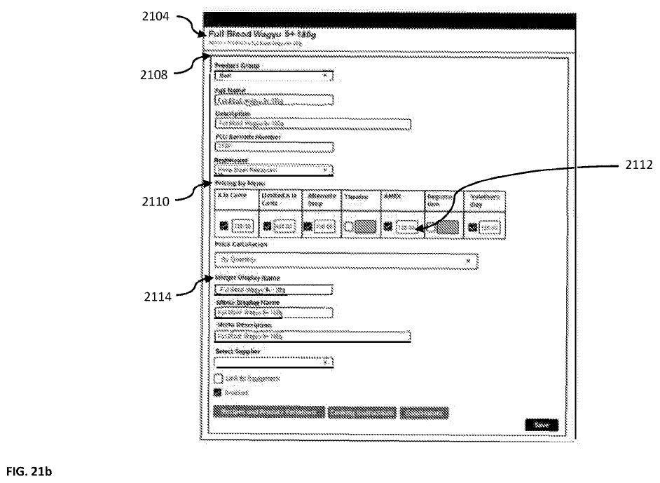

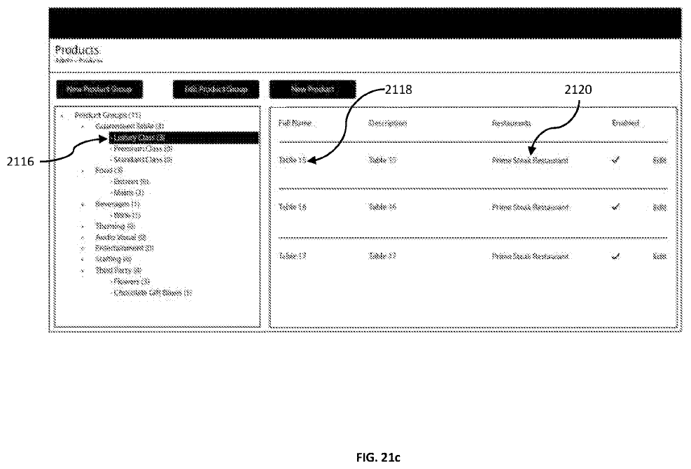

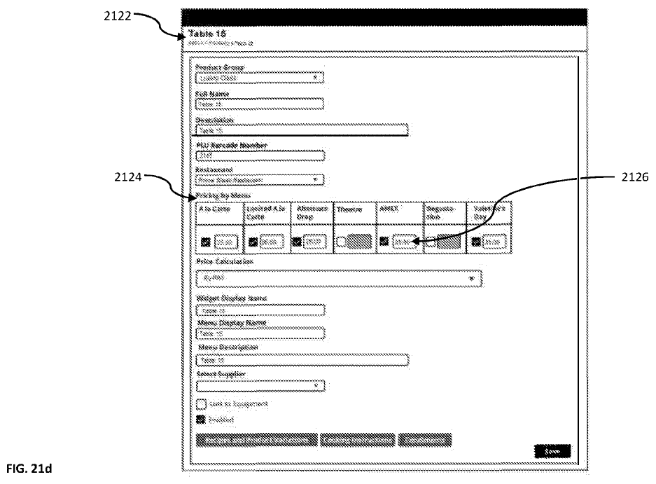

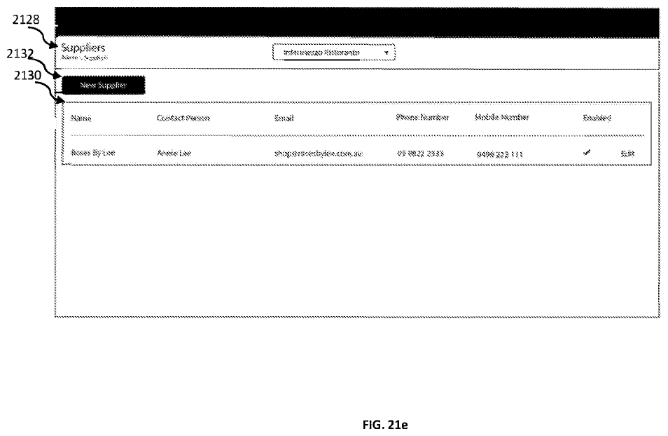

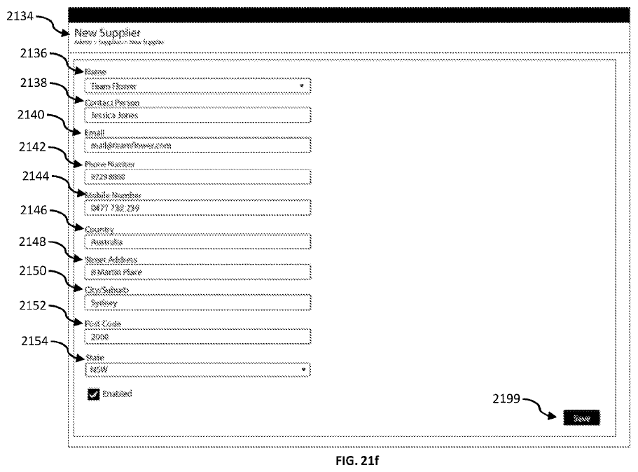

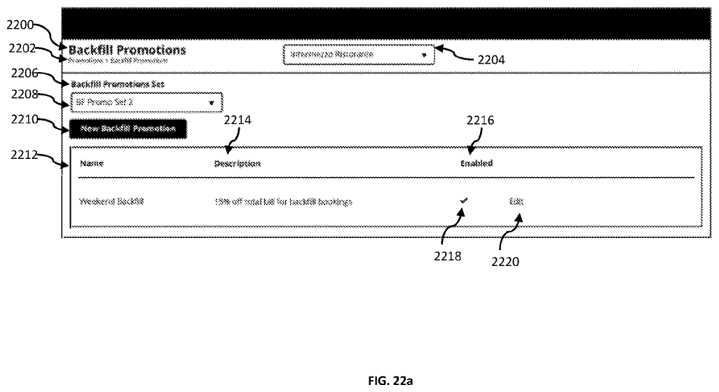

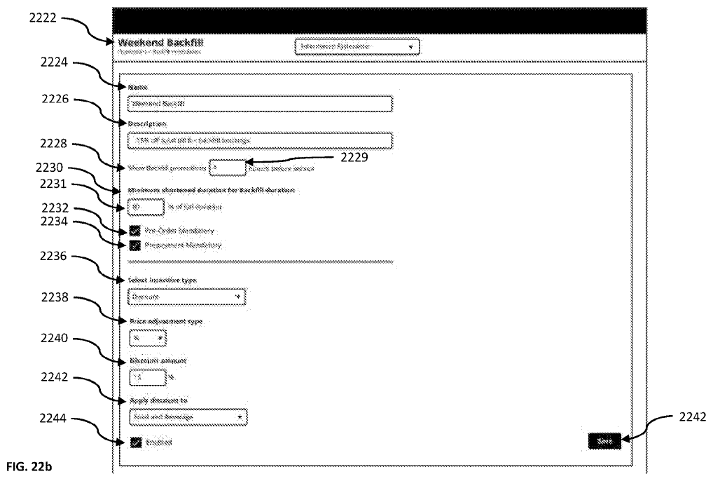

Referring to FIG. 21a, there is shown an example screen of a listing of products, specifically a “leaf” 2102 of a branch of the tree representing a specific product group. The Product information includes a product name 2104.

Referring to FIG. 21b, there is shown, in more detail, the product 2104 of FIG. 21a. The product includes a number of information items 2108, which allow the product to be costed and to be reordered as required.

Referring to FIG. 21c, there is shown an example screen of a listing of tables in a class, specifically a “leaf” 2116 of a branch of the tree representing a specific table 2118.

Referring to FIG. 21d, there is shown an example screenshot illustrating the setup of a product 2122 called table 15, which is where pricing can be setup for tables that have been set-aside for sale.

Referring to FIG. 21e-f, there is shown screenshots of the setup process for the creation of suppliers which can be linked to specific products to assist in product ordering processes. Referring to FIG. 21e, there is shown a list of suppliers 2130, to which an operator may add a new supplier by clicking the new supplier button 2132, which will open up the interface as shown in FIG. 21f. Referring now to FIG. 21f, there is shown the input screen utilised by an operator to assign contact details to a supplier, after which the supplier information can be saved by clicking the save button 2199.

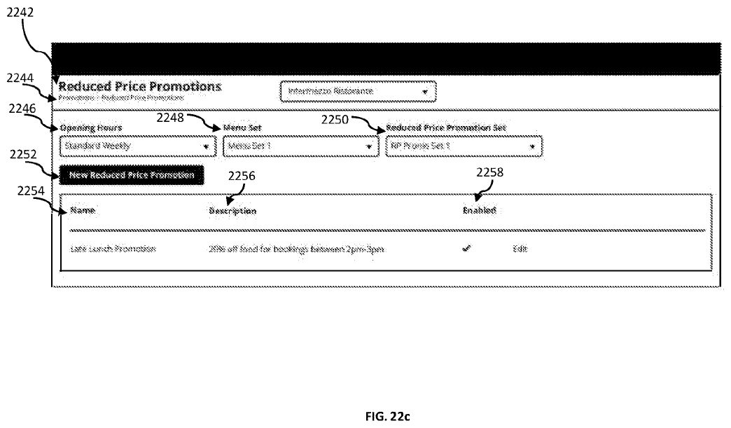

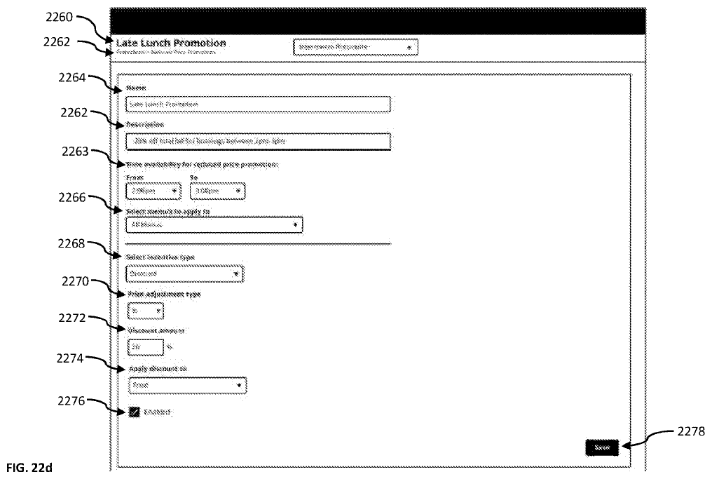

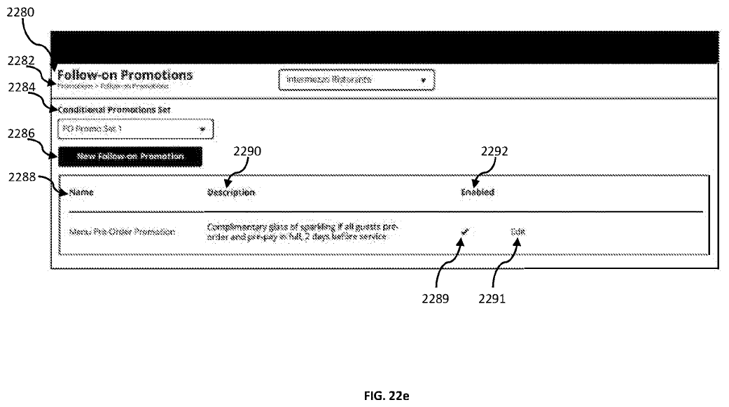

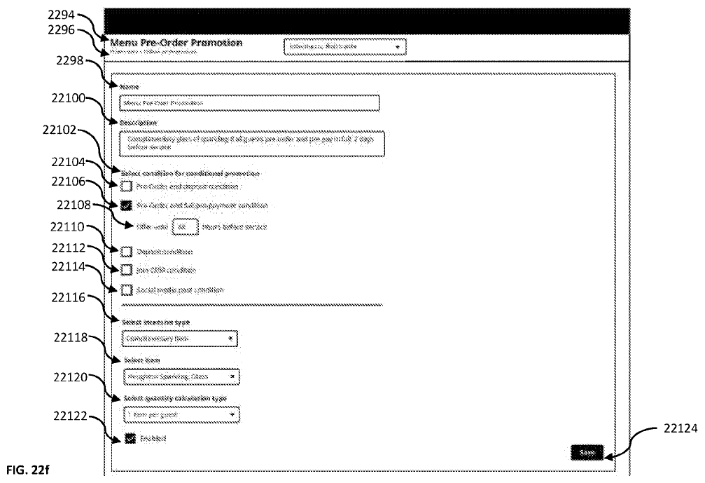

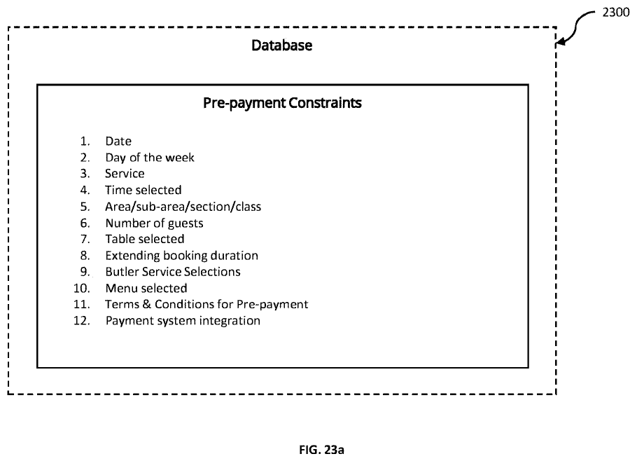

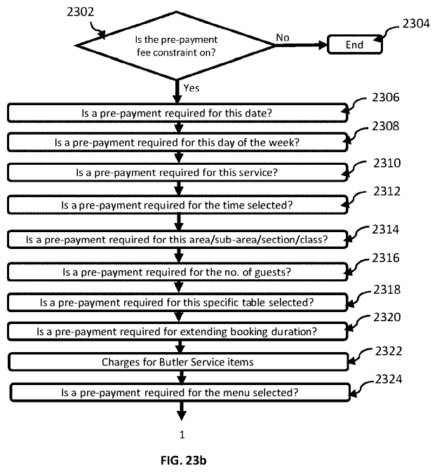

Referring to FIG. 22a, there is also shown a screenshot 2200 for an interface for entering backfill promotions. At pull down menu 2204 a restaurant is chosen. A backfill promotion set is displayed at 2206 and a promotion set is chosen at 2208. A new backfill promotion may be selected by button 2210 and previous backfill promotions are displayed at 2212, including a description 2214 and an enabled column 2216 which shows whether the promotion is enabled using tick 2218. The existing promotion may also be edited by clicking edit button 2220.

Referring to FIG. 22b, there is shown a screenshot of a weekend backfill promotion data entry screen 2222 in accordance with an embodiment of the invention. At 2224 the operator may enter a name and at 2226 a description of the promotion. At 2228 the operator is provided with a timing option for when backfill promotions are to be displayed and at 2229 the operator can enter a number of hours before service at which the backfill can be added. At 2230 there are displayed options that determine when backfill promotions will stop being displayed, and at 2231 a percentage can be applied by the operator. The operator may then select whether pre-order and/or prepayment is mandatory at 2232 and 2234 respectively.

The operator can also select an incentive type at the drop-down menu 2236 and can select a price adjustment value type at 2238. In the example screen shown, as the discount type is percentage, at 2240 a percentage value may be entered by the operator. The operator may then decide which items/products to apply the discount to, and may enable the discount by checking the enabled box at 2244. The entire promotion information may be saved at any time by clicking the save button 2242.

Referring to FIG. 22c, there is also shown a screenshot 2242 for an interface for entering reduced price promotions. At pull down menu 2246 a set of pre-set services (which may be a single service or an ongoing, repeating service) is chosen. Further, a menu set is selected at pull down menu 2248. Correspondingly, a reduced price promotion set is selected at 2250. The relevant reduced price promotion set is displayed at 2254. A new reduced price promotion may be entered by selecting button 2252 and the previous reduced price promotions, displayed at 2254, include a description 2256 and an enabled column 2258 which shows whether the promotion is enabled using tick (not labelled). The existing promotion may also be edited by clicking edit button (not labelled).

Referring to FIG. 22d, there is shown a screenshot of a late lunch promotion data entry screen 2260 (an example of a reduced price promotion) in accordance with an embodiment of the invention. At 2264 the operator may enter a name and at 2266 a description of the promotion. At 2263 the operator is provided with a timing option for when promotion is to be made available (i.e. which service or time interval) and at 226 the operator can enter which menus the promotion should be applied to.

The operator can also select an incentive type at the drop-down menu 2268 and can select a price adjustment value type at 2270. In the example screen shown, as the discount type is percentage, at 2272 a percentage value may be entered by the operator. The operator may then decide which items/products to apply the discount to at 2274, and may enable the discount by checking the enabled box at 2276. The entire promotion information may be saved at any time by clicking the save button 2278.

Referring to FIG. 22e, there is also shown a screenshot 2280 for an interface for entering follow-on promotions. At pull down menu 2284 a set of pre-set conditional promotions is chosen. The relevant follow-on promotion set is displayed at 2288. A new follow-on promotion may be entered by selecting button 2286 and the previous follow on promotions, displayed at 2288, include a description 2290 and an enabled column 2292 which shows whether the promotion is enabled using tick 2289. The existing promotion may also be edited by clicking edit button 2291.

Referring to FIG. 22f, there is shown a screenshot of a pre-order promotion data entry screen 2294 in accordance with an embodiment of the invention. At 2298 the operator may enter a name and at 22100 a description of the promotion. At 22104 and 22106 the operator is provided with pre-order and deposit or pre-order and payment options, and at 22108 an offer expiry time can be entered by the operator. At 22110, 22112 and 22114 various conditions may be imposed on the customer, including a deposit condition, a join CRM condition and/or a social media post condition respectively.

The operator can also select an incentive type at the drop-down menu 22116 and can select an item at 22118. In the example screen shown, as the incentive type is an item, at 22120 and 22122 an item and quantity may be selected by the operator. The operator may enable the promotion by checking the enabled box at 22122. The entire promotion information may be saved at any time by clicking the save button 22124.

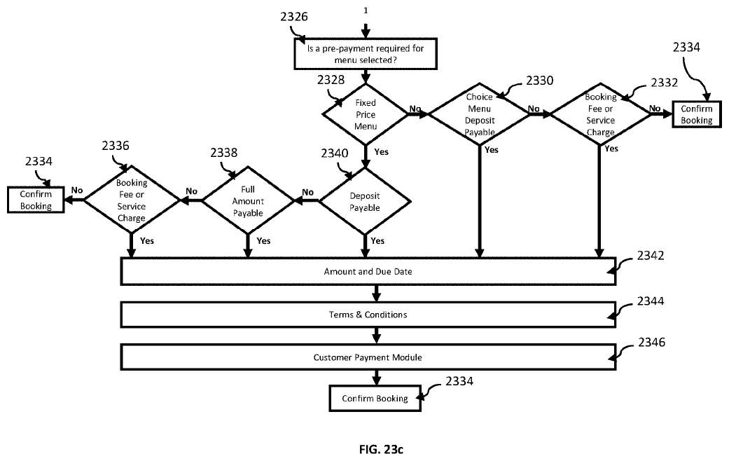

Referring to FIG. 23a, in one embodiment of the computer system is detailed an example of pre-payment constraints 2300 that can be used to determine whether a prepayment is required to secure a booking.

Referring to FIGS. 23b and 23c in one embodiment of the computer system is detailed an example of the pre-payments decision tree to determine if a booking request is required to make a pre-payment for the booking to be confirmed.

Referring in detail to FIG. 23b, the embodiment determines whether the pre-payment constraint is on at step 2302. If not, the process ends at step 2304. If yes, then a series of cascading criteria are determined utilising the constraint information, including whether pre-payment is required for the date 2306, the day of the week 2308, the service 2310, the time selected 2312, the space, sub-space, section or class 2314, the number of guests 2316, the specific table 2318, the extended booking duration 2320, additional services 2322 or the menu selected 2324.

Referring to FIG. 23c, which continues from flow arrow 1 of FIG. 23b, if the menu selected at step 2326 is a fixed price menu 2328, then the process determines if a deposit is payable 2340, and if not, the process determines if a full amount is payable at 2338, and if not, then the process determines if a booking fee is payable at 2336, if not then at step 2334 the booking is confirmed. If a deposit is payable at any one of steps 2340, 2338 or 2336, then the amount and date due is communicated at step 2342, the terms and conditions are communicated at step 2344, and the requestor is directed to a customer payment module at step 2346, after which the booking is confirmed at step 2334.

Returning to step 2328, if the menu is not a fixed price menu, the process determines whether a choice menu deposit is payable at step 2330, and if not, the process determines whether a booking fee is payable at step 2332 and if not, the booking is confirmed at step 2334. If a deposit is payable at steps 2330 and 2332, then the amount and date due is communicated at step 2342, the terms and conditions are communicated at step 2344, and the requestor is directed to a customer payment module at step 2346, after which the booking is confirmed at step 2334.

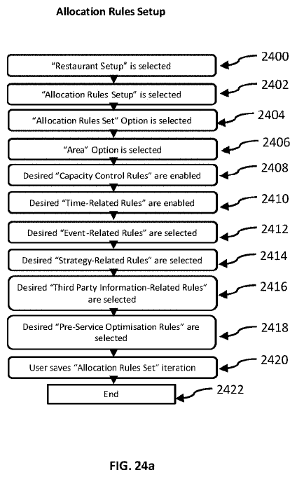

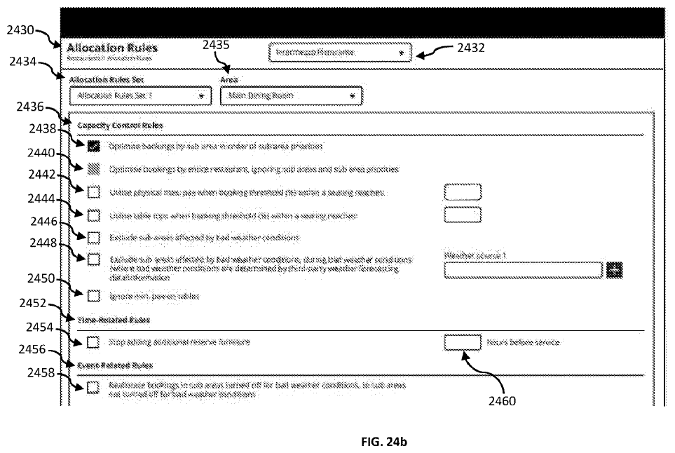

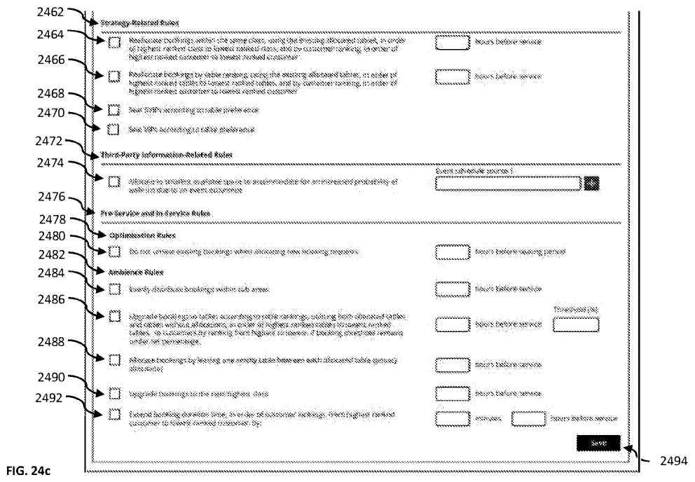

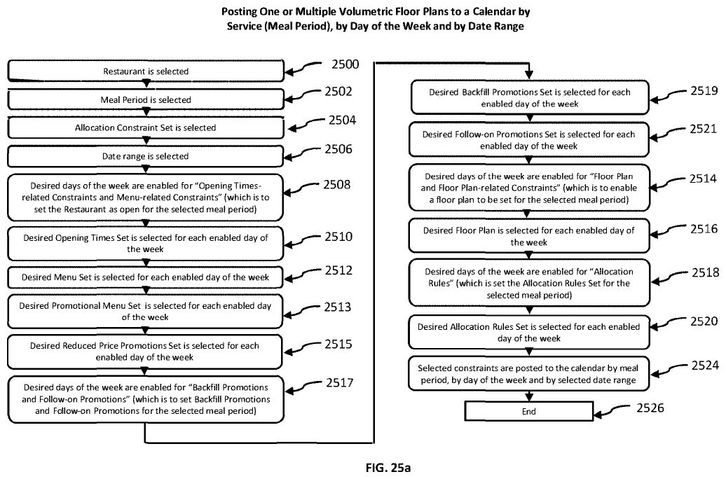

Referring to FIG. 24a there is shown a process flow diagram for an allocation rules setup, which allows an operator to create multiple unique sets of allocation rules configurations that can be posted to the calendar database by service, by day of the week and by date range, in accordance with a restaurant's strategy. At step 2400, the restaurant setup option is selected. Subsequently, at step 2402 the allocation rules setup is selected, and an allocation rules set option is selected at step 2404. The area option is selected at step 2406, and a desired capacity control rules are enabled at step 2408, then a desired time related rules is enabled at step 2410, followed by an event related rules being selected at step 2412. At step 2414, a strategy related rules is selected, followed by a third party information related rules being selected at step 2416. A Pre-service optimisation rules is selected at step 2418 and at step 2420 the user saves the allocation rules set before the process ends at step 2422.

Referring to FIG. 24b and FIG. 24c, there are shown screenshots of a screen which an operator utilises to input information in accordance with the process flow of FIG. 24a. At 2430, there is shown the Allocation rules title and at 2432, an operator can select a restaurant. At 2434 the operator selects an allocation rules set and at 2435 an area is selected. There are provided certain categories, including a capacity control rules category 2436, which includes the ability to set a series of constraints related to capacity control, including an optimise bookings by sub-area option 2438, an optimise bookings by entire restaurant 2440, a utilise physical max pax when a booking threshold is achieved 2442, a utilise table tops when a booking threshold is achieved 2444, an exclude sub areas affected by weather option 2446, an exclude sub areas affected by bad weather, during bad weather option 2448 and an ignore minimum pax on tables option 2450. There is also a time related rules category 2452 which includes a stop adding additional furniture option 2454 and a further constraint 2460 which activates option 2454 for a defined number of hours before service. There is also provided an event-related rules section 2456 including a relocate bookings for bad weather option 2458.

Referring now to FIG. 24c, there is shown a strategy-based rules section 2462 including a reallocate bookings by class rankings option 2464, a reallocate bookings by table ranking 2466, a seat SVIPs by table preference 2468 and a seat VIPs by table preference 2470. There is also provided a third-party information related rules section 2472 including an apply rules for event occurrence option 2474. Lastly, there is provided a pre-service and in-service rules section 2476 including optimisation rules 2478 and ambience rules 2482. Optimisation rules include a do not unseat existing bookings when allocating new booking requests option 2480. Ambience rules include an evenly distribute bookings within sub areas option 2484, an upgrade bookings to tables according to table rankings option 2486, an allocate bookings by leaving one empty table between each allocated table option 2488, an upgrade bookings to the next highest class option 2490 and an extend booking duration time in order of customer rankings option 2492. The operator may at any time save the selected options by utilising save button 2494.

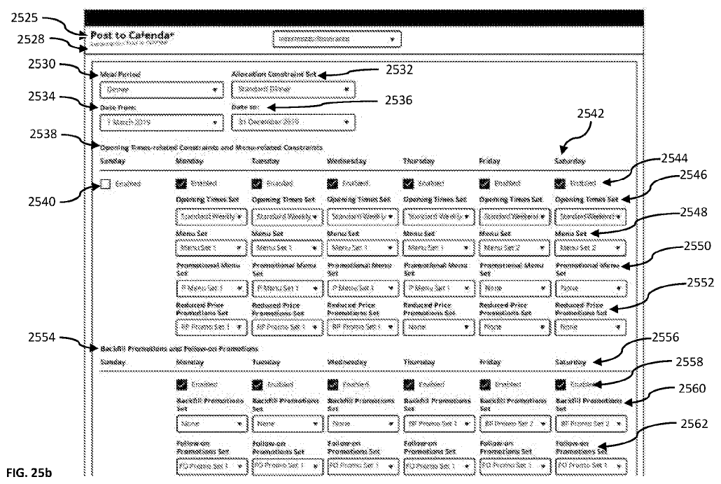

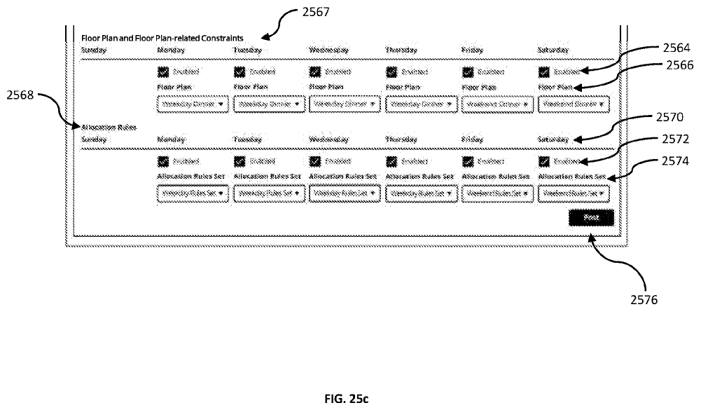

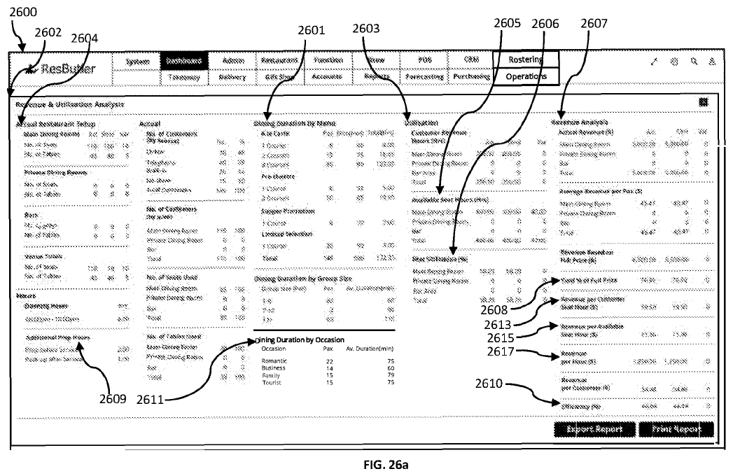

Referring to FIG. 25a there is shown a flowchart depicting the posting process for one or multiple volumetric floor plans to a calendar by one of service, day of the week and date range. At step 2500 a restaurant is selected. At step 2502 a meal period is selected, followed by the selection of an allocation constraint set at step 2504. Subsequently, a date range is selected at step 2506.

Next, at step 2508, the desired days of the week are enabled, and at step 2510, the desired opening times are set. At step 2512, the desired menu is set and then the desired days of the week are enabled for a floor plan at step 2514. The desired floor plan is selected for each enabled day of the week at step 2416, followed by the desired days of the week being enabled for the allocation rules at step 2520. Lastly, the selected constraints are posted to the calendar by meal period, day of the week and selected date range, before the process ends at step 2526.

Referring to FIGS. 25b and 25c, there is shown a screenshot of an interface utilised by an operator to effect the method steps described with reference to FIG. 25a. In FIGS. 25b and 25c, at 2525 there is shown a title for the screen, and there is provided a restaurant selector (not labelled). There is also provided a number of selectors including a meal period selector 2530, an allocation constraint set selector 2532, and a date range selector as indicated at 2534 and 2536. There are also provided four sets of selectable constraints for each of the days of the week (such as day 2542) relevant to the date period, namely an opening-time constraints 2546, menu set of constraints 2548, promotional menu set 2550 and a reduced price set 2552. The aforementioned constraint sets can be enabled for the specific day by checking the enable check box 2544. Similarly, the floor plan constraints 2567 allows the enabling of a specific floor plan for each day using check box 2564 and the selection of a floor plan set 2566 for each defined service/day period, and the allocation rules set 2546 allows for the selection of an allocation rules set 2568 for each defined service/day period such as day 2570, including a check box to enable the day 2572 and the ability to select a rule set 2574 for the day. Once all relevant sets have been selected, the operator posts the selected sets to the calendar by using the post button 2576. In this manner, each service/day period can utilise a customised set of constraints.

A further example of a pop up window relates to the restaurant summary and revenue module 2602 of the user interface 2600, is shown at FIG. 26a. When the operator clicks on the button “Rev & Util” for the restaurant summary and revenue module 2602, a “new” restaurant summary and revenue window 2604 “pops up” over the user interface dashboard 2600. The new restaurant summary and revenue window 2604 may have enhanced or additional functionality than is provided by the restaurant summary and revenue module 2602.

The restaurant summary and revenue module 2602 provides an advantageous insight into the operation of the venue. There are numerous metrics which are calculated within the embodiments of the system for yield management, forecasting and for the autonomous operations the system, examples of which are included within Annexure 2, with relevant prior art included as Annexure 1. However, in the embodiment, displayed on the user interface or dashboard of the system are revenue yield 2608, seat utilisation 2606 and efficiency 2610. Each may be represented as:

$$Revenue yield \% = \frac{actual revenue}{ \begin{matrix}retail price of items sold and \\ complimentary items provided\end{matrix} }$$

$$Seat utilisation \% = \frac{revenue seat hours}{avalaible seat hours}$$

$$Efficiency \% = revenue yield \% \times seat utilisation \%$$

The revenue yield is the actual revenue generated divided by the retail price revenue (excluding discounts, promotional benefits or gifts) 2608 at FIG. 26a. The seat utilisation is the revenue generated by each seat per hour divided by the number of hours the seat is in use 2606. The Efficiency of the restaurant is calculated as the revenue yield multiplied by the seat utilisation. The calculation of efficiency as shown at 2610 provides the user associated with the venue with a true measure of the efficiency of the operation of the restaurant across time.

Referring to FIG. 26a there is displayed a screenshot of an utilisation and revenue analysis screen 2600 in accordance with an embodiment of the invention. At 2602 generally there is shown a series of statistics and metrics, including actual restaurant setup at 2604 and seat utilisation at 2606. There is also shown a true yield FIG. 2608 and an efficiency value at 2610. Each of the metrics and values shown in the screenshot are not approximations but exact values calculated based on the information provided from the input data collected and the constraint information, customer information and venue information in the ResButler system.

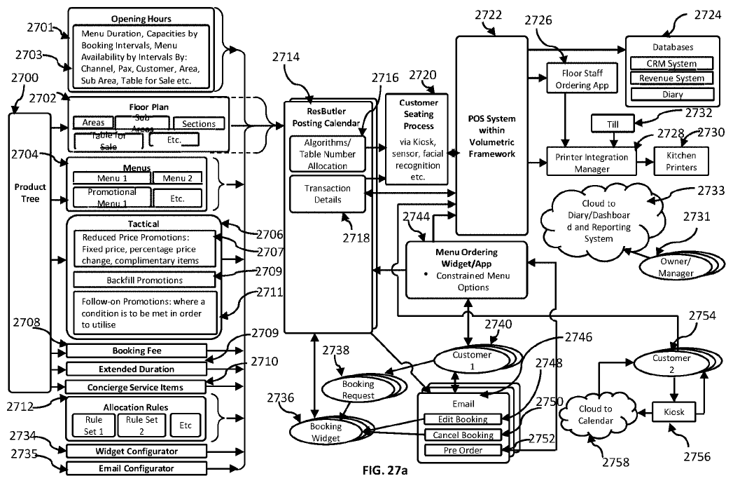

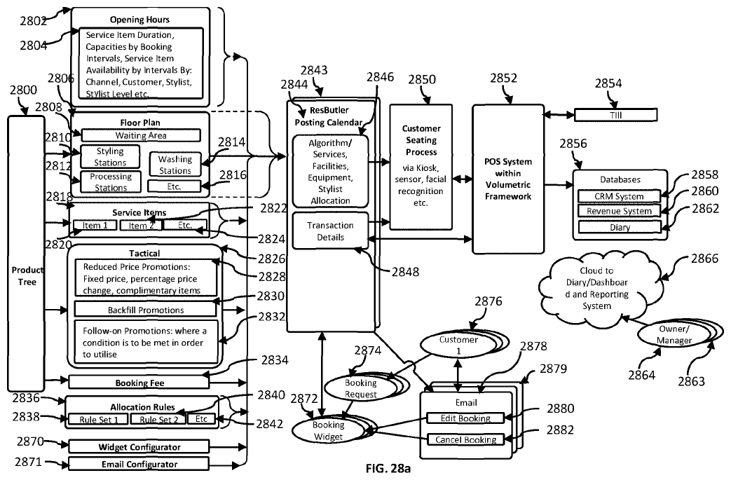

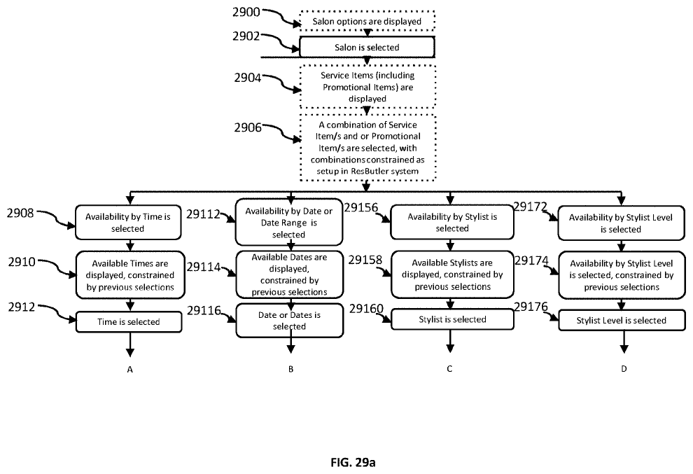

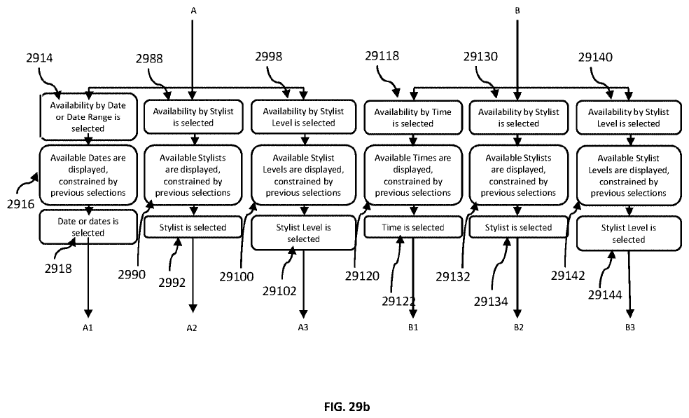

Referring to FIG. 27a there is shown a modular chart depicting the various hardware and software components of the ordering system and widget in accordance with an embodiment of the invention. Utilising the product tree 300 and opening hours information 2701 and 2703, floor plan information 2702, menu information 2704, promotion information 2706 including reduced price promotions 2707, backfill promotions 2719 and follow on promotions 2711, pus booking fee information 2706, extended duration information 2708, concierge service item information 2710, allocation rules 2712, widget configuration rules 2734 and email configuration data 2735, all information is posted to the posting calendar 2714 which includes table allocation logic 2718 and transaction details 2720 and interacts with the booking widget 2736 which receives booking request 2738 from customer 1 to create a seating process 2721 which is then posted to the POS system within the volumetric framework, which is arranged to interact with the floor staff ordering app and databases 2724. The floor staff ordering app is in communication with the printer integration manager 2728 and a kitchen printer 2730, and a till 2732.

The email configurator 2735 communicates with the customer via emails 2746 which include the ability to edit bookings 2748 and cancel bookings 2750 an also pre-order 2752, which connect with the menu ordering app 2742 or the menu ordering widget 2744. Similarly, customer 2 (2754) may interact directly with kiosk 2756 which has a cloud connection to the calendar 2758. The operator/owner/manager 2731 may also have a cloud connection 2733 to the diary and dashboard reporting system.

Referring to FIG. 28a, there is shown a modular chart depicting the various hardware and software components of the ordering system and widget in accordance with another embodiment of the invention (a hair salon). Utilising the product tree 2800 and opening hours information 2802 and 2804, floor plan information 2806 (which includes specific equipment and areas 2808, 2810, 2812, 2814 and 2816), service item information 2818 (including various items such as 2820, 2822 and 2824), tactical promotion information 2826 (including reduced price promotions 2828, backfill promotions 2830 and follow on promotions 2832), plus booking fee information 2834, allocation rules 2836 (including rule sets such as 2838, 2840 and 2842), widget configuration rules 2870 and email configuration data 2871, all information is posted to the posting calendar 2843 and 2844 which includes service and stylist allocation logic 2846 and transaction details 2848 and interacts with the booking widget 2872 which receives booking requests 2874 and 2875 from customer 1 (2867 and 2877) to create a seating process 2850 which is then posted to the POS system within the volumetric framework 2852, which is arranged to interact with the databases 2856 (including CRM system 2858, revenue system 2860 and diary 2862). The POS system 2852 is in communication a till 2854.

The email configurator 2871 communicates with the customer via emails 2878 and 2879 which include the ability to edit bookings 2880 and cancel bookings 2882, which connect with the booking widget 2872. The operator/owner/manager 2863 and 2864 may also have a cloud connection 2866 to the diary and dashboard reporting system.

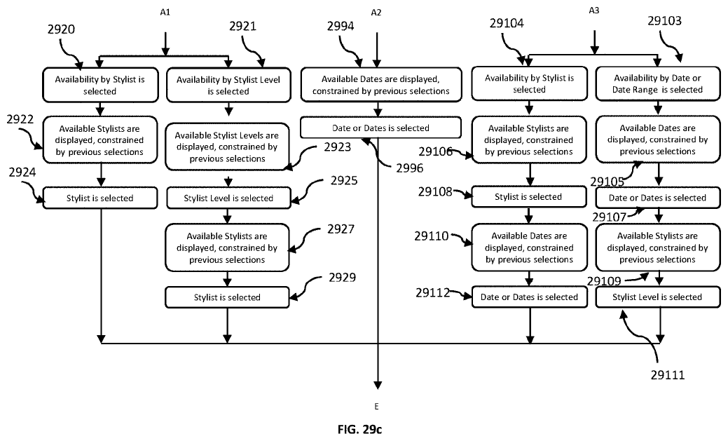

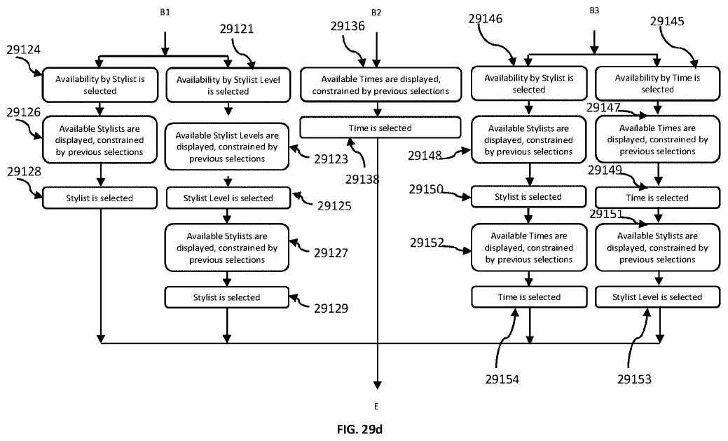

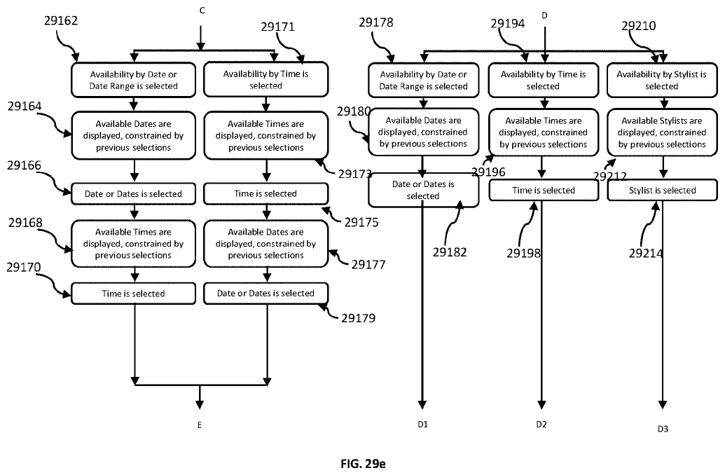

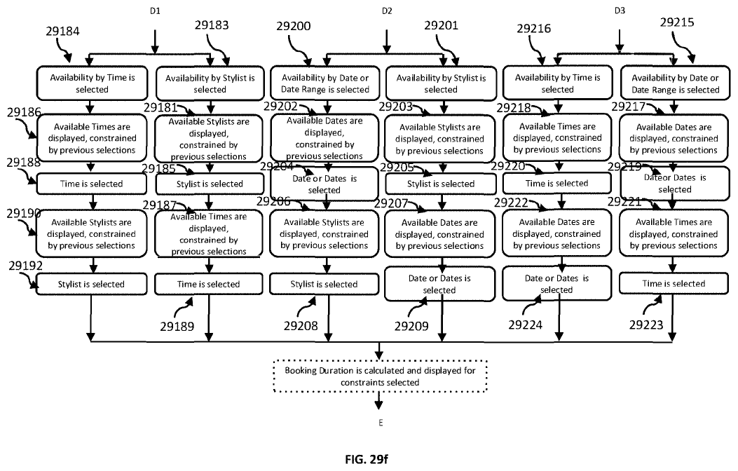

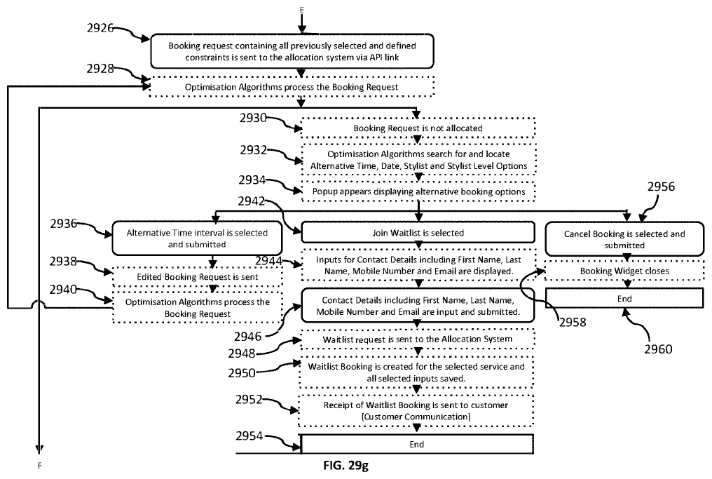

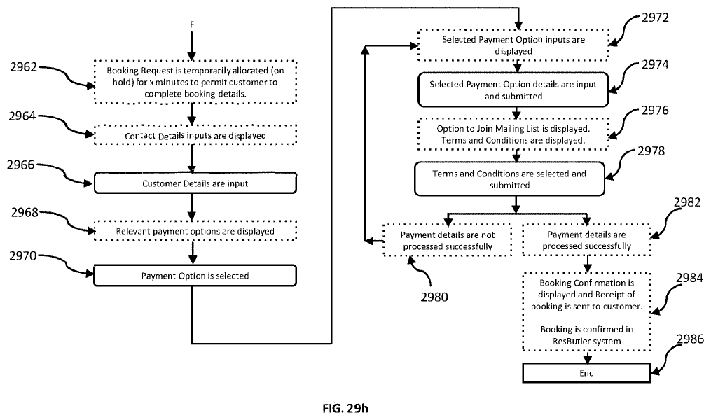

Referring to FIG. 29a, there is shown a flowchart for booking a service in a salon in accordance with an embodiment of the invention. At step 2900, a customer views a series of salon options, and at 2902 the customer selects a salon. Appropriate service items are displayed at 2904 and at 2906 the customer selects the desired service items (which may include promotional offers).

The customer is subsequently given four options to select from. Availability by time, availability by date, availability by stylist and availability by stylist level. If the customer selects availability by time at step 2908, available times are displayed at 2910 and the customer selects a time at step 2912, before the process continues along arrow A. If the customer selects availability by date at step 29112, available dates are displayed at 29114 and the customer selects a date at step 29116, before the process continues along arrow B. If the customer selects availability by stylist at step 29156, available stylists are displayed at 29158 and the customer selects a stylist at step 29160, before the process continues along arrow C. If the customer selects availability by stylist level at step 29172, available stylist level are displayed at 29174 and the customer selects a stylist level at step 29176, before the process continues along arrow D.

Referring to FIG. 29b, there is shown a continuation of the process along arrow A from FIG. 29a. The customer is subsequently given three options to select from. Availability by date, availability by stylist and availability by stylist level. If the customer selects availability by date at step 2914, available dates are displayed at 2916 and the customer selects a date at step 2918, before the process continues along arrow A1. If the customer selects availability by stylist at step 2988, available stylists are displayed at 2990 and the customer selects a stylist at step 2992, before the process continues along arrow A2. If the customer selects availability by stylist level at step 2998, available stylist levels are displayed at 29100 and the customer selects a stylist at step 29102, before the process continues along arrow A3.

There is also shown in FIG. 29b a continuation of the process along arrow B from FIG. 29a. The customer is subsequently given three options to select from. Availability by time, availability by stylist and availability by stylist level. If the customer selects availability by time at step 29118, available times are displayed at 29120 and the customer selects a time at step 29122, before the process continues along arrow B1. If the customer selects availability by stylist at step 29130, available stylists are displayed at 29132 and the customer selects a stylist at step 29134, before the process continues along arrow B2. If the customer selects availability by stylist level at step 29140, available stylist levels are displayed at 29142 and the customer selects a stylist at step 29144, before the process continues along arrow B3.

Referring to FIG. 29c, there is shown a continuation from FIG. 29b of arrows A1, A2 and A3. Following from arrow A1, the customer is subsequently given two options to select from. Availability by stylist and availability by stylist level. If the customer selects availability by stylist at step 2920, available stylists are displayed at 2922 and the customer selects a stylist at step 2924, before the process continues along arrow E. If the customer selects availability by stylist level at step 2921, available stylist levels are displayed at 2923 and the customer selects a stylist level at step 2925, then available stylists are displayed at 2927 and the customer selects an available stylist at 2929 before the process continues along arrow E.

Following on from arrow A2, if the customer selects available dates at step 2994, a date is selected at step 2996 and the process continues along arrow E.

Following on from arrow A3, if the customer selects availability by stylist at step 29104, available stylists are displayed at 29106 and the customer selects a stylist at step 29108, then available dates are displayed at 29110 and the customer selects an available date at 29112 before the process continues along arrow E. If the customer selects availability by date at step 29103, available dates are displayed at 29105 and the customer selects a date at step 29107, then available stylists are displayed at 29109 and the customer selects an available stylist at 29111 before the process continues along arrow E.

Referring to FIG. 29d, there is shown a continuation from FIG. 29b of arrows B1, B2 and B3. Following from arrow B1, the customer is subsequently given two options to select from. Availability by stylist and availability by stylist level. If the customer selects availability by stylist at step 29124, available stylists are displayed at 29126 and the customer selects a stylist at step 29128, before the process continues along arrow E. If the customer selects availability by stylist level at step 29121, available stylist levels are displayed at 29123 and the customer selects a stylist level at step 29125, then available stylists are displayed at 29127 and the customer selects an available stylist at 29129 before the process continues along arrow E.

Following on from arrow B2, if the customer selects available times at step 29136, a date is selected at step 29138 and the process continues along arrow E.

Following on from arrow B3, if the customer selects availability by stylist at step 29146, available stylists are displayed at 29148 and the customer selects a stylist at step 29150, then available times are displayed at 29152 and the customer selects an available time at 29154 before the process continues along arrow E. If the customer selects availability by time at step 29145, available times are displayed at 29147 and the customer selects a time at step 29149, then available stylists are displayed at 29151 and the customer selects an available stylist at 29153 before the process continues along arrow E.

Referring to FIG. 29e there is shown a continuation of the process along arrow C from FIG. 29a. The customer is subsequently given two options to select from. Availability by time and availability by date. If the customer selects availability by date at step 29162, available dates are displayed at 29164 and the customer selects a date at step 29166, then available times are displayed at 29168 and the customer selects an available time at 29170 before the process continues along arrow E. If the customer selects availability by time at step 29171, available times are displayed at 29173 and the customer selects a time at step 29175, then available dates are displayed at 29177 and the customer selects an available date at 29179 before the process continues along arrow E.

There is also shown in FIG. 29e a continuation of the process along arrow D from FIG. 29a. The customer is subsequently given three options to select from. Availability by date, by time and availability by stylist. If the customer selects availability by date at step 29178, available dates are displayed at 29180 and the customer selects a date at step 29182, before the process continues along arrow D1. If the customer selects availability by time at step 29194, available times are displayed at 29196 and the customer selects a stylist at step 29198, before the process continues along arrow D2. If the customer selects availability by stylist at step 29210, available stylists are displayed at 29212 and the customer selects a stylist at step 29214, before the process continues along arrow D3.

Referring to FIG. 29f there is shown a continuation of the process along arrow D1 from FIG. 29e. The customer is subsequently given two options to select from. Availability by time and availability by stylist. If the customer selects availability by time at step 29184, available times are displayed at 29186 and the customer selects a time at step 29188, then available stylists are displayed at 29190 and the customer selects an available stylist at 29192 before the process continues along arrow E. If the customer selects availability by stylist at step 29183, available stylists are displayed at 29181 and the customer selects a stylist at step 29185, then available times are displayed at 29187 and the customer selects an available time at 29189 before the process continues along arrow E.

Returning to FIG. 29f there is shown a continuation of the process along arrow D2 from FIG. 29e. The customer is subsequently given two options to select from. Availability by date and availability by stylist. If the customer selects availability by date at step 29200, available dates are displayed at 29202 and the customer selects a date at step 29204, then available stylists are displayed at 29206 and the customer selects an available stylist at 29208 before the process continues along arrow E. If the customer selects availability by stylist at step 29201, available stylists are displayed at 29203 and the customer selects a stylist at step 29205, then available dates are displayed at 29207 and the customer selects an available date at 29224 before the process continues along arrow E.

Returning to FIG. 29f there is shown a continuation of the process along arrow D3 from FIG. 29e. The customer is subsequently given two options to select from, availability by time and availability by date. If the customer selects availability by time at step 29216, available times are displayed at 29218 and the customer selects a time at step 29220, then available dates are displayed at 29222 and the customer selects an available date at 29224 before the process continues along arrow E. If the customer selects availability by date at step 29215, available dates are displayed at 29217 and the customer selects a date at step 29219, then available times are displayed at 29221 and the customer selects an available time at 29223 before the process continues along arrow E.

Referring to FIG. 29g there is shown a continuation of the process along arrow E (from FIGS. 29 c, d, e and f). At step 2926, the information gathered in the previous steps is sent to the allocation system via an API link. At step 2928, the optimisation algorithm processes the booking request. If the booking request is allocated, the process continues along arrow F which is described in more detail in FIG. 29h. If the booking request is not allocated, as shown at step 2930, the optimisation algorithm determines possible alternatives at step 2932, and a popup containing the alternatives is provided to the customer on their user interface at step 2934. At this point, the customer has three alternatives. If the customer selects an alternative time at step 2936, an edited booking request is sent to the system and at step 2940 the optimisation algorithm processes the booking request, before returning to one of arrow F or step 2930.

Alternatively, the customer may choose to join a waitlist at step 2942, and inputs contact details at step 2944. The contact details are submitted at step 2946 and a waitlist request is sent to the allocation system at step 2948. A waitlist booking is created at step 2950, and the information is communicated to the customer at step 2952 before the process ends at step 2954.

In a third alternative, the customer may cancel the booking request at step 2956, after which the widget closes at step 2958 and the process ends at step 2960.

Referring to FIG. 29h, there is shown a continuation of the process along arrow F of FIG. 29g. At step 2962, the booking request is temporarily allocated and at step 2964 the contact detail inputs are displayed. The customer inputs their details at step 2966 and relevant payment options are displayed at step 2968. A payment option is selected by the customer at step 2970, and the selected payment option is displayed to the customer at step 2972. Payment details are submitted at step 2974 and an option to join a mailing list, plus the display of terms and conditions, occurs at step 2976. Terms and conditions are agreed to at step 2978 and if payment details are not processed at step 2980, the process returns to step 2972. Alternatively, if payment is processed successfully at step 2982, the booking confirmation is displayed and a receipt is sent to the customer at step 2984, before the process ends at 2986.

### Advantages

The embodiment and broader invention described herein provides a number of advantages.

Firstly, the embodiment provides the first complete and comprehensive application of a yield management system as part of a booking allocation process which permits a total and complete differentiation of capacity including the utility of space, tables and table combinations.

Secondly, the embodiment provides a comprehensive framework for the application of dynamic pricing including pricing for specific tables, for specific tables at different times, for different menus and/or courses for different tables.

Thirdly, the embodiment provides a framework for the capacity control and dynamic pricing of additional tables added to a space or removed from a space during the booking allocation process.

Fourthly, the embodiment provides a framework for the use of CRM information and other historical and third party information to be used in the booking allocation process to provide a further level of product differentiation and capacity control.

Fifthly, the embodiment provides a framework for the application of yield management with an online booking allocation process with an iterative and dynamic allocation process.

Sixthly, the embodiment provides a framework for the integration of a yield management system with a configurable dynamic widget or app, and a dynamic iterative allocation methodology or one or more allocation algorithms.

Seventhly, the embodiment provides a framework for the integration of other restaurant systems such as transaction management, rostering and staffing levels, operational procedures and requirements, marketing, promotions, and artificial intelligence.

Eighthly, the embodiment provides for the booking allocation system and diary to have a dual diary for seamless integration and management reporting with all other systems to minimise and/or eliminate all associated manual interventions, reconciliations, reporting, forecasting and artificial intelligence requirements.

Lastly, the use of the computer-enabled method, system and computer program disclosed herein has provided examples within the restaurant industry, however, they are equally applicable within other industries and businesses such as airlines, accommodation, hotels, travel, cruise ships, car rentals, clubs, pubs, gyms, hairdressers, workspaces, and the provision of advice and consulting services.

### Disclaimers

Throughout this specification, unless the context requires otherwise, the word “comprise” or variations such as “comprises” or “comprising”, will be understood to imply the inclusion of a stated feature or group of features but not the explicit exclusion of any other feature or group of features.

Those skilled in the art will appreciate that the embodiments described herein are susceptible to obvious variations and modifications other than those specifically described and it is intended that the broadest claims cover all such variations and modifications. Those skilled in the art will also understand that the inventive concept that underpins the broadest claims may include any number of the steps, features, and concepts referred to or indicated in the specification, either individually or collectively, and any and all combinations of any two or more of the steps or features may constitute an invention.

Where definitions for selected terms used herein are found within the detailed description of the invention, it is intended that such definitions apply to the claimed invention. However, if not explicitly defined, all scientific and technical terms used herein have the same meaning as commonly understood to one of ordinary skill in the art to which the invention belongs.

Although not required, the embodiments described with reference to the method, computer program, computer interface and aspects of the system can be implemented via an Application Programming Interface (API), an Application Development Kit (AD K) or as a series of program libraries, for use by a developer, for the creation of software applications which are to be used on any one or more computing platforms or devices, such as a terminal or personal computer operating system or a portable computing device, a smartphone or a tablet computing system operating system, or within a larger server structure, such as a ‘data farm’ or within a larger computing transaction processing system.

Generally, as program modules include routines, programs, objects, components and data files that perform or assist in the performance of particular functions, it will be understood that the functionality of the method, computer program and computer interface defined herein may be distributed across a number of routines, programs, objects or components to achieve the same functionality as the embodiment and the broader invention claimed herein. Such variations and modifications are contemplated by the inventor and are within the purview of those skilled in the art.

It will also be appreciated that where methods and systems of the present invention and/or embodiments are implemented by computing systems or implemented across multiple computing systems then any appropriate computing system architecture may be utilised without departing from the inventive concept. This includes standalone computers, networked computers and dedicated computing devices that do not utilise software as it is colloquially understood (such as field-programmable gate arrays).

Where the terms “computer”, “computing system”, “computing device” and “mobile device” are used in the specification, these terms are intended to cover any appropriate arrangement of computer hardware for implementing the inventive concept and/or embodiments described herein.

Where the terms “software application”, “application”, “app”, “computer program”, “program” and “widget” are used in the specification when referring to an embodiment of the invention, these terms are intended to cover any appropriate software which is capable of performing the functions and/or achieving the outcomes as broadly described herein.

Where reference is made to communication standards, methods and/or systems, it will be understood that the devices, computing systems, servers, etc., that constitute the embodiments and/or invention or interact with the embodiments and/or invention may transmit and receive data via any suitable hardware mechanism and software protocol, including wired and wireless communications protocols, such as but not limited to second, third, fourth and fifth generation (2G, 3G, 4G and e) telecommunications protocols (in accordance with the International Mobile Telecommunications-2000 (IMT-2000) specification), Wi-Fi (in accordance with the IEEE 802.11 standards), Bluetooth (in accordance with the IEEE 802.15.1 standard and/or standards set by the Bluetooth Special Interest Group), or any other radio frequency, optical, acoustic, magnetic, or any other form or method of communication that may become available from time to time.

1. A computer-enabled method for providing differentiable product and/or services offerings to a booking requestor via a booking allocation algorithm utilising a volumetric space/time framework to allocate bookings using a booking allocation algorithm, comprising the steps of, associating one or more spatial, product and service attributes with each one of one or more spaces within the volumetric space/time framework, whereby the one or more attributes associated with the each one of the one or more spaces define at least one of a physical and qualitative attribute of the each one or more spaces, associating one or more products with the each one of the one or more attributes to create the differentiable set of products, whereby the differentiable set of products is further associated with the each of the one or more spaces, whereby the differentiable set of products is utilised in allocating the booking by the booking allocation algorithm, whereby upon execution of the algorithm, the framework is arranged to produce an optimised allocation instruction set for the one or more spaces within the volumetric space/time framework and the allocated bookings, whereby the optimised allocation instruction set is saved in the database and displayed, upon request, by a space allocation user interface to one or more users.

2. The method of claim 1, whereby the booking allocation algorithm is a dynamic booking allocation algorithm.

3. The method of claim 1, comprising the further step of determining of the capacity to be released for the each one or more differentiable products or services to determine the total capacity of the each one or more differentiable products or services available for sale within a venue.

4. The method of claim 1, comprising the further step of allocating a booking request within the product differentiation volumetric framework whereby, for a booking allocation request including booking information arranged to allow the booking request algorithm to select one or more potentially suitable tables or spaces, at least one of the purchase amount of the one or more products and the availability of the one or more products is determined as a function of whether the product is associated with the one or more potentially suitable tables or spaces within the volumetric space/time framework.

5. The method of claim 4, whereby the framework is arranged to interact with a booking application, the booking application including a user interface arranged to interact with the booking requestor.

6. The method of claim 5, whereby the booking application prompts the booking requestor to input booking request information, the booking request information including requestor constraint information.

7. The method of claim 6, comprising the further step of the booking application providing a channel identifier to the algorithm, whereby the channel identifier is associated with further constraints, whereby, for each of the products in the set of products, the further constraints are utilised to further differentiate the purchase amount of the product or the availability of the product as displayed to the booking requestor on the user interface.

8. The method of claim 7, comprising the further step of identifying the booking requestor, whereby the identity of the booking requestor or any associated party is utilised by the algorithm to determine at least one of the purchase amount for the product and the availability of the product.

9. The method of claim 7, comprising the further step of, upon receiving a booking request from a booking requestor, via the booking application, the framework utilises the constraint information provided by the booking requestor to provide a list of available products and associated purchase amounts.

10. The method of claim 1, whereby the constraint information includes at least one of selected menu items, group size, occasion, group composition and odd group number sizes.

11. The method of claim 1, whereby the constraint information includes at least one of the terms and conditions associated with a booking, the provision of a prepayment or part payment and the payment of supplementary items and the framework provides one of differential pricing and availability dependent on the constraint information.

12. The method of claim 1, whereby the constraint information includes a duration time for a booking and the framework provides one of differential pricing and availability dependent on the constraint information.

13. The method of claim 1, comprising the further steps of utilising an allocation module arranged to retrieve one or more booking requests from a database containing a plurality of booking requests, the plurality of booking requests wherein the allocation module executes an allocation algorithm that utilises the booking information and the constraint information to assess the capacity of the one or more spaces and allocate a portion of space for each booking request, to derive an optimised allocation instruction set of allocated portions, wherein the instruction set is saved in the database and provided to a space allocation user interface for display to one or more users.

14. The method of claim 13, the constraint information further including space constraint information defining a plurality of sub-spaces within each one or more spaces, wherein the attributes include constraints that define spatial and utility aspects of the plurality of sub-spaces, wherein the allocation algorithm utilises the sub-space constraint information to allocate each allocation portion to one or more of the plurality of sub-spaces.

15. The method of claim 14, the constraint information further including section constraint information defining a plurality of sections within at least one sub-space of the plurality of subspaces, whereby the section constraint information and the booking constraint information include constraints that define spatial and utility aspects of the plurality of sections, wherein the allocation algorithm utilises the section constraint information to allocate each allocation portion to one or more of the plurality of sections.

16. The method of claim 15, wherein the section constraint information includes specific section constraint information, each specific section constraint information being associated with one or more of the plurality of sections, wherein each of the one or more sections is associated with section constraint information to utilised by the framework to provide one of differential pricing and availability.

17. The method of claim 5, the venue spatial information including the dimensions of the one or more sub-spaces, wherein the dimensions are utilised by the framework to provide one of differential pricing and availability.

18. The method of claim 1, the constraint information further including a class identifier associated with at least one of a space, sub-space or section, wherein the class identifier is utilised by the framework to provide one of differential pricing and availability.

19. The method of claim 18, the requestor constraint information for at least one of the one or more booking requests including information identifying at least one customer associated with each one of the at least one of the one or more booking requests, wherein the allocation algorithm accesses a customer database including additional customer constraint information regarding the at least one customer and utilises the additional customer information as an input to generate and allocate the allocation portion for the at least one of the one or more booking requests.

20. The method of claim 1, the customer constraint information including grouping information utilisable to group each one of the booking requests from the plurality of bookings into at least one of a plurality of groupings, the groupings including a grouping of booking requests where a predefined allocation portion is provided in the requestor constraint information and a grouping where no booking request is provided in the requestor constraint information.

21.-62. (canceled)
